(19) United States
(12) Patent Application Publication
(10) Pub. No.: US 2002/0184401 A1
(43) Pub. Date: Dec. 5, 2002

(54) Extensible information system

(76) Inventors: Richard William Kadel JR., San Diego, CA (US); Jeffrey Stephan Herman, San Diego, CA (US); Christopher Lee Exline, San Diego, CA (US); David Edward Almilli, La Mesa, CA (US); Christopher C. Priebe, San Diego, CA (US)

Correspondence Address: David A. Hall, Heller Ehrman White & McAuliffe LLP, 6th Floor, 4350 La Jolla Village Drive, San Diego, CA, 92122-1246, US

(21) Appl. No.: 10/039,306

(22) Filed: Oct. 22, 2001

Related U.S. Application Data
(60) Provisional application No. 60/242,041, filed on Oct. 20, 2000.

(51) Int. Cl. G06F 9/44

(52) U.S. Cl. 709/315

(57) ABSTRACT

A framework enables data source components to be developed independently of data consumer components. A mediation layer, typically implemented as a group of APIs (application programming interface), handles and defines the mediation and interface between the source and data components. The framework, called XIS (extensible information system), is especially suited for development of information-handling systems and applications. Data source components and data consumer components are typically designed to communicate with each other via several interfaces. Domain, relationship, attribute/metadata, and change event interfaces are defined within the mediation layer. Other interfaces may also be defined. Data source components that are written for non-XIS aware environments or frameworks may still be used with XIS by “wrapping” such source components with code to conform to the interface requirements. Java objects are examples of data source components. Data consumer components thus are able to use or consume various source components regardless of the data types and the data source. Thus, once a data consumer component is developed within the XIS framework, any data source components within the XIS framework may be consumed by a data consumer component.

This application claims priority of co-pending U.S. Provisional Patent Application Ser. No. 60/242,041 entitled “Extensible Information System (XIS)” by R. Kadel et al., filed Oct. 20, 2000. Priority of the filing date of Oct. 20, 2000 is hereby claimed, and the disclosure of said Provisional Patent Application is hereby incorporated by reference.

A portion of the disclosure of this patent document contains material, which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

1. Field Of The Invention

The present invention relates generally to data processing systems and, more particularly, to systems that process, analyze, and display data or information.

2. Description of the Related Art

The continuing inroads made by computer technology into the practices of information storage and manipulation have opened up new realms of possibility for intelligent, informed decision-making. From labor statistics and scientific databases like the human genome project to traffic patterns and aircraft positions, the availability of information in electronic form allows sophisticated analysis techniques and display methods to be applied at the touch of a button. However this diverse array of information also poses significant challenges in areas such as:

effective organization of information;

ability to interpret and manipulate information in an increasingly wide variety of formats so that data and processing software can be brought together in a compatible but also timely and effective way; and

recognizing and navigating relationships between disparate information types.

This task of information management has already grown beyond the ability of human operators to keep pace with it, and in most applications, there is far more relevant information electronically available on the web and elsewhere than is effectively used. The problem is that software affording display of and interaction with information must be custom-designed for the particular type and format of the information it will work with. This leads to high costs of software development and limited availability of software appropriate to information of interest, and poor integration between information from different sources. An analyst must use one program when dealing with geographic distribution data such as precipitation amounts or land use, another for rendering 3-dimensional terrain, another for examining congressional districts and voting records, and so on. Many desirable applications of available data, such as determining correlations between political party and land use strategy in this case, fall between the cracks left by specialized applications, and there is no easy way to allow them to interoperate.

The primary means for allowing one application to operate on the results of another are the limited cut and paste facilities offered by many operating systems, which allow plain or formatted text or images to be moved between programs. There is no independent way to transfer structured data such as a table of numbers with particular column headings, a set of lists of items under specified categories, or even something as simple as a single number with an associated unit of measurement.

From the discussion above, it should be apparent that there is a need for computer systems that have greater ability to develop, integrate, and interoperate with disparate sources of information, to more easily develop software applications, components, or objects, and to facilitate interoperation of data between software components. The present invention fulfills this need.

### SUMMARY OF THE INVENTION

In accordance with the present invention, a framework for use with object oriented programming (OOP) systems provides a framework user with classes that comprise a mediation layer that defines an interface between data source components and data consumer components such that the configuration of the data source components can be specified independently of the data consumer components. The mediation layer specifies data relationships of the data objects, domain methods for defining groups of class attributes, attribute metadata for defining groups of class attributes, and change event registration for detecting changes in data values. Thus, when extended, the mediation layer of the framework can support runtime data manipulation between unrelated data source components and data consumer components. In this way, the framework provides an extensible information system. The framework will be referred to herein as “XIS”, and is especially suited to assist in the development of information-handling systems or applications.

Data source components that are configured for a non-XIS-aware programming environment or framework may still be used with XIS by “wrapping” such source components with code to conform to the interface requirements. Data objects of the well-known “Java” programming language are examples of data source components. Data consumer components thus are able to use or consume various data source components regardless of the data types and the data source. Thus, once a data consumer component is developed within the XIS framework, any data source components within the XIS framework may also accordingly be used. The framework can be provided as a group of APIs (application programming interface).

The XIS framework of the present invention also includes libraries and APIs that provide information management technologies that enable developers and integrators to combine XIS-aware components, data sources, and off-the-shelf JavaBeans into complete systems designed around whatever architecture is best for the situation. XIS further supports multiple, dynamic domains and is scalable to n-tier systems using the latest technology. The framework enables many developers to choose architectures based on their requirements (e.g., server, client/server, application server, web server, standalone, hand-held, etc.).

Other features and advantages of the present invention should be apparent from the following description, which illustrates, by way of example, the principles of the invention.

### BRIEF DESCRIPTIONS OF THE FIGURES

FIG. 1 is a diagram of the extensible information system (XIS) framework constructed in accordance with the present invention.

FIG. 2 is a more detailed diagram of FIG. 1, showing the various interfaces within XIS, constructed in accordance with the present invention.

FIG. 3A is a more detailed diagram of FIG. 1, including information and services available within XIS, constructed in accordance with the present invention.

FIG. 3B is a hierarchical structure diagram of an embodiment of an InfoModel constructed in accordance with the present invention.

FIG. 4 is a more detailed diagram of FIG. 1 showing various information available to components within XIS constructed in accordance with the present invention.

FIG. 5 is a diagram of the semantic representation of a data item within the XIS framework constructed in accordance with the present invention.

FIGS. 6A to 6F show data consumer components, particularly display components, constructed in accordance with the present invention.

FIG. 7 shows a consumer component displaying the properties exposed by a data source object constructed in accordance with the present invention.

FIG. 8 is a unified modeling language (UML) diagram of a Person object.

FIG. 9 lists a set of attributes exposed within the XIS framework by the Person object of FIG. 6 constructed in accordance with the present invention.

FIG. 10 illustrates that an object constructed in accordance with the present invention may subscribe to more than one domain policy or definition.

FIG. 11 shows a domain usage and sequence scenario between a consumer component and source component constructed in accordance with the present invention.

FIGS. 12A to 12D list information regarding a Type Metadata package class typically implemented in the mediation layer and constructed in accordance with the present invention.

FIG. 13 shows a relationship usage scenario diagram between a consumer component and source component constructed in accordance with the present invention.

FIG. 14 is a flow chart that shows a reference resolution scenario usage sequence in which an indirect reference to an information element is created, passed around, and then resolved by two separate data consumers, causing reconstruction to occur only the first time.

FIG. 15 lists an exemplary Java source file to implement an information-handling application constructed in accordance with the present invention.

FIGS. 16A to 16B list an exemplary Java source file to implement an information-handling application constructed in accordance with the present invention.

FIG. 17 shows a data consumer component using a source component constructed in accordance with the present invention.

FIGS. 18A to 18B list an exemplary Java source file to implement an information-handling application constructed in accordance with the present invention.

FIGS. 19A to 19B list an exemplary Java source file to implement an information-handling application constructed in accordance with the present invention.

FIG. 20 shows a data consumer component using a source component constructed in accordance with the present invention.

FIG. 21 lists an exemplary Java source file to implement an information-handling application constructed in accordance with the present invention.

FIGS. 22A to 22C list an exemplary Java source file to implement an information-handling application constructed in accordance with the present invention.

FIGS. 23A to 23D list an exemplary Java source file to implement an information-handling application constructed in accordance with the present invention.

FIGS. 24A and 24B show two data consumer components using a source component constructed in accordance with the present invention.

FIGS. 25A to 25C list an exemplary Java source file to implement an information-handling application constructed in accordance with the present invention.

FIG. 26 shows a data consumer component using a source component constructed in accordance with the present invention.

FIG. 27A and FIG. 27B show a flow chart of a data exposure facility within the XIS framework constructed in accordance with the present invention.

FIG. 28 is a diagram of how InfoModels constructed in accordance with the present invention provide contextualization with the XIS framework.

FIG. 29 is a diagram of the pluggable service facilities within XIS constructed in accordance with the present invention.

FIG. 30 shows a flow diagram of a wizard or an API constructed in accordance with the present invention that assists in creating XML (extensible markup language) DSIs and database DSIs.

FIG. 31 shows objects and methods involved in distribution collaboration facilities constructed in accordance with the present invention.

FIG. 32 shows semantic repositories for distributed agents constructed in accordance with the present invention.

FIGS. 33A to 33P list information regarding a ContentInfoBean class constructed in accordance with the present invention.

FIGS. 34A to 34D list an information management package typically implemented in the mediation layer and constructed in accordance with the present invention.

FIGS. 35A to 35F list an InfoModel interface package typically implemented in the mediation layer and constructed in accordance with the present invention.

FIGS. 36A to 36B list a package for handling change events typically implemented in the mediation layer and constructed in accordance with the present invention.

FIGS. 36C and 36D show two sequence diagrams showing how change events are handled and constructed in accordance with the present invention.

FIGS. 37A to 37D list an exemplary Java source file to implement an information-handling application constructed in accordance with the present invention.

FIGS. 38A, 38B, 38C, and 38D show two data consumer components using a source component constructed in accordance with the present invention.

FIGS. 39A, 39B, and 39C is list information concerning an AttributeAlias class of the framework.

FIG. 40 is a block diagram of a computer device that may be used to operate with the framework, in accordance with the present invention.

### DETAILED DESCRIPTION

The following detailed description illustrates the invention by way of example, not by way of limitation of the principles of the invention. This description will clearly enable one skilled in the art to make and use the invention, and describes several embodiments, adaptations, variations, alternatives and uses of the invention, including what we presently believe is the best mode of carrying out the invention.

The invention will be described by way of illustration with reference to various classes, objects, sample codes, etc. written within the exemplary framework, but it should be understood that such classes, class libraries, application programming interfaces, interfaces, objects, etc. may be differently coded, implemented, designed, etc. and yet support the functions and features of the present invention.

Object-Oriented Technology Many application programs and APIs (application program interface) are developed using object-oriented (OO) technology. Using OO technology, a system is typically developed as a collection of interrelated cooperative objects that are instances of classes that typically include corresponding states and behaviors. A class is a blueprint or template that defines the variables and the methods common to all objects that are instances of the class. An object maintains its state in one or more variables and implements its behavior with methods or functions.

Object-oriented programming (OOP) techniques encapsulate, or bind together, data and the methods that operate on them. This encapsulation permits program development to more closely model real-world entities and breaks up program development efforts into smaller, more manageable pieces. Although OOP techniques have done much to improve program development efficiency, such techniques still require a great degree of code generation on the part of developers, which discourages program reuse.

Even with OOP techniques, specifying data sources and the way in which data will be retrieved or updated from the data sources are still typically hard-coded within the objects themselves. An object, for example, may be specified to display pricing data (for example, a price display object) and would likely be hard-coded such that the data source is predefined. Thus, an object may be written to retrieve data from a source such as a relational database management system (RDBMS), a spreadsheet file such as a spreadsheet in the format of “EXCEL” spreadsheet application by Microsoft Corporation, or the object may be written to an XML file. Nevertheless, in conventional systems, the price display object would be limited such that if a different source of data, for example, an XML file rather than an EXCEL file, has to be used, the object has to be modified to incorporate access to and manipulation of the XML file. Furthermore, if a different set of fields are retrieved, for example, latitude and longitude (i.e., data fields unrelated to pricing information), a new object to display latitude and longitude may have to be written to display such information in tabular format.

Table I below shows the data configuration of a typical object.

TABLE I

| | |
|---|---|
| State/Properties: | Name, SSN, position, DOB, and . . . |
| Behavior: | Record[] |
| | getRecords(DateRange) |
| | promote () |
| | . . . |

For an application to be able to use this data object, the application would need prior knowledge of object properties (state) and behavior. The application would be tightly coupled with the class from which the object was instantiated. The meaning and intent of the data might be found in the source code or by asking the original programmers (e.g., SSN is social security number stored as string rather than a numeric type).

Assuming the object was created by one application written independently of another, the object could not be intelligently exchanged between the first application and the other with the expectation that the object would be processed unless the applications were tightly coupled. A way to have objects be used in various applications is thus highly desirable to reduce programming time and resources.

Common OOP languages include “Java” from Sun Microsystems, Inc. of Palo Alto, Calif., USA, C++, Simula, and Smalltalk.

Framework

The concept of a framework is an important part of OO programming technique. A framework is a specification of the classes and the relationships between classes such that the framework defines a class hierarchy that can be used over and over again, with overrides and extensions. In this way, an initial problem solution specified by a class hierarchy can be adapted and customized for new circumstances, simplifying program maintenance. In essence, a framework is a set of OOP classes that embodies a predetermined set of attributes and methods for providing a common group of behaviors.

OOP frameworks have been developed in an effort to further reduce program development costs. An application program developer utilizes the framework and builds upon it, starting with the classes, attributes, and methods defined by the framework designer and adding subclasses and attributes and modifying methods depending on the problem to be solved. Such changes to the framework are typically referred to as framework extensions, and are made possible by the OOP notions of inheritance and polymorphism. Thus, a framework can speed the development of an OO application program. The challenge confronting framework developers, then, is to define a set of classes and methods that best supports the desired problem solution and will accept the most likely framework extensions. Thus, the designer of a framework must carefully assess what framework users will most likely need in the way of classes, attributes, and methods.

It is therefore a technical advantage of the present invention to provide a framework that allows information-handling software to adapt to new data types and formats of information, so that a single application built within this framework has a significantly broader range of compatibilities and domains of usefulness than a conventional application and, further, may automatically interoperate at a structured level with other similarly enhanced applications. In one embodiment of the present invention, desirable applications of data such as determining correlations between political party and land use strategy may be facilitated.

In an embodiment of the present invention, a single information visualization or manipulation application is able to handle many diverse types of information, even those that are conceived and developed subsequently to the completion of development of the application itself.

In another embodiment of the present invention, information from multiple and diverse sources yet sharing some basic feature in common—such as being distributed in geographic space, or being distances measured in meters—can be simultaneously displayed (superimposed) and manipulated within a single application. This invention further provides means of access to common data sources such as relational databases, extensible markup language (XML) streams, and “Java” programming language software objects.

In an embodiment of the present invention, an information-handling application is defined as any software application which is capable of utilizing digitally available structured information in bulk form, such as from electronic files, databases, or internet web sites to provide a display and/or a set of possible manipulations to a user, such as after some internal processing and transformation of the information such as summarizing it, performing computations on it, or selecting a subset. Examples include but are not limited to graphing programs, analysis tools (for handling financial data, statistical, time series, etc.), and interfaces to geographic information systems. Prototypical information-handling applications process structured information that has some form of hierarchical and/or modular structure. In one embodiment, image and word processing applications are not examples of what we term information-handling applications. In another embodiment of the present invention, structured information in bulk form does not include plain text or specific electronic media files such as MP3 files.

A conventional information handling application such as a graphing program comprises two major components: one component handles the intake of information, from storage devices, the network, or user input, and the other component handles the display of the information. There may also be parts of the application that perform computations or transformations on the information before it is displayed. From the developer's perspective, a modular piece of software that handles a portion of (or all of) the data intake function is a data source component, because it provides information to other components within the application. A modular piece of software that handles part of (or all of) either the computation, transformation, or display of information is a data consumer component, because it uses (consumes) information provided by the data sources.

Data sources and data consumers communicate with each other by making function calls. The particular functions and their parameters are defined as part of an internal version of an application program interface (API). The data consumer components handle data that is given them through specific calls on their respective API, so that information provided through data source components written for different applications will not be accepted. This situation provides little opportunity for reuse of data source or consumer components, since each is written to interoperate only with a specific instantiation of the other.

In an embodiment of the present invention, an internal mediation layer is inserted between the data source components and the consumer components that expose data structure in a standardized way. Consumer components are constructed to use this common API, which is suitable for expressing an extremely wide variety of information types. Data source components can be constructed to deliver the information they take in this format, or a small amount of code can be written to translate the output of another source component into the common format. The result of the construction is that any consumer component can work with any data source component regardless of the specific nature of the information involved, or whether one was anticipated during the design of the other. The common API allows consumer components to automatically extract whatever features of information from a particular source they are most suitable for displaying or computing with, and also allows them to utilize all the other features of that information in a generic, unspecialized fashion.

Other embodiments of the present invention comprise: (1) a system for representing information such that: (a) a single fixed interface suffices to describe a wide range of information types, (b) the information is rendered self describing to an extent, and (c) relationships between different information elements are expressed; (2) an apparatus for allowing this information representation to be employed as a medium between data source and data consumer software components; (3) a method and apparatus for attaching clarifying material on “intended use” to information so that consumer components can handle it more appropriately; (4) a method and apparatus for providing a context to all information consumption affording control over security and visibility of data; (5) a method and apparatus for allowing users to transfer information from one consumer component to another through intuitive “drag and drop” and “cut and paste” interfaces; (6) a method and apparatus for developing enhanced information handling applications based on the foregoing framework; (7) a method and apparatus for automatically re-representing data from partially self describing sources including relational databases, XML streams, and Java software objects; (8) a method and apparatus allowing end users using computers distributed over a network to collaboratively view and manipulate information; and (9) a method and apparatus allowing software components distributed over a network to automatically obtain annotations on intent and other aspects of encountered data.

Most aspects of this invention can be implemented in any object oriented programming language such as Smalltalk, Objective C, C++, or Java. Certain aspects of it, pointed out below, are especially suited to object oriented languages such as Java and Objective C that provide for run time self analysis by programs. However, these are in every case peripheral aspects, and the essential parts of the invention may be implemented in an object oriented language like C++ without these capabilities. We will from time to time make reference to a “preferred embodiment” implemented in Java, but this should not be taken to be limiting.

In a preferred embodiment the present invention provides a system and/or framework of software components for purposes of aiding development of information-handling applications. The system and/or framework of object-oriented software components aid the development of applications that read, gather, or receive electronic information and allow the display of such information to and manipulation by users. These applications are structured in a way so that there are distinct data source components and data consumer components. The crucial features of the system and/or framework are the fact that data is seen by consumers only through a standard, conventionalized interface that incorporates: a breakdown into attributes, relationships, semantically-annotated “domain methods”, event-broadcasting of changes in the foregoing to all registered consumers, metadata for each attribute providing certain declarative and procedural information including unit of measure, content length, data quality, default value, comparator function, summary function, validation function, and input/output functions for display and user editing within an extensible set of interface modalities, related data items available for each data item including those in child or generic relationships, and including the ability to store a reference without direct access to the related item itself (it can be reconstructed if needed), and contextualization such that the attributes, relationships, events, and methods available for a data item depends on context (see below).

In a related embodiment, the system and/or framework includes methods for data exposure wherein the system determines automatically which method is employed in any particular case, and the choice is invisible to consumers. Exemplary methods such as, a data source component which directly provides the standard interface, a data source component which is accompanied by a separate Translator component which maps its interface to the standard interface; and a data source component which is automatically inspected by the system to determine what available data fields it has, these are exposed to consumers through the standard interface as detailed above.

In a preferred embodiment, the contextualization provided by the system and/or framework is accomplished by delegating the final responsibility for data exposure to an object termed an “InfoModel” which is able to choose which of the available attributes and methods on an object should be exposed or hidden, and is able to add additional attributes or methods. Preferably, the system and/or framework further provides facilities supporting transfer of data items between consumers, either by user manipulation (cut/paste or drag/drop) or by internal method calls. When a transfer is initiated, the data item is passed without its contextual characteristics (supplied by an InfoModel) to the receiver. The system and/or framework includes facilities supporting the automatic integration of service components (generally comprising management facilities such as menu provision or running of user dialog routines and may or may not have data source provider and/or user interface provider components) into an application. Integration is handled by a plug-in manager object and set of interfaces such that: each service provider is given the opportunity upon loading to query all components (data providers or consumers) existing within the application for whether they desire the service, and if so what parameters they would like to pass to it. The provider then acts on these responses. Whenever new client components are loaded, they will be queried and possibly responded to by all services loaded within the application.

In another embodiment a system for importing partially schematized or structured data sources (such as a database system or an XML document) into a system as described herein. Any application written using the disclosed system and/or framework can then utilize these data sources through a standard interface. In particular, a system and/or framework for performing all or a substantial portion of the functionality outlined herein—if it is in connection with a framework or application implemented using a framework falling under categories as disclosed such as an infrastructure for mediating between information sources and consumers and rapidly assembling applications using them.

Thus the present invention provides a method and apparatus involving two subsystems, one which processes the schema information for a data source to determine the type and metadata information for information attributes from the source, and one which processes the instance information. Preferably, the schema subsystem processes schematic information such as the type information contained in an XML schema document or the column information available from a relational database management system and sets up appropriate metadata and relationship structure for information elements, but it does not necessarily create any information elements. Optionally, additional annotations can be provided by a user in the form of a file specifying how to map attributes in the original data to metadata, relationships, or domain policy attribute or method definitions. Preferably, the instance subsystem processes instance information such as that available from an XML document or set of relational database rows, for which corresponding schema information can be found, and constructs information elements exposed through the standard interface. Data consumers can utilize the outputs of these as if they were custom-created data sources for the type of information described in the schemas.

In a related aspect, implementation of the invention as described herein for both XML and relational databases is provided. In the XML implementation, a built-in data type hierarchy for XML schemas is used to provide types to attributes, and the element-subelement-attribute structural hierarchy in XML schemas is used to determine relationships between information elements. All documents and schema references to other documents are followed up to their sources in order to specify further attribute or relationship information. A user can optionally specify an XSLT (XML Stylesheet Transformations) document that maps the typed data fields found from the instance-schema combination into attributes with richer metadata and/or references to specific domain policies. In the database implementation, the table column heading types from the relational database (date, integer, text, etc.) are used to provide default type metadata to the attributes of information elements derived from table rows of the database. A user can optionally specify a mapping between columns or sets of columns into attributes with specific metadata. Furthermore, a user can define a sequence of queries for which the results are to result in a hierarchy of information elements. For example, for each information element retrieved from, for example, Query 1, a parameterized instantiation of Query 2 may be applied to retrieve elements which will be exposed as the children of the first information element. For each of these elements, a parameterized instantiation of Query 3 may be instantiated, and so forth.

Framework Block Diagram

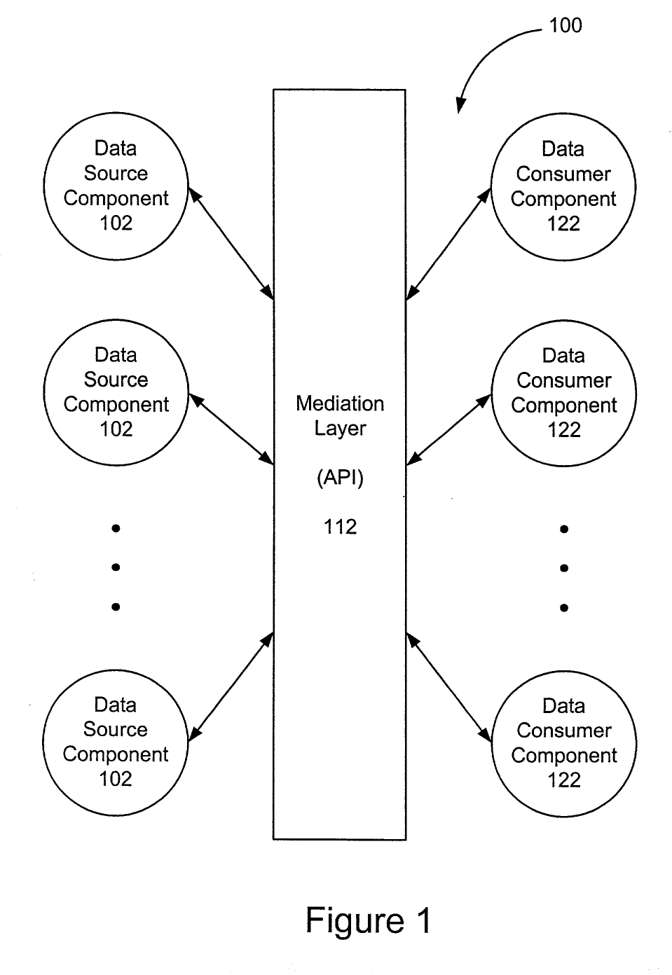

FIG. 1 shows a basic block diagram of a framework that is implemented in accordance with the present invention. The framework 100 of FIG. 1 can be used to develop, for example, an information-handling system or application wherein data source components 102 and data consumer components 122 are separate and independent from each other but can communicate and share data. The framework 100 described herein shall be called the extensible information system (XIS) framework.

From a developer's perspective, a modular piece of software that handles part or all of the data intake or retrieval function is a data source component 102. A modular piece of software that handles part or all of either data computation, transformation, presentation, or display of information is a data consumer component 122. A conventional information-handling application such as a graphing program comprises two major components: one side handles the intake of information from storage devices, the network, or user input, and the other side handles the display or presentation of the information. There may also be parts of the application that perform computations or transformations on the information before it is displayed.

XIS Framework

In the XIS framework 100 constructed in accordance with the invention, there may be more than one data source component 102 (also referred to as a source, data source, source component, and source object) and there may be more than one data consumer component 122 (also referred to as a consumer, consumer object, consumer component, and data consumer). The data source components 102 provide information to other components within the XIS framework 100 via a mediation layer 112, while the data consumer components 122 use the provided information.

The source components 102 and consumer components 122 that comprise the XIS framework 100 are configured such that they communicate with each other in a manner that is supported by the programming environment in which the framework exists, typically by making function calls, via the mediation layer 112. In one embodiment, the mediation layer 112 consists of a group of application programming interfaces (APIs) or class libraries that define a common format for data exchange, establishing an information exchange standard. Thus, data source components 102 configured for a different system, application, or framework may still be used within the XIS framework if they are “wrapped” in a predetermined way or are suitably modified, as will be known to those skilled in the art, such that they conform to the requirements of the data exchange interface of the mediation layer 112.

A relatively simple block of programming code may be produced to translate the output of a data source component 102 into the common format as defined by the mediation layer or API 112. In this way, any consumer component 122 may work with any data source component 102 regardless of the specific nature or type of information involved and regardless of whether the data source component was known or anticipated during the design of the data consumer component. Because of the XIS framework described herein, the data consumer 122 may also extract whatever features or sets of information that it needs or can process from one or more data source, thereby enabling the data consumer to utilize features and information in a generic unspecialized fashion.

The mediation layer 112, which is between the data source components 102 and the consumer components 122, exposes the data structure of the data source components 102 in a manner that is common for the framework, preferably through an API interface. Data consumer components 122 are constructed to use this common API, including utilizing the exposed data structure. The data consumer components 122 are suitable for expressing an extremely wide variety of information types. In addition, the data consumers may be constructed to deliver the information received from the mediation layer to another data consumer component, or to output the information received for display.

Data consumer objects 122 are application or software objects or components that use data, or may be said to consume it. Examples of data consumers include display programs that display data in tabular format, in graphical mode, in organizational chart mode, spreadsheet mode, timeline mode (similar to files in the format of the “PROJECT” application from Microsoft Corporation), and the like. Data consumers may be desktop based, web-based (Internet-based), distributed architecture, interpreted programs, and the like. Data consumer components within the XIS framework may provide display, computational, or interactive facilities. In the present description, such specially configured data consumer components are referred to as “INFOBEAN” objects, as available from the assignee of the present invention, Polexis, Inc. of San Diego, Calif., USA. Those skilled in the art will understand how to extend the framework 100 to produce desired applications, in view of the description herein.

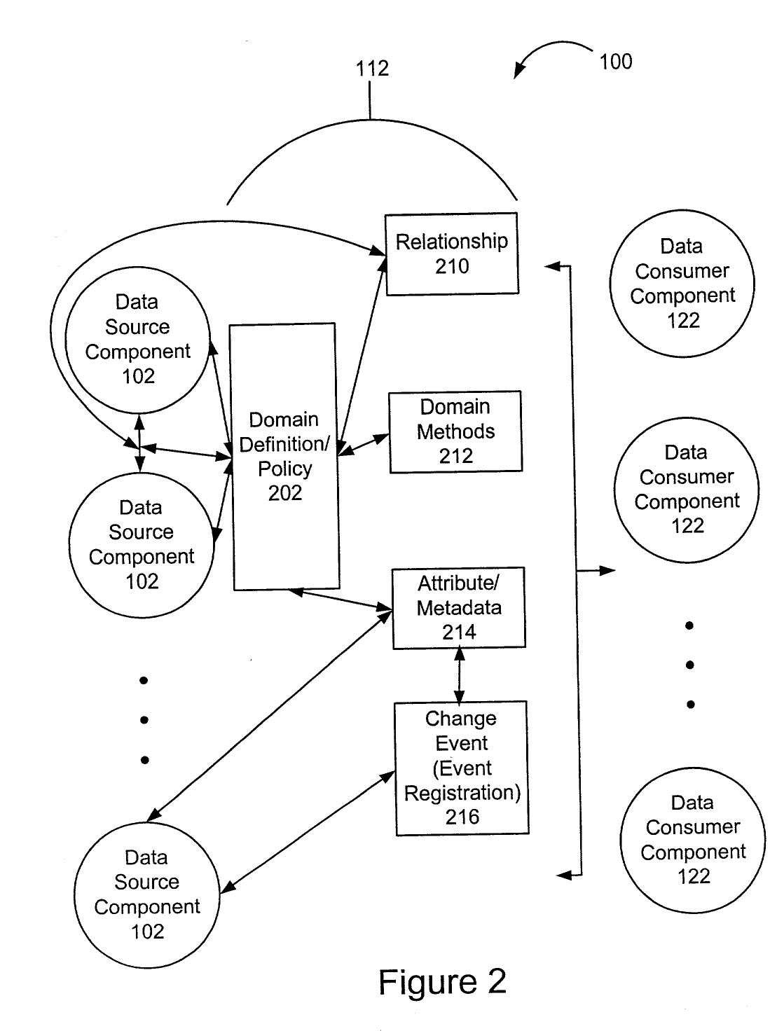

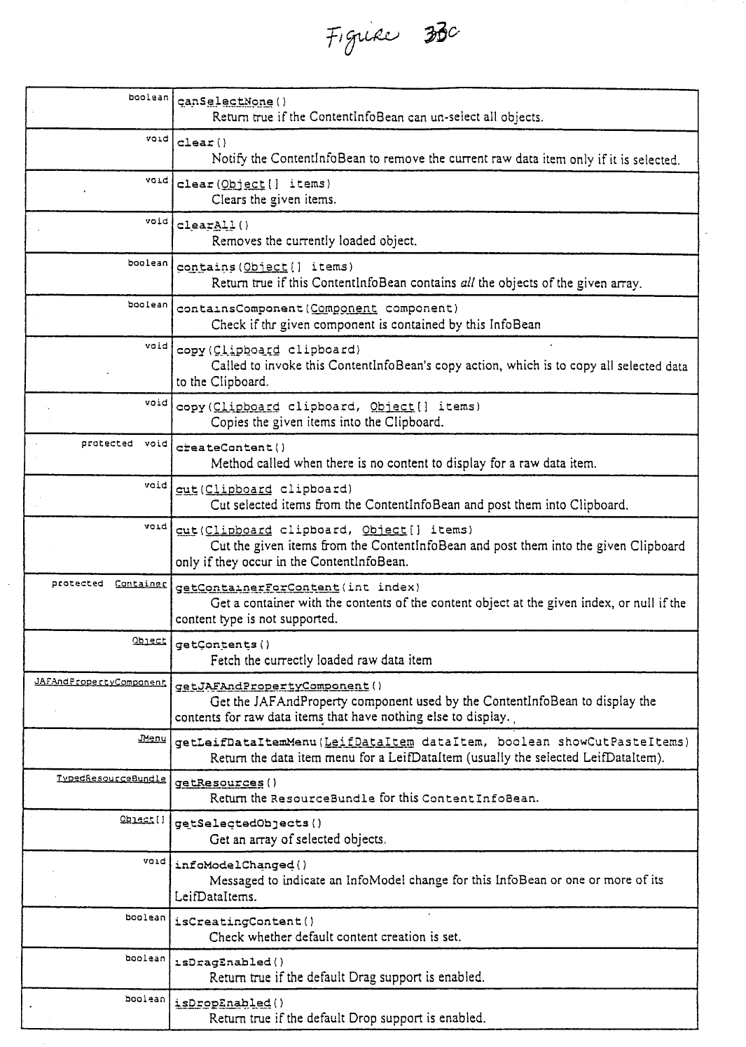

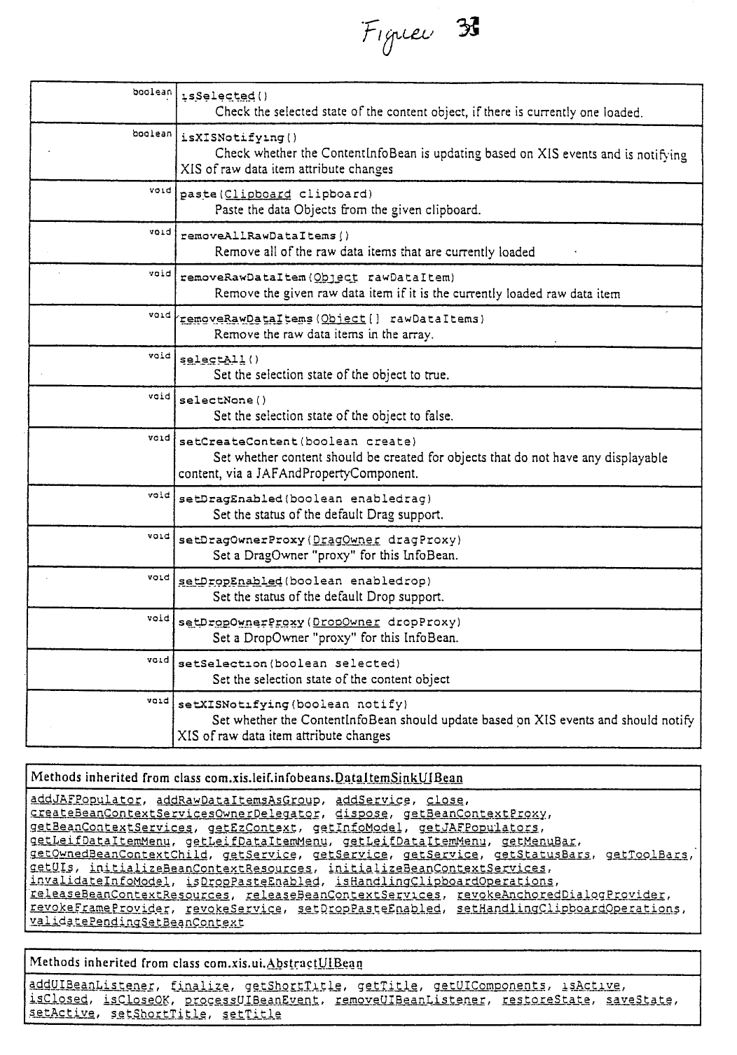

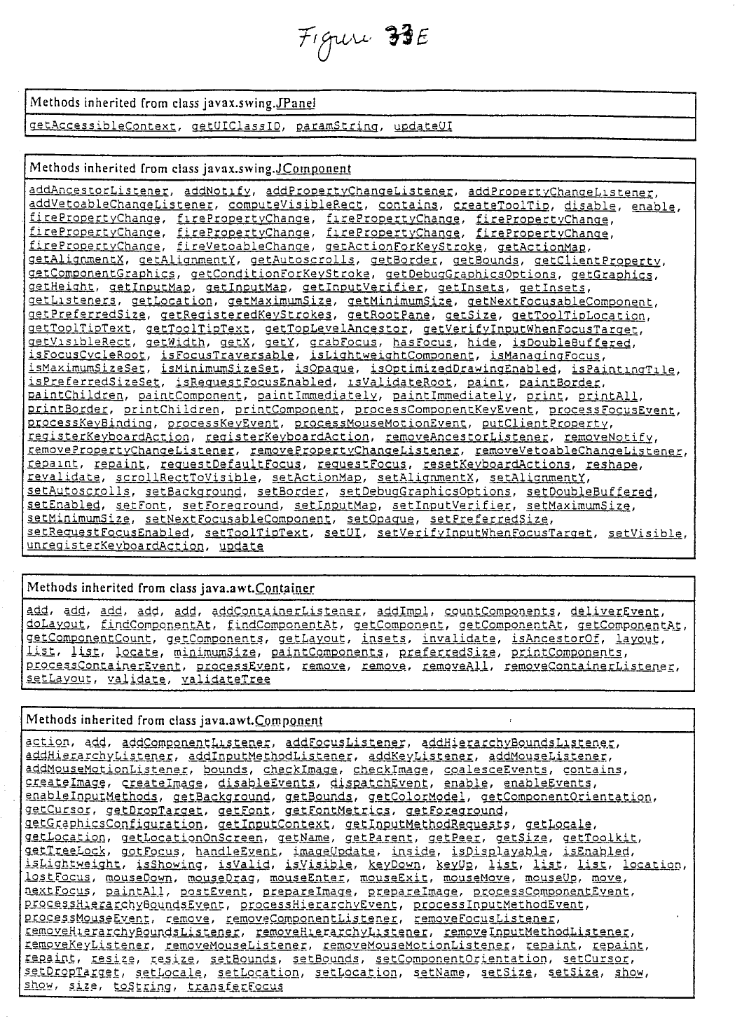

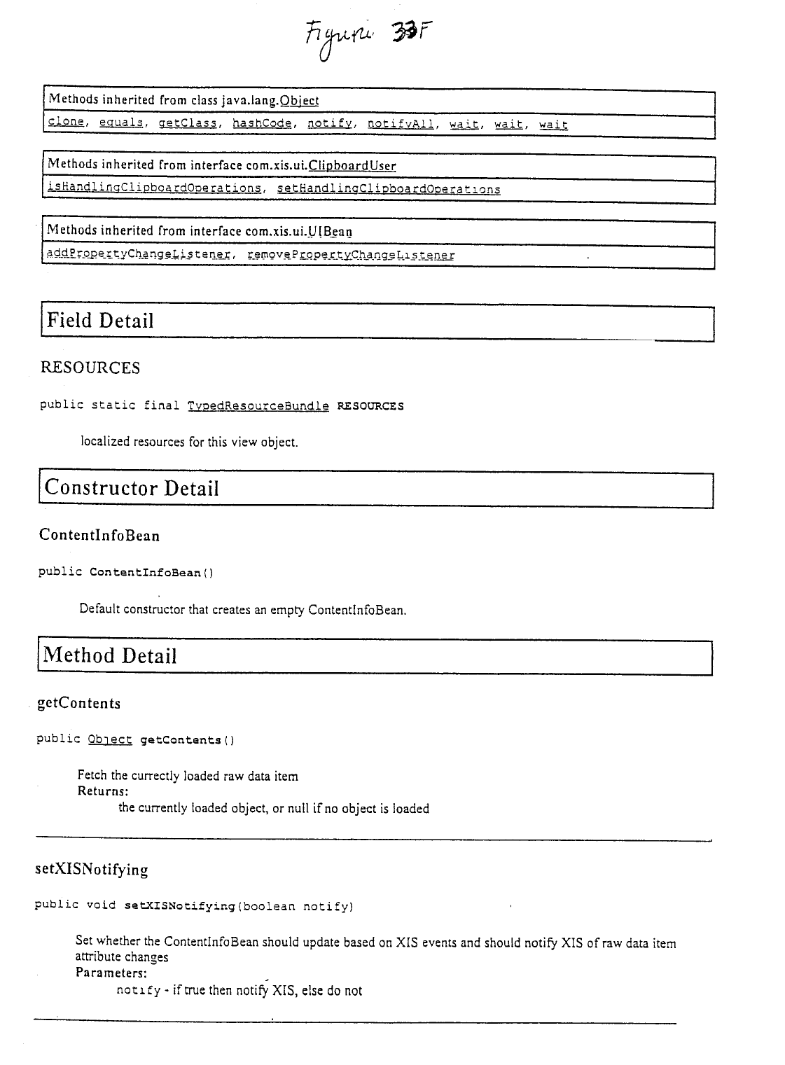

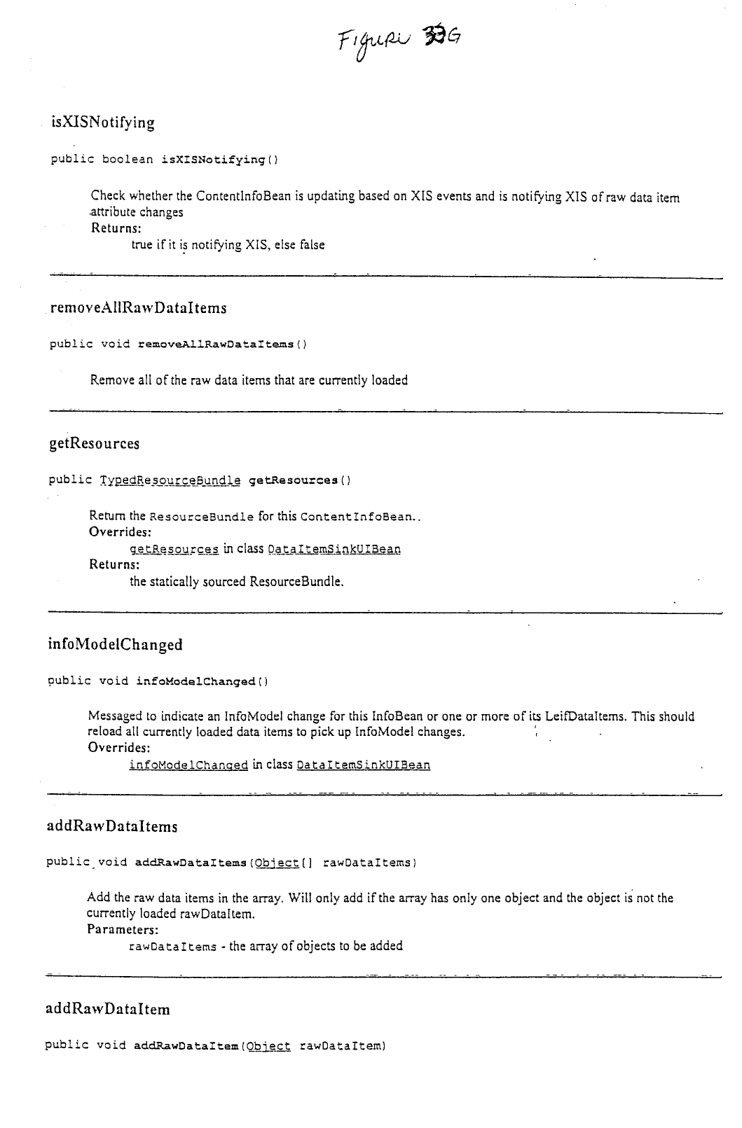

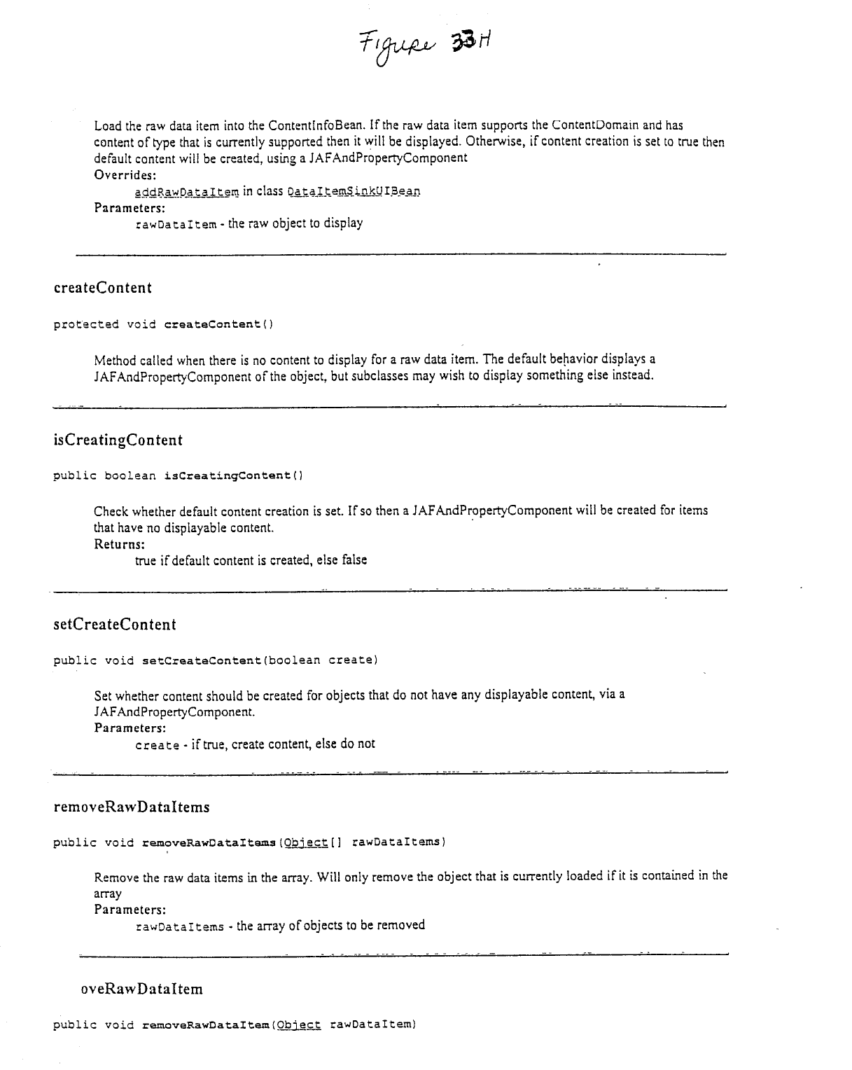

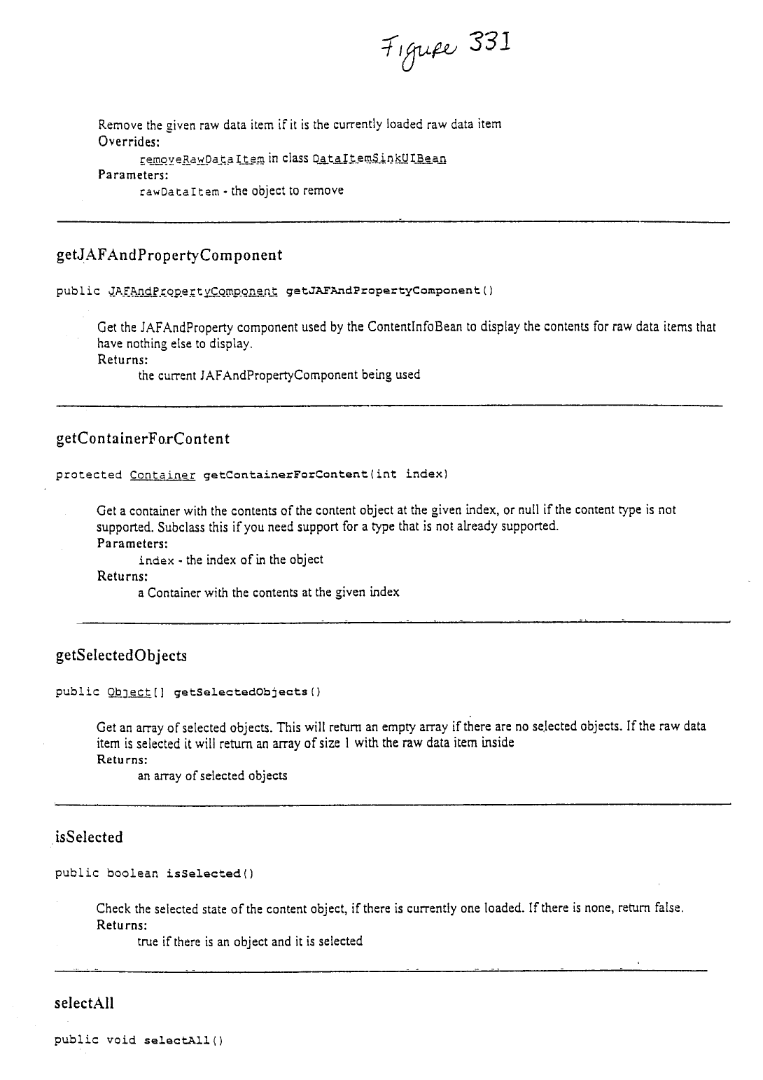

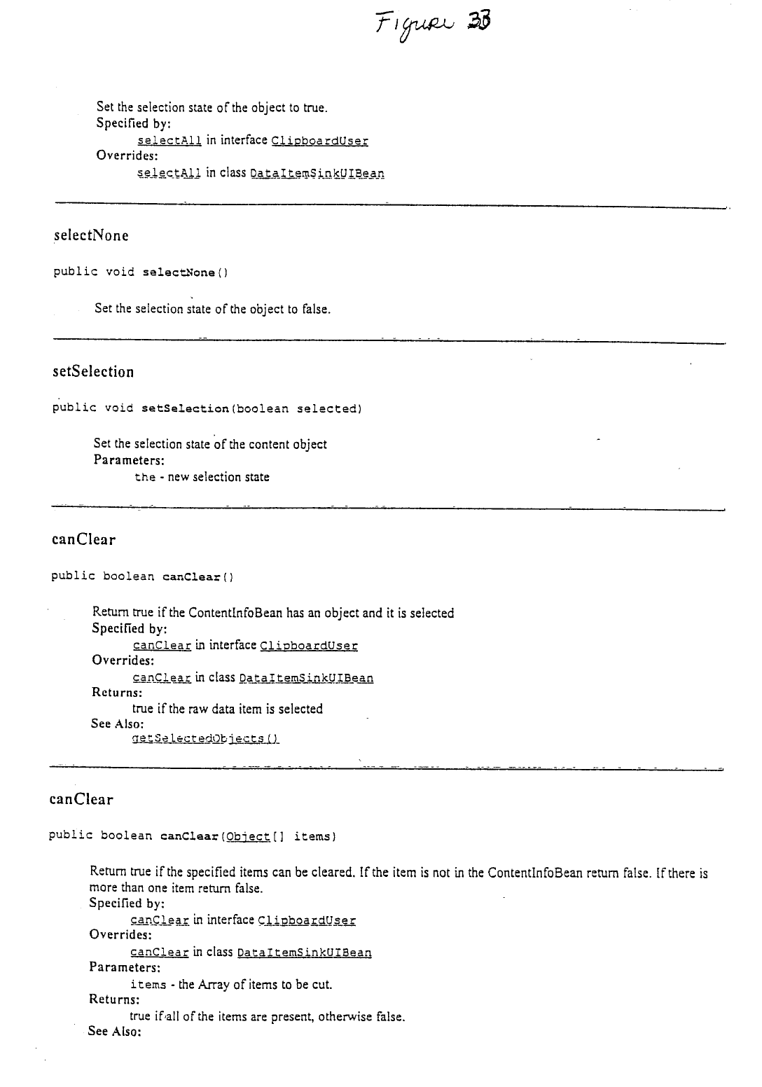

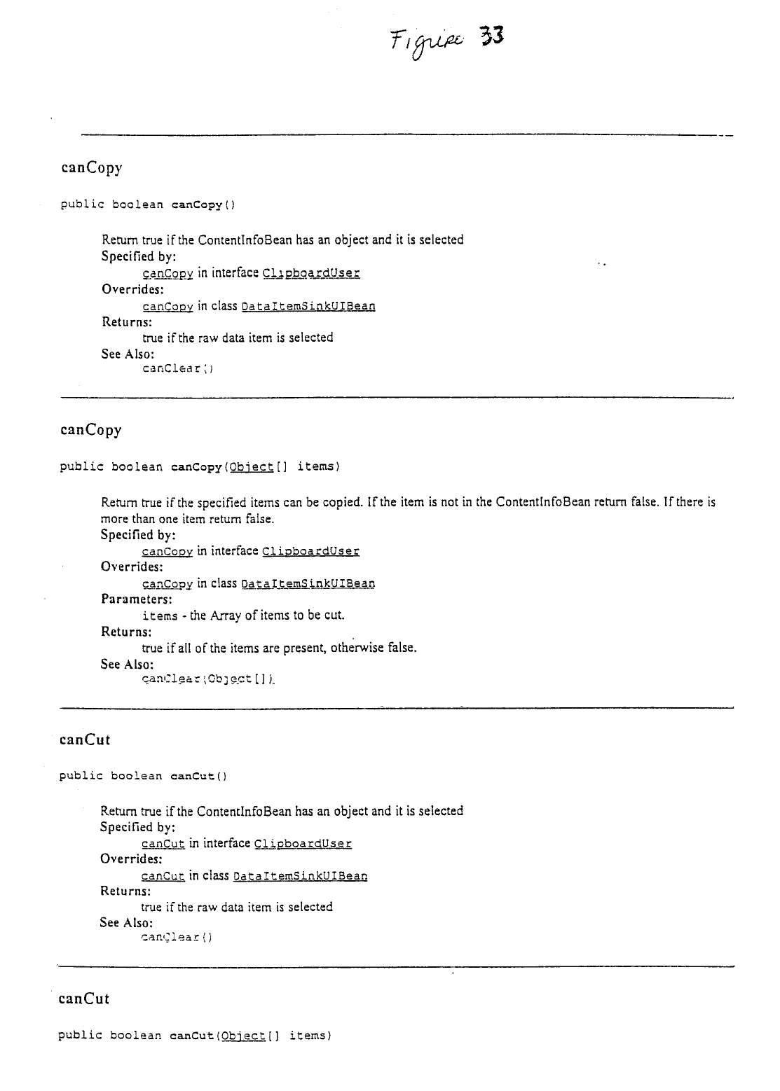

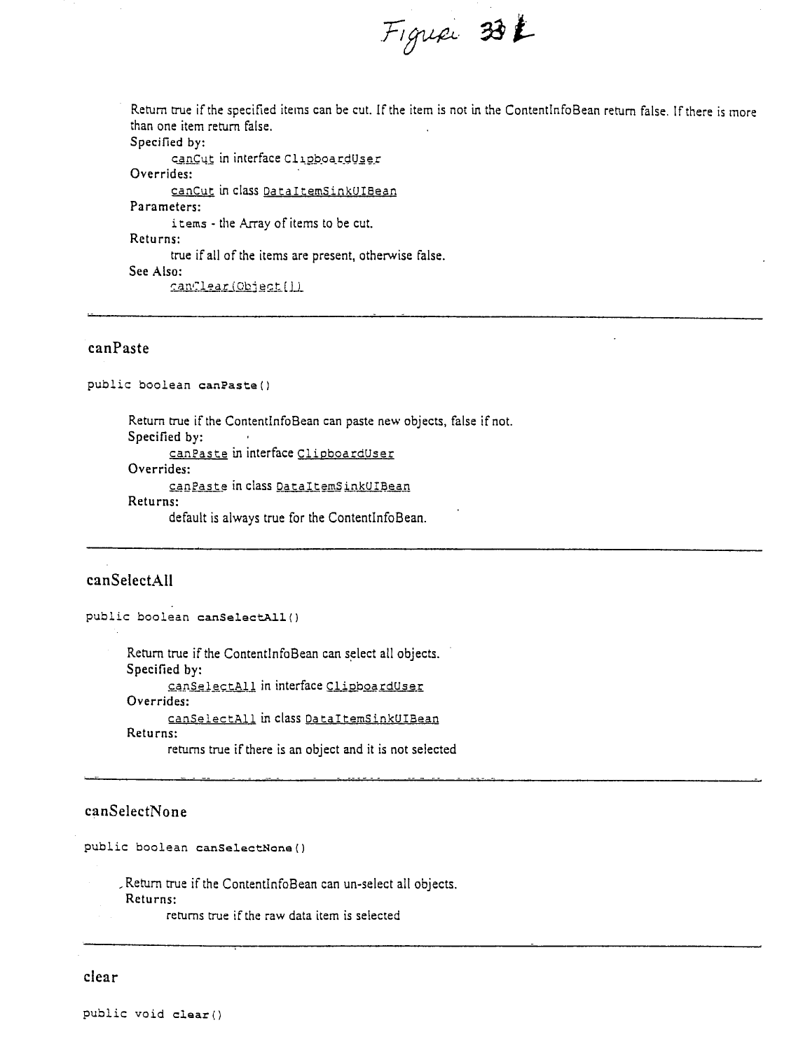

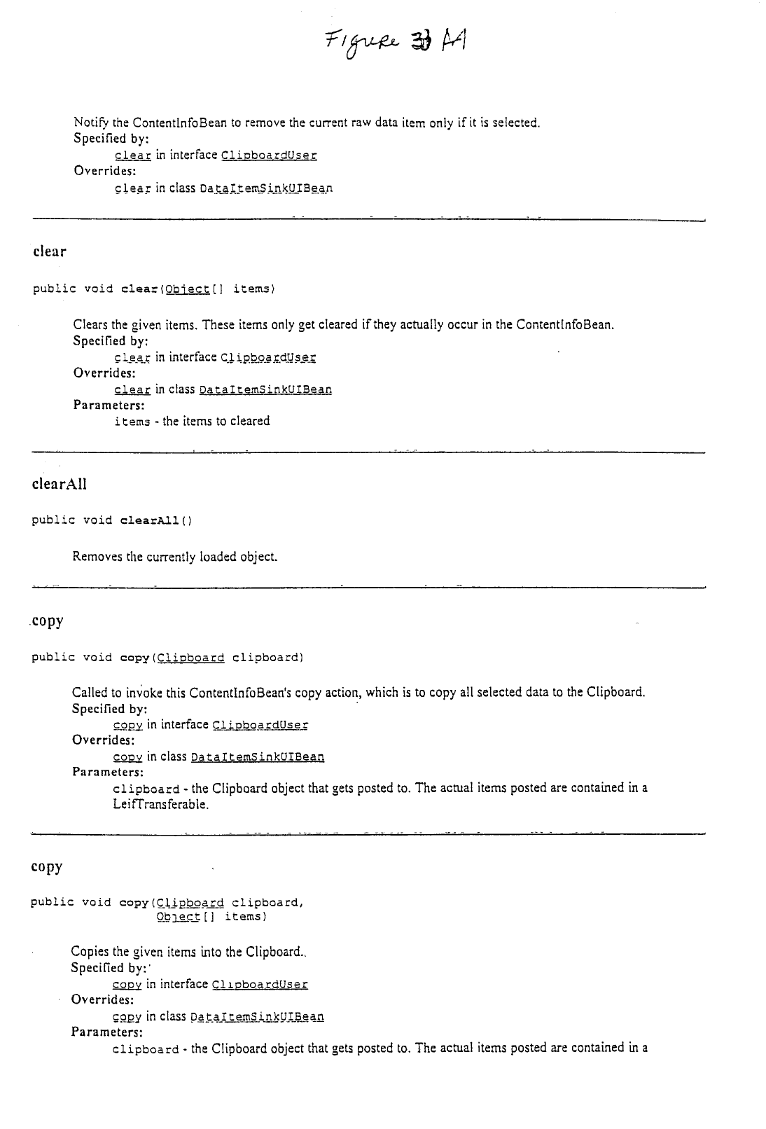

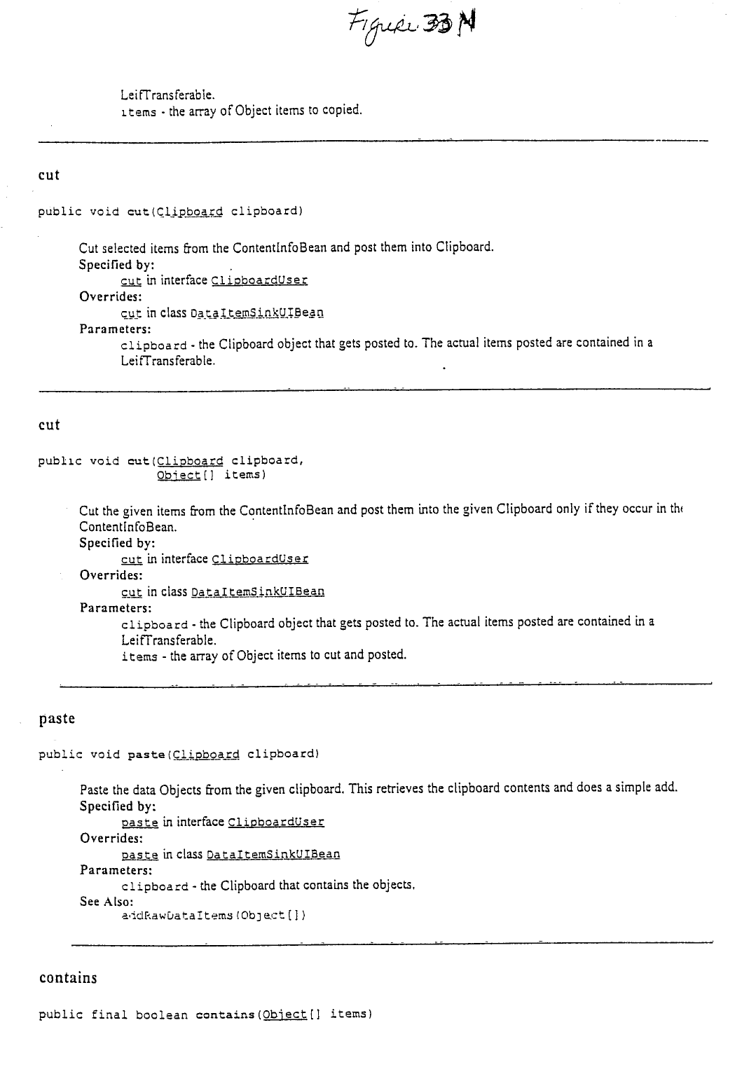

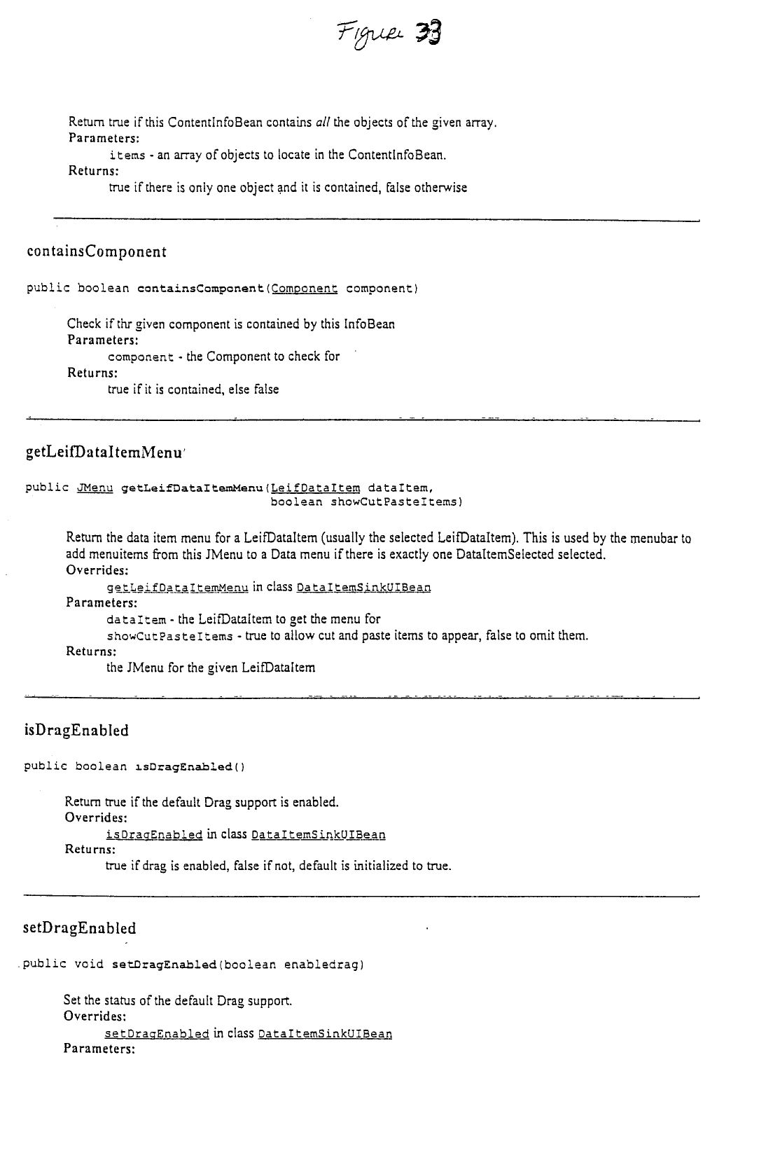

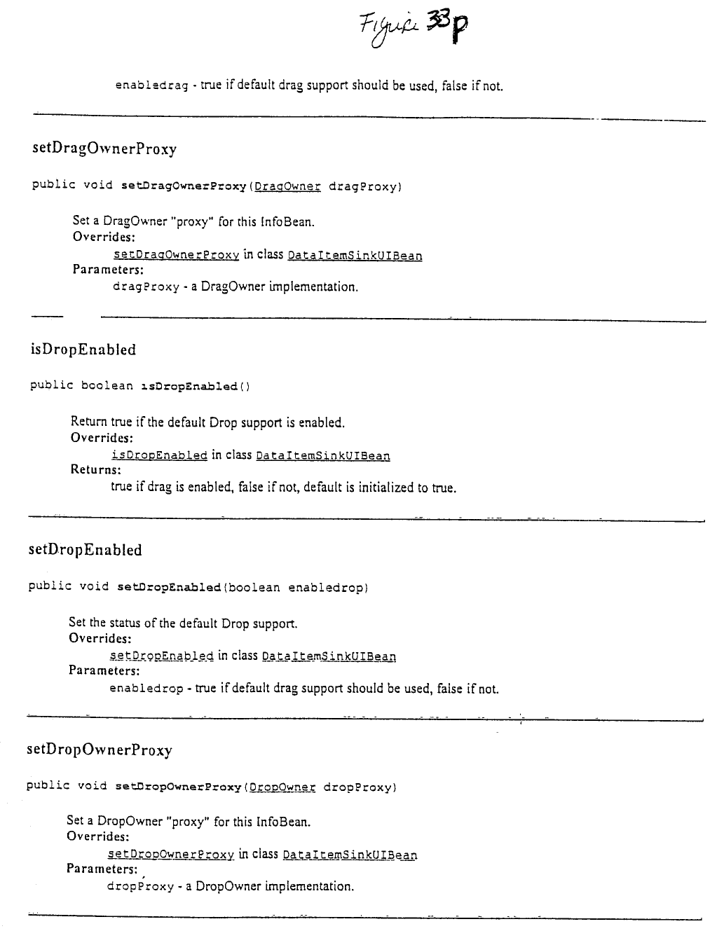

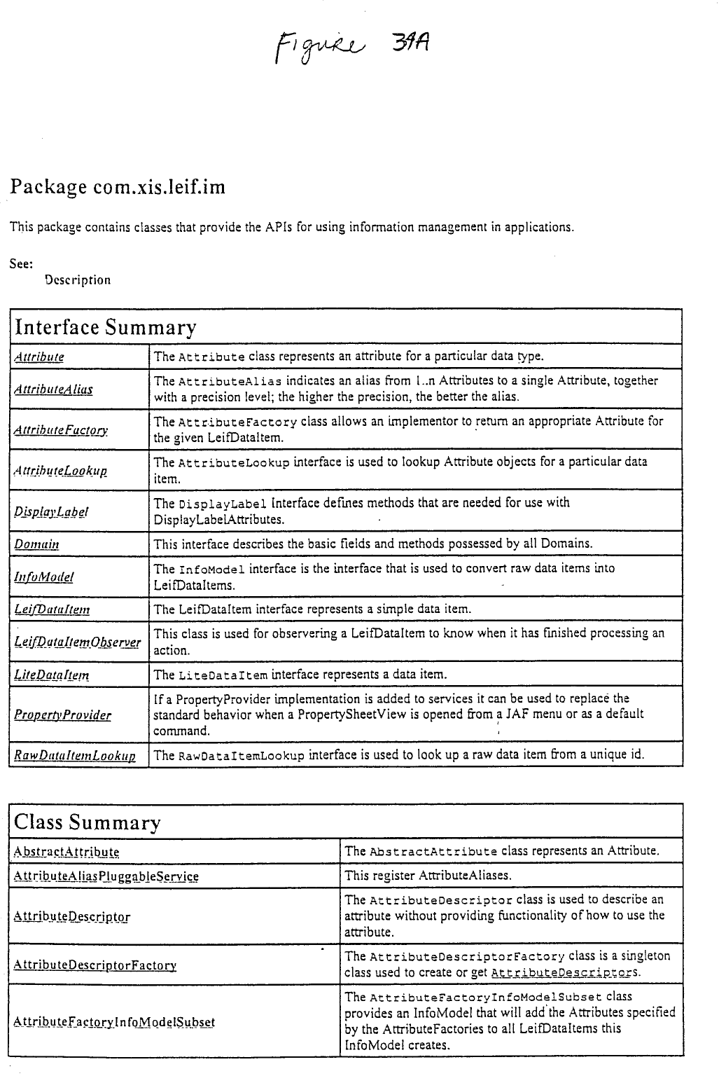

FIG. 2 shows additional details of the mediation layer 112 in the framework 100. In the framework 100, four special types of interfaces may be exposed to the data consumer components 122. These four interfaces include Domain Definition or Domain Policy 202, Relationship 210, Attributes/Metadata 214, and Change Event 216. In one embodiment, change events are registered within the XIS framework 100. These interfaces may be exposed, for example, through class and object libraries that may be developed for the XIS framework. With these pre-defined class and object libraries and APIs, developers of data source components 102 and data consumer components 122 may independently develop their own source and consumer components, thus facilitating development of information-handling applications or systems. An example of a class that may be implemented or written in the mediation layer to facilitate development of source and consumer components is illustrated in FIGS. 33A to 33P, which show details of a sample class called ContentInfoBean.

Domain definitions or policies 202 (also referred to as domain objects or simply domains) are optional within the XIS framework 100. If defined, the corresponding Domain methods 212 for such policies are exposed to the data consumers 122. Other information about the domain policy may also be exposed, such as Attributes/metadata 214 and Relationships 210 for that particular Domain Policy. Attributes/Metadata 214, Change Events 216, and Relationships 210 may also be exposed within the XIS framework 100, even if domain policies are not defined.

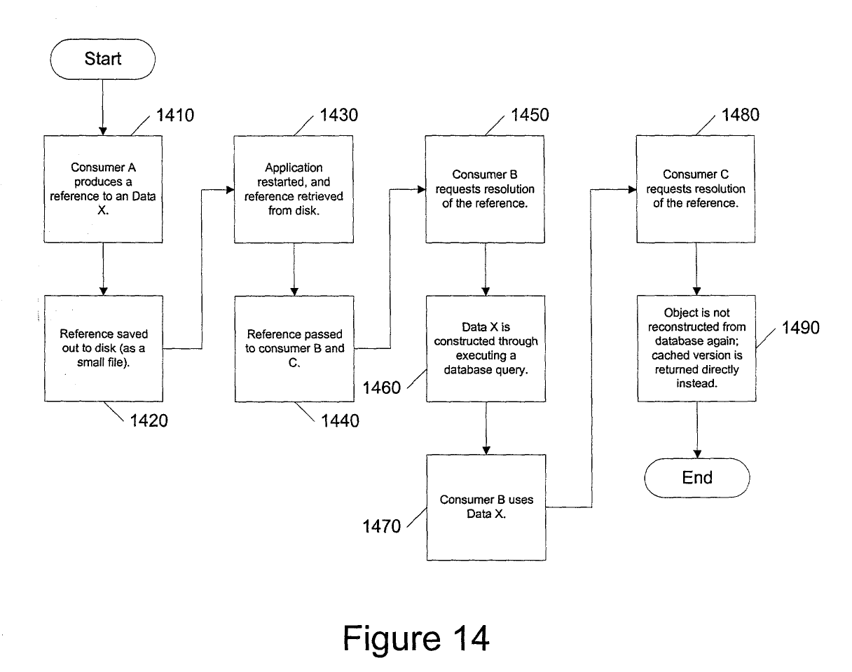

Relationships show the relationship between data source components. Containment, hierarchies, and ad-hoc relationships, for example, may be shown. They may be expressed as “members of” and references. Relationships are thus recognized and may be obtained accordingly, as shown in FIG. 14 described further below.

Change events may be used to ensure that all consumer or source components that have an interest in another source component's data are notified when changes occur. Changes may be notified when attributes, members (or containers), or references (or referrers) are added, updated, or removed and when values are changed.

Once a data consumer component 122 obtains a reference to a data source 102, the data consumer component may obtain access to these interfaces 202, 210, 212, 214, 216 through method calls in accordance with the programming environment of the host computer system. The data consumer 122 obtains such a reference typically in preparation to consume or use information from at least a particular data source 102. Examples of such consumer component method calls include:

get attributes;

get member and container information elements;

get referred and referring information elements;

get unique ID and selection state;

add and remove instance specific attributes;

register to be informed of changes to attributes or relationships; and

invoke method calls of a semantically annotated type, described below.

These types of method calls will be familiar to those skilled in the art and familiar with the programming environment of the host computer system.

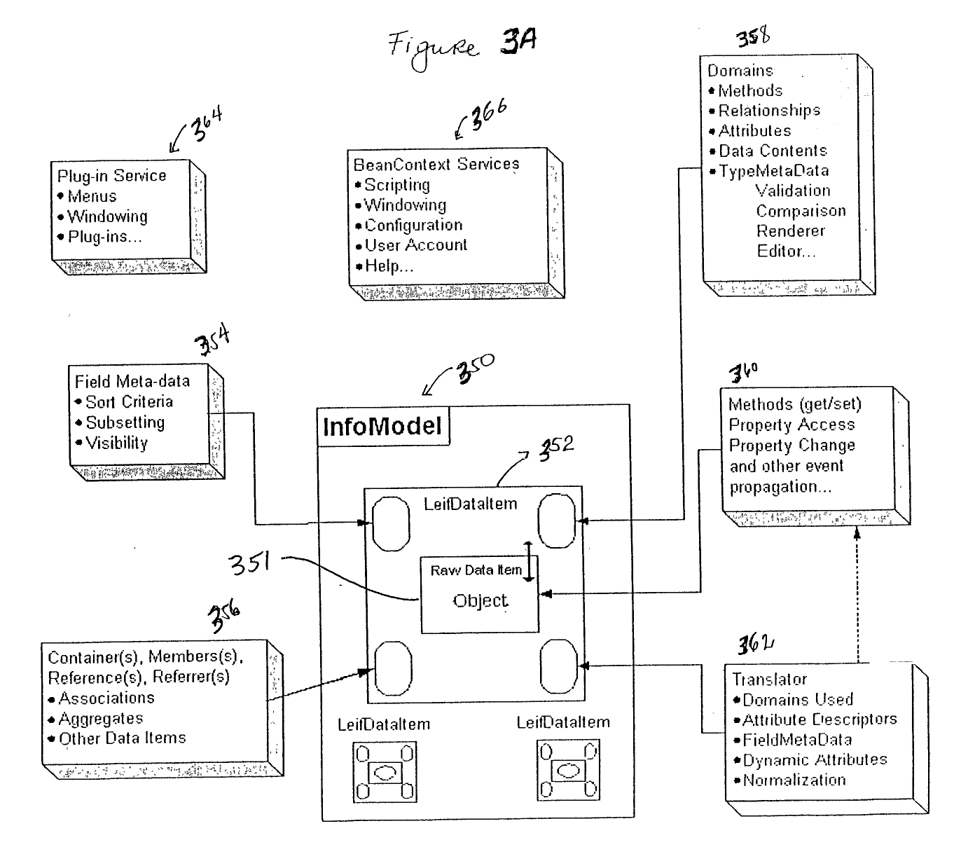

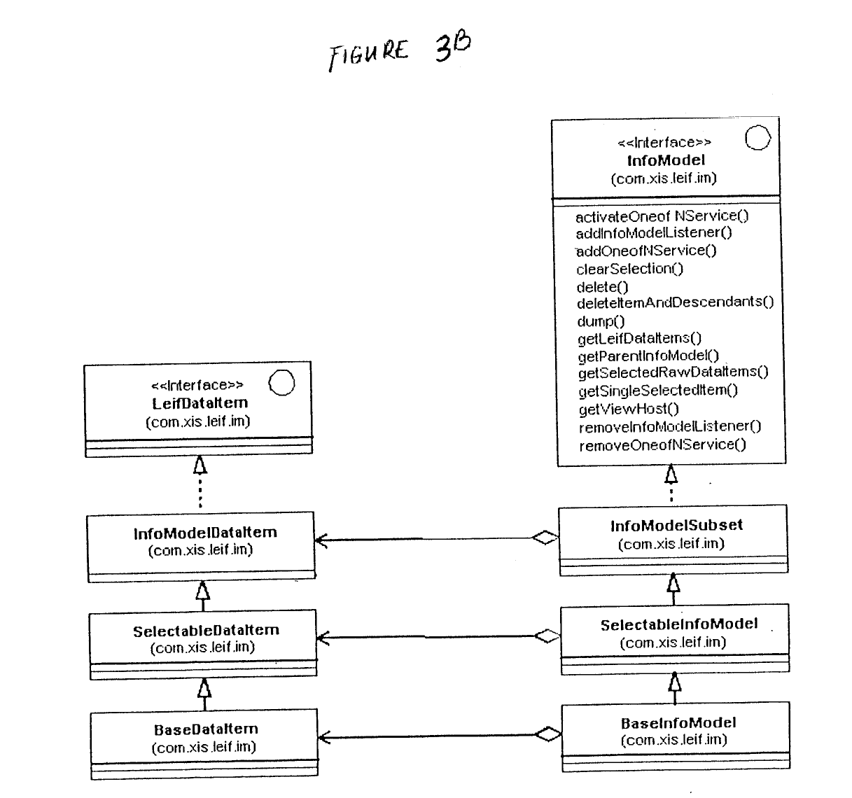

FIG. 3A is a schematic diagram showing the information about data source objects that is exposed by the mediation layer 112 in FIGS. 1 and 2, as well as the services available within the XIS framework 100. In accordance with the invention, data source components are wrapped with an object that exposes the interface information for the data source to data consumers through the mediation layer.

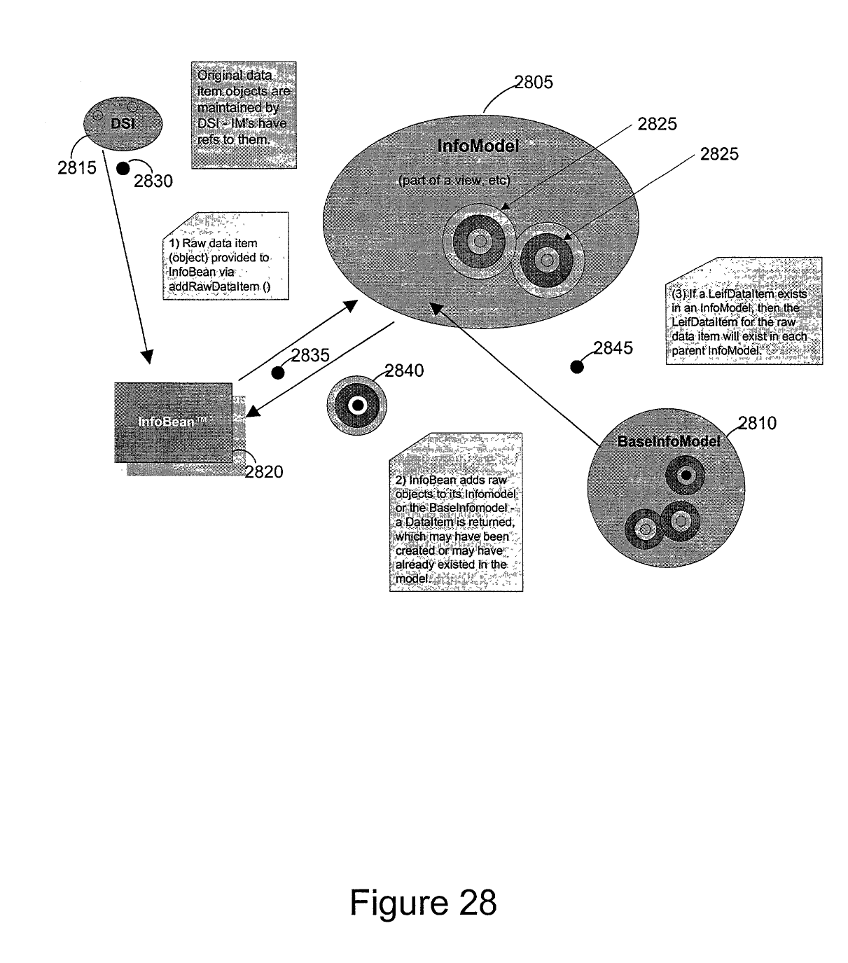

In the preferred embodiment, the wrapper around each data source is an object provided by a class called InfoModel. As shown in FIG. 3A, a data source comprising a raw data item 351, via the APIs 112 as described above, offers a variety of information, as shown in the blocks 354, 356, 358, 360, 362, through which data consumers may gain access to the data source. The information represented by the blocks 354, 356, 358, 360, 362 is exposed or may be contained within an InfoModel 350, which provides an information space for all information available in the XIS framework 100 for the wrapped data source component. In one embodiment of the invention, the data needed by data consumers are accessed via such InfoModels (such as further illustrated in FIG. 28). The wrapper provided by the InfoModel is called a LeifDataItem object 352. Thus, the InfoModel is an interface that permits data sources and data consumers of the XIS framework to independently share their data. In this way, the methods 360, domains 358, metadata 354, relationships 356, and other information of a data source object are thus exposed using the InfoModel object, which may be said to exist in the mediation layer 112, which sets up contexts for data consumption. The XIS framework also provides additional data services through the mediation layer, such as the Plug-In Service 264 and BeanContext Service 266 indicated in FIG. 3A. These services provide the functionality listed in their respective boxes 364, 366. Other data services may be provided, as desired.

The InfoModel object provides a context for information access, i.e., context is instantiated through the InfoModel concept. In this way, security may be enforced, considering that the conceptual or real “end-user” accessing the information is known and thus the underlying data source may be forwarded correctly. Furthermore, through this InfoModel concept, an embodiment of the framework may be implemented such that attributes and methods may be added or removed by the framework user. Original attributes and methods in one context may also be overridden.

An attribute is any property of an object. In one embodiment of the invention, an attribute may be coded with an “AttributeDescriptor”. An AttributeDescriptor is provided by the object or its Translator to describe a property of the object using TypeMetaData, e.g., how to display it, how to edit it, its permitted ranges, and the like. Translators map data source-specific structures and types to an XIS-generic representation. Translators are further discussed below. Attributes may also be defined using Java introspection or reflection, as discussed further below.

Dynamic attributes may also be exposed within the XIS framework 100. These attributes are attributes that are exposed during run time, such as, for example, a database query wherein each column is an attribute revealed at run time. The mediation layer has a mechanism that captures such information. In the preferred embodiment, the XIS framework operates in conjunction with a database management application, so that the mediation layer utilizes run time database query mechanisms that generate-metadata of the data object, such as data table column headings, data types, and the like. Such mechanisms may be provided, for example, by SQL queries and the like. In one embodiment, data consumer applications using the XIS APIs are unaware of whether an attribute for a data item is obtained dynamically or statically, so that the process is transparent to the application user.

A domain is a collection of semantically meaningful attributes and method signatures grouped by their common domain of interest. Examples of domains include a Display Domain (a domain that describes how to display information) or a Geo Domain (a domain that specifies how to handle geographic information). Domains are further discussed below.

The contextualization provided by the XIS framework system is accomplished by delegating the final responsibility for data exposure to an object termed an “InfoModel”, which is able to choose which of the available attributes and methods of an object should be exposed or hidden, and is able to add additional attributes or methods. Preferably, the system and/or framework further provides facilities supporting the transfer of data items between data consumers, either by user manipulation (cut/paste or drag/drop) or by internal method calls. This supports data sharing among data consumers. When a transfer is initiated, the data item is passed without its contextual characteristics (which are supplied by an InfoModel object) to the receiver, i.e., only non-contextual information is transferred. In this way, the source data may remain unchanged.

As illustrated in FIG. 3A, a FieldMetaData file 354, a type of metadata, is used to represent sorting, subset, and visibility criteria for an attribute. This is further explained below in conjunction with Examples 1 to 5, wherein subsets of data are shown depending on whether “All Attributes” or “Preferred Attributes” are shown. In one embodiment of the invention, default behavior method of domain policy attributes may also be overridden. Within this framework, context-specific special attributes for flagging whether a data item should be visible or not (e.g., can be used for display filtering, including the XIS value slider, tree checkboxes in the map view, etc.) may be defined. This may be achieved through the mediation layer by utilizing a user interface to modify display processing for the data item. Furthermore, a selection attribute that is a context-specific special attribute for flagging whether an object is “selected” (and typically should be highlighted) may also be defined. Selected pieces of information are often shared among views (context-specific, though), and certain operations may be performed on the set of selected objects in a given context The InfoModel objects as described above know how to return a data item (a LeifDataItem) given a corresponding raw data source identifier. The InfoModel also manages these data items. As indicated in FIG. 3A, an InfoModel may contain one or more LeifDataItem objects, each of which provides an interface to a raw data item. An application developer may use an InfoModel object 350 to get a LeifDataItem object 352 in order to use the XIS APIs for accessing the underlying data source in a generic fashion. If two different data consumer components ask for a data item (e.g., a LeifDataItem) from the same InfoModel for the same raw data source, then both data consumers will get the same instance of the LeifDataItem object. InfoModel objects may also be nested as indicated in FIG. 3B.

Information becomes normalized in the XIS framework so that any application can use an object's information by getting attributes and relationships dynamically at runtime. Therefore, instead of hard-coding a visualization program to a specific type of object, the visualization looks for the attributes it needs to perform its function. Thus, the developer of the data consuming module may obtain the information needed from the XIS LeifDataItem class, which wraps raw data item objects and exposes them to the data consumer through uniform APIs. The visualization can access all the information exposed, through the XIS APIs and techniques, as needed. If the data source provides AttributeDescriptor objects or translates the properties to domain attributes, then the information can be interpreted more intelligently in domain-specific ways. In one embodiment of the invention, the XIS framework also offers APIs and a programming model (or design pattern) that extends Sun's JavaBean pattern with XIS information awareness. These extended JavaBeans comprise “smarter JavaBeans” that are provided in the XIS framework as the specially configured INFOBEAN objects and, like JavaBeans, INFOBEANs can be visual or nonvisual components, and can be graphically combined in any standard Java development environment.

InfoModel Class Objects

In one embodiment, there are four types of InfoModels in the XIS framework:

BaseInfoModel:

A single BaseInfoModel is required because it is responsible for creating and caching every BaseDataItem (data item) wrapping a Java object (the raw data item object). The BaseInfoModel object holds any object used as a LeifDataItem until the data item is no longer needed (i.e., until it is no longer strongly referenced).

SelectableInfoModel:

A super class of BaseInfoModel, this InfoModel delegates to any other InfoModel (typically the BaseInfoModel), and creates SelectableDataItems (data items that are selectable). The SelectableInfoModel objects add a selected Boolean attribute and delegate to the LeifDataItems from the prior InfoModel. Since the BaseInfoModel is a SelectableInfoModel, all LeifDataItems have a selected attribute. This is true because any LeifDataItem is either in the BaseInfoModel itself, or is in an InfoModel that is nested in the BaseInfoModel and, therefore, inherits the selected attribute from the BaseDataItem. Additional SelectableInfoModels can be instantiated to create independent contexts for selection state, independent of other InfoModels.

AttributeFactoryInfoModel:

This InfoModel allows AttributeFactory classes to be registered so that every time a LeifDataItem is created, it enables attribute factories to add additional attributes to each LeifDataItem.

InfoModelSubset:

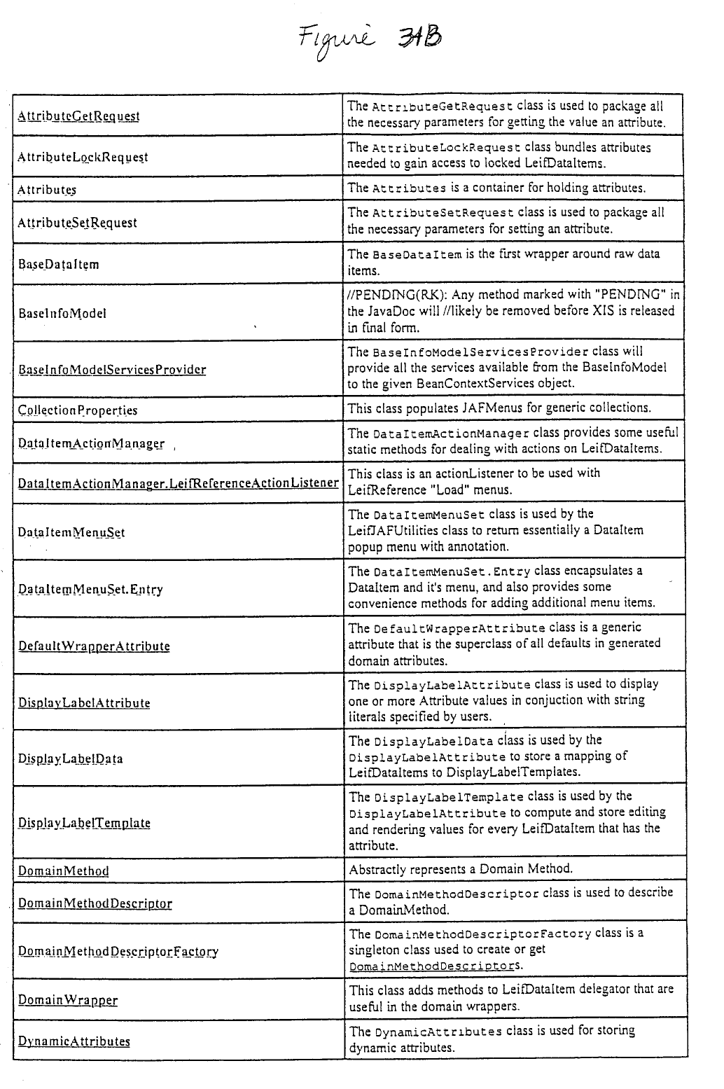

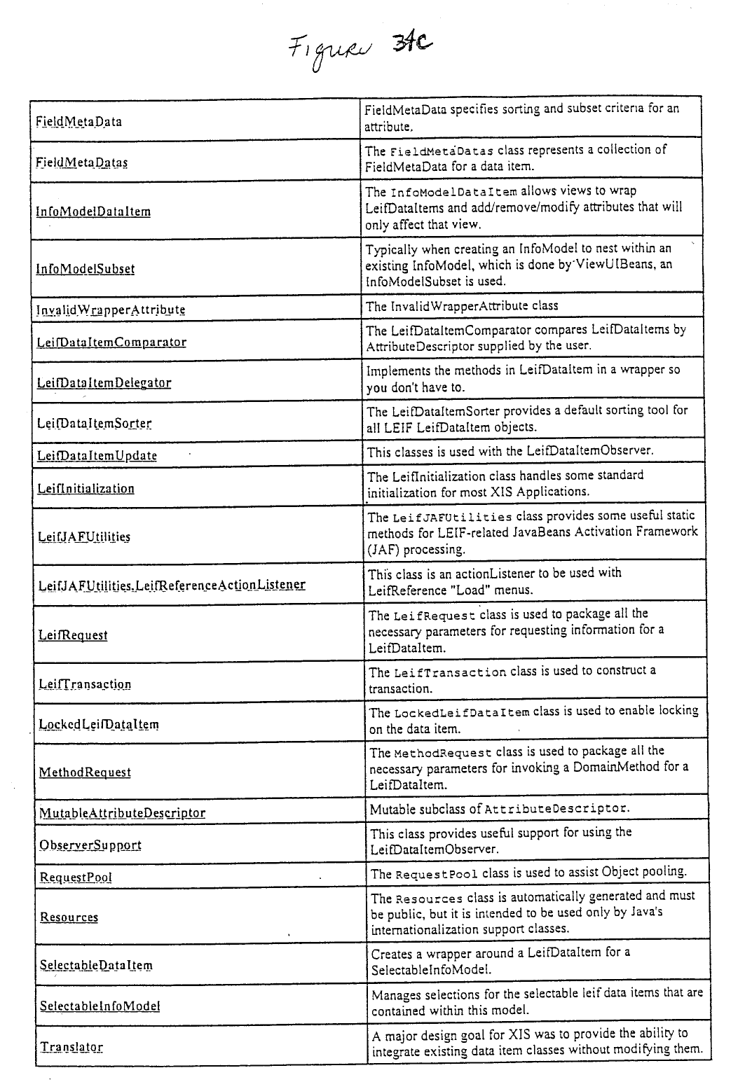

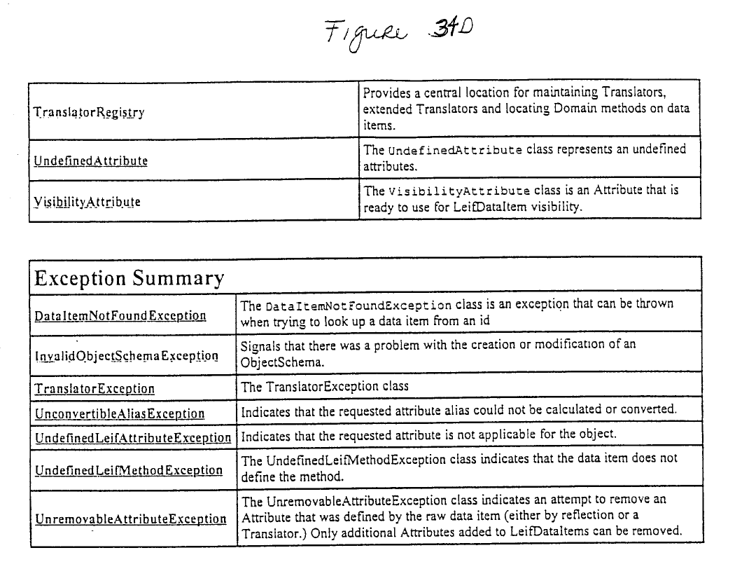

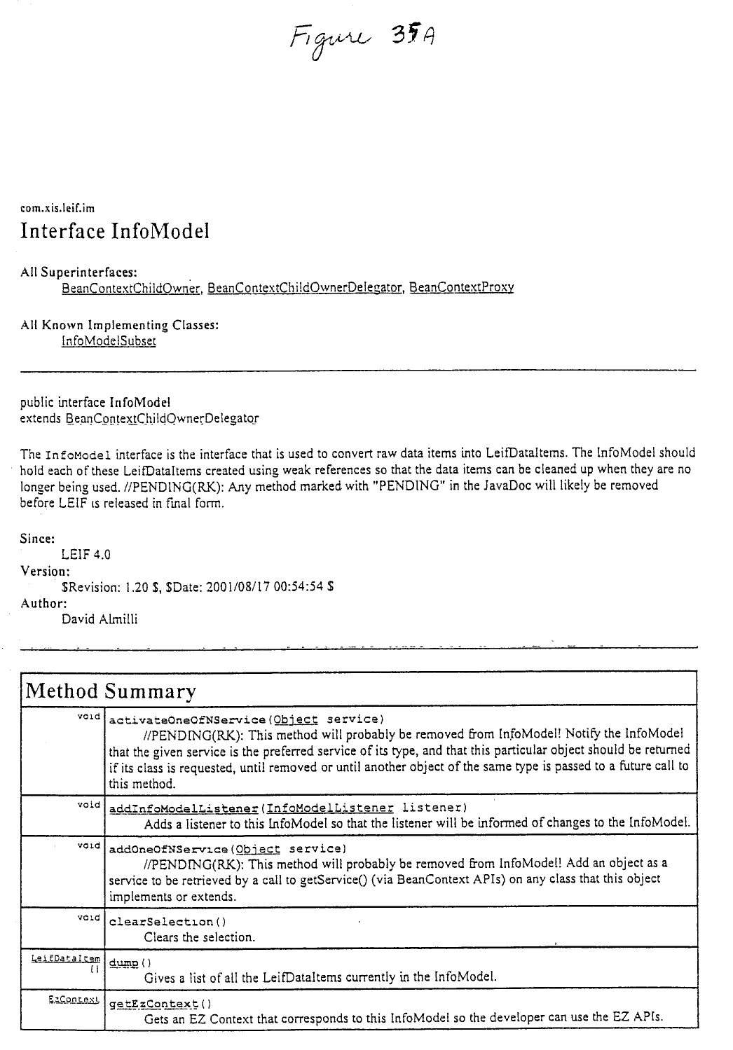

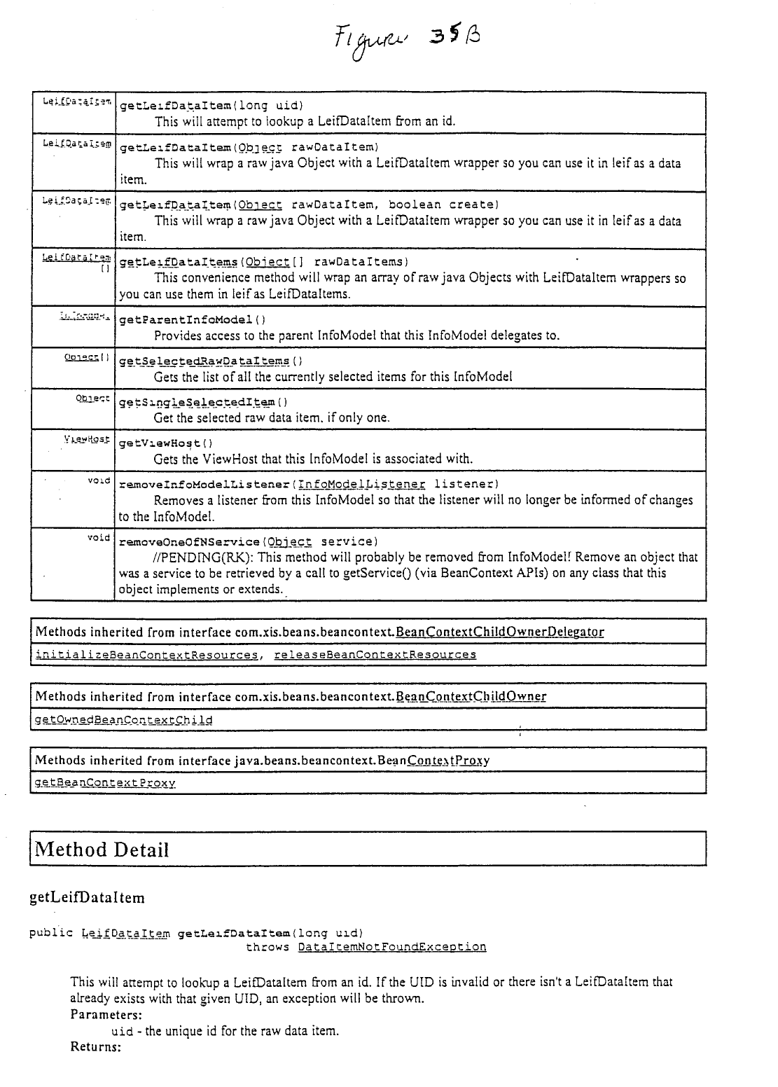

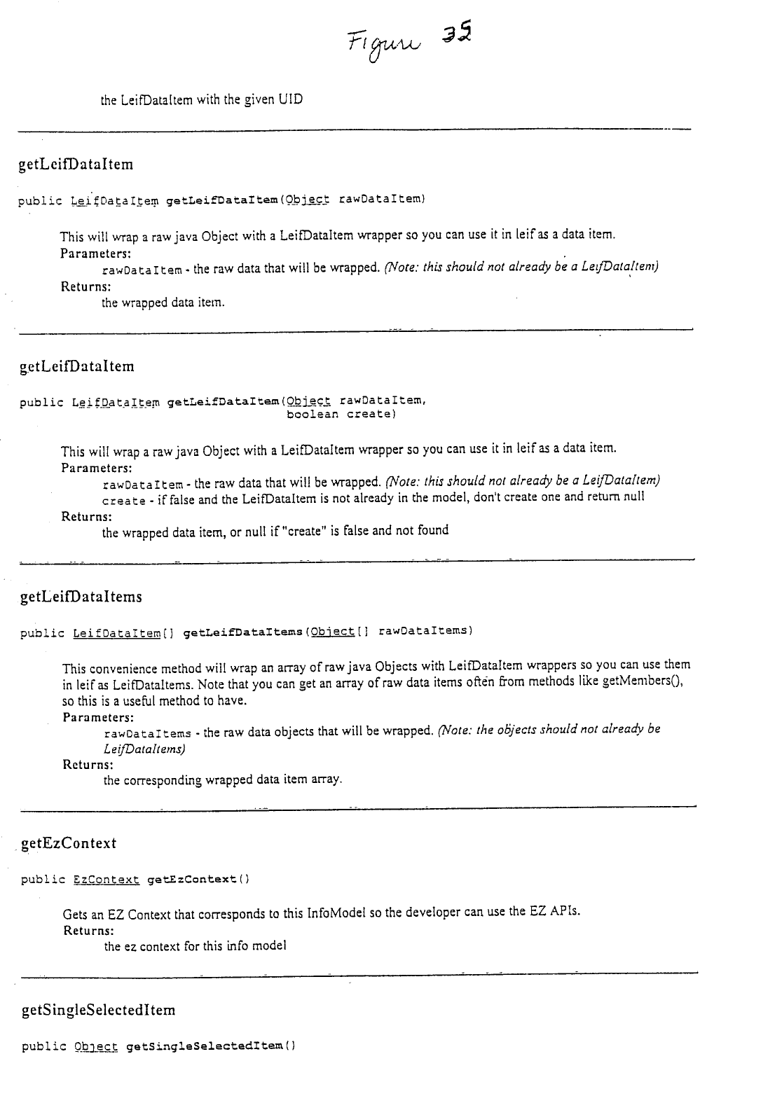

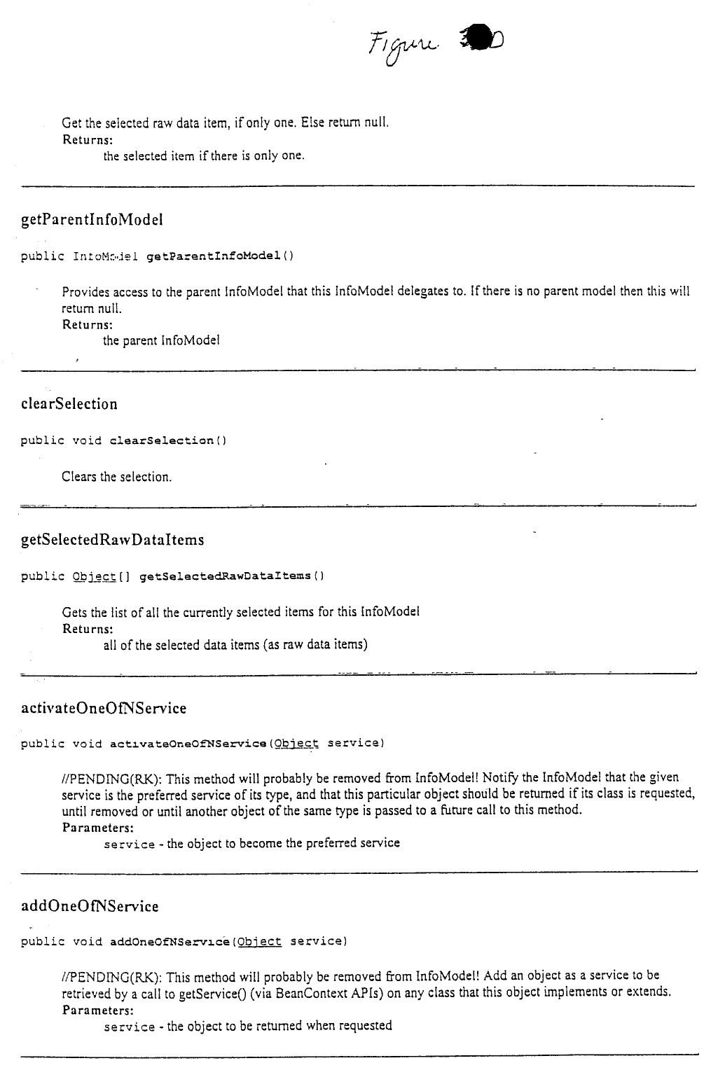

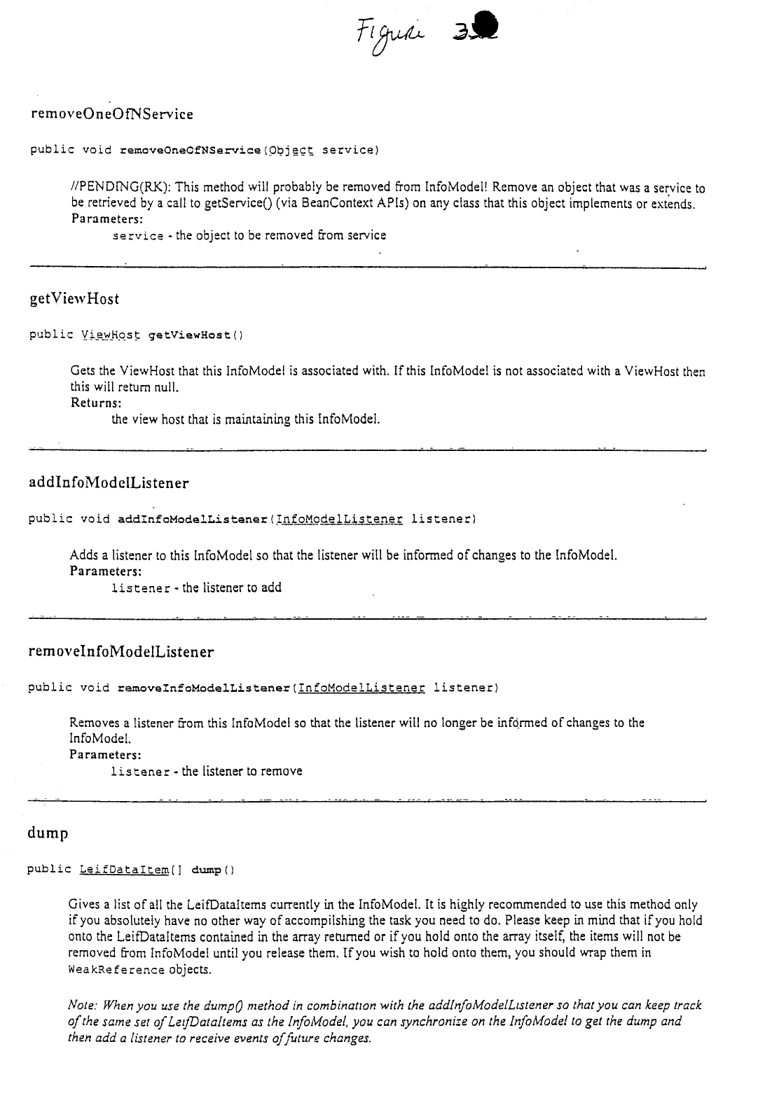

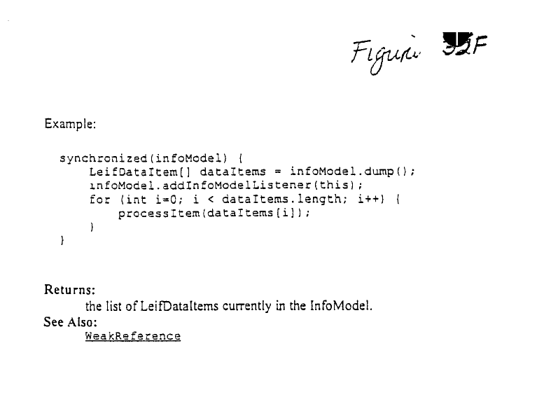

A super class of SelectableInfoModel and AttributeFactoryInfoModel, this is the simplest InfoModel. It delegates to its parent InfoModel and creates LeifDataItems that wrap those XIS data items from the other InfoModel. This InfoModel does not automatically add any attributes to the LeifDataItems it creates and manages, but simply provides a context in which data items can be managed. Each InfoModel “layer” provides a context in which additional attributes can be defined, or existing ones can be overridden. FIGS. 34A to 34D list an exemplary Java package that lists various classes. FIGS. 35A to 35D list the InfoModel interface. An interface is a contract in the form of a collection of method and constant declarations. When a class implements an interface, it promises to implement all of the methods declared in that interface.

Exposing Data

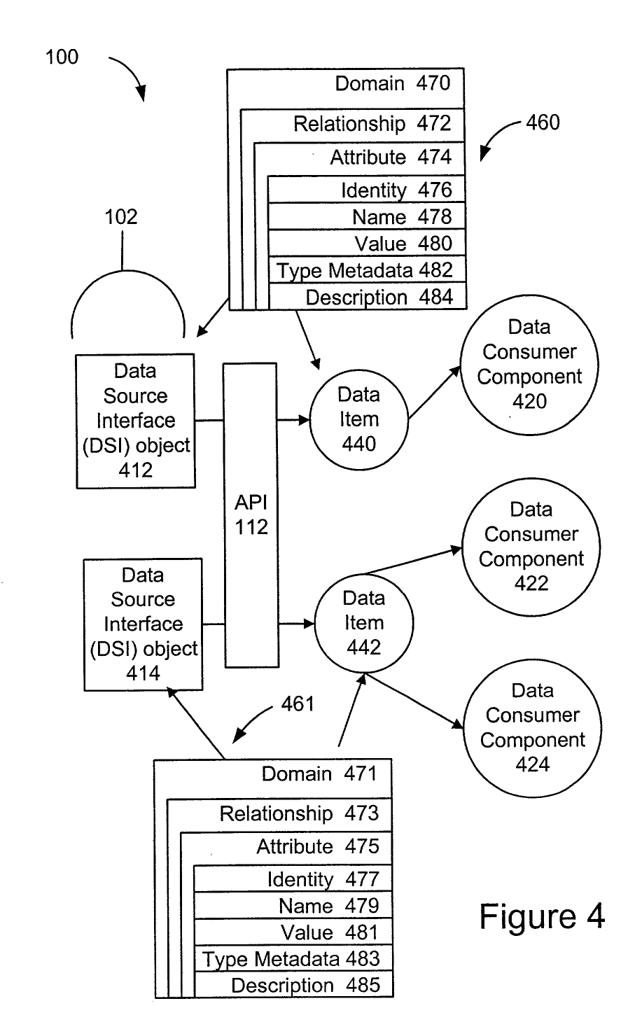

FIG. 4 is a diagram showing how information from source components may be exposed to data consumers using the mediation layer 112. The Attribute/Metadata interface 214 of FIG. 2 exposes a data item 440, 442 as a set of attributes, each of which carry a value and a set of metadata that describes the value. A data consumer component 420, 422, 424 may obtain information from one or more data items. Similarly, a data item 342 may be used by more than one data consumer 422, 424 via the mediation layer or API 112. The information blocks 460, 461 show the information available to data consumers.

A data source component 102 may comprise a data source interface (DSI) object 412, 414. A DSI object 412, 414 provides a conceptual way to encapsulate objects that provide data to the XIS framework 100. A class of a DSI object does not have to extend or implement any interface. Data is created (instantiated) in DSI objects to thereby encapsulate the data and make it available to other objects. The DSI itself may also be a data item that simply contains other data items (members). The data may be generated internally or extracted from an external source such as a database or across a LAN. In addition to creating the data, DSI objects are also responsible for maintaining and controlling data, such as removing and updating the data themselves if such changes are observed in the underlying data used by the DSI to create the data. Property change events (216 of FIG. 2) may be used by DSIs to communicate changes observed in the original source data items to the listening data consumers.

Any Java object may be a data source component. The Swing JButton, for example, is usually a transient object, and not typically retrieved in an information system. The Swing JButton, however, may still be a data source, if so desired.

INFOBEANs as stated above are data consumer components 420, 422, 424. They are specially configured objects that behave like JavaBeans that process and manipulate data in a generic fashion. They are also capable of interpreting and optionally displaying XIS data items. INFOBEANs use the XIS framework API's to gain access to information about data items.

As previously stated, any Java object may become a data item 440, 442 within the XIS framework 100. To make a data item out of JSlider javax.swing.JSlider), it simply must be added to an INFOBEAN (data consumer component). Table II below provides programming code that makes a data item out of javax.swing.JSlider, thus exposing the information blocks 460, 461 shown in FIG. 4.

TABLE II

Jslider slider = new Jslider(0, 100, 50);
tableInfoBean.addRawDataItem(slider);

The first line of code creates a data item out of JSlider. The second line of code adds the JSlider created in line 1 to the TableInfoBean object (an INFOBEAN). In this framework, JSlider knows nothing about the XIS framework, however, all its attributes are exposed, to be used and modified.

There are basic steps that must be performed when creating a DSI. First, before any code is actually written, a determination must be made as to how the original data or data source is to be obtained (e.g., will it come from a database, a flat file, an EJB (Enterprise JavaBean), read from a socket, etc.). This step is performed prior to and independent of coding the DSI. Once the data source has been determined, it must be decided what attributes of the data source should be exposed within the XIS framework.

The DSI component within the mediation layer of the XIS framework has the capability of exposing the attributes of a data source. In one embodiment, assuming that the data source is a Java object, the attributes to be exposed are determined through Java introspection. Introspection is a way to determine a bean's properties, methods, and events. Those skilled in the art will understand that a bean is a reusable software component, which may be combined to build applications. In this scenario, no additional code in the consumer component needs to be written. Although convenient, this approach is limiting, as it does not allow control over which attributes are exposed, and does not allow the user to define custom visualization components or express semantics. Furthermore, it requires the Java object to conform to the JavaBean design pattern.

Another approach to determining which attributes of a data source should be exposed involves writing new code. This approach embeds XIS-aware code directly into the Java object. This allows the component developer to directly specify details such as the attributes (e.g., via AttributeDescriptor) to be exposed along with their metadata, the Domains to which the DSI subscribes, which Domain methods are exposed with what implementations, and more. Writing new code enables greater control over the data item (as opposed to the introspection-only case) and provides more flexibility in dealing with any Java object rather than just JavaBean objects. One limitation of this approach is that the relationships between data items may not be directly specified.

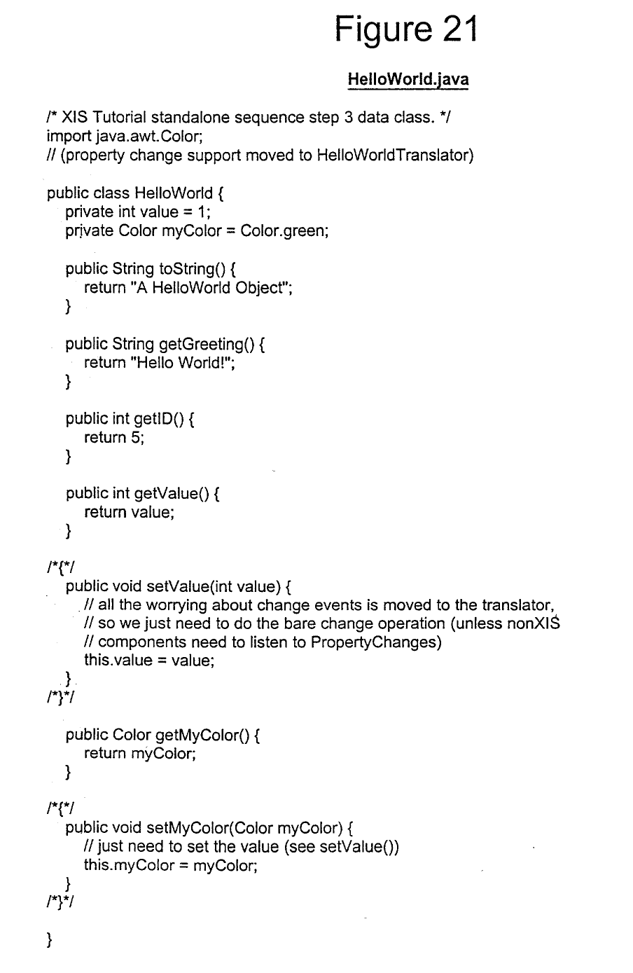

Another approach for exposing attributes is to create a Translator class. An application developer may place any of the XIS-aware code for exposing attributes, Domains, and the like in this class, as specifying relationships to other data as members or as references. This is described further below, in conjunction with the description of FIGS. 21 to 23.

Referring back to FIG. 4, a data consumer 420, 422, 424 may access a data source via a data source interface (DSI) object defined in the mediation layer 112. Communication between the DSI objects 412, 414 and data consumers 420, 422, 424 in the framework 100 is mediated through a set of application programming interfaces (APIs) 112 that remain independent of the actual contents and types of the data sources. Such APIs are contained in class libraries.

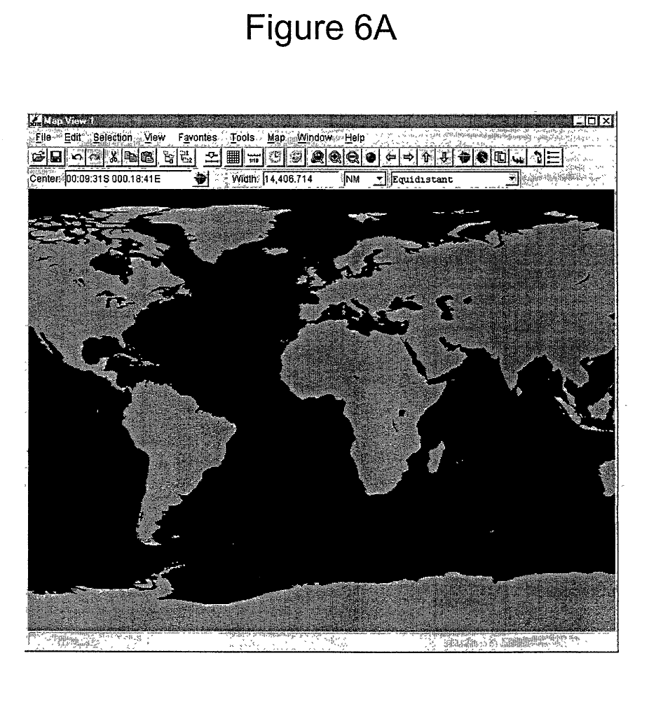

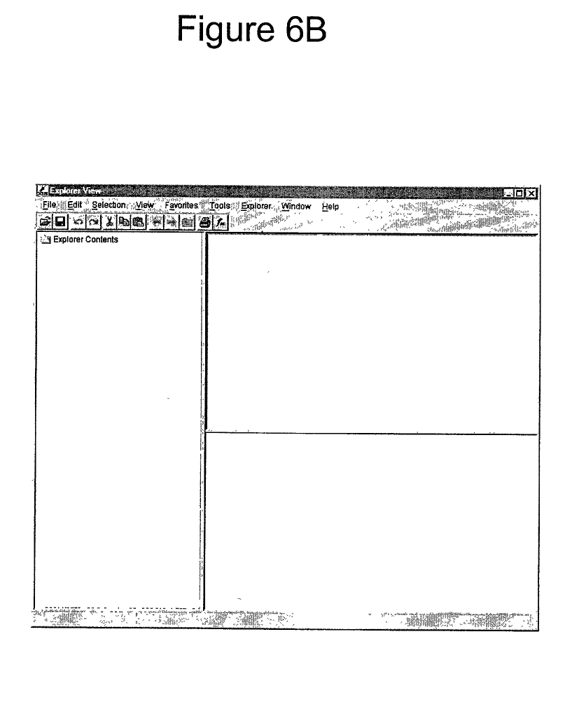

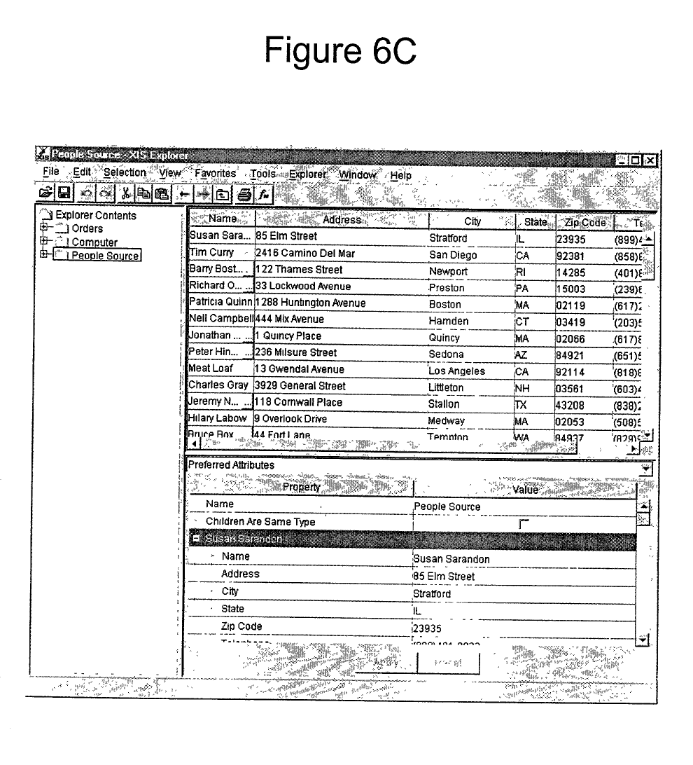

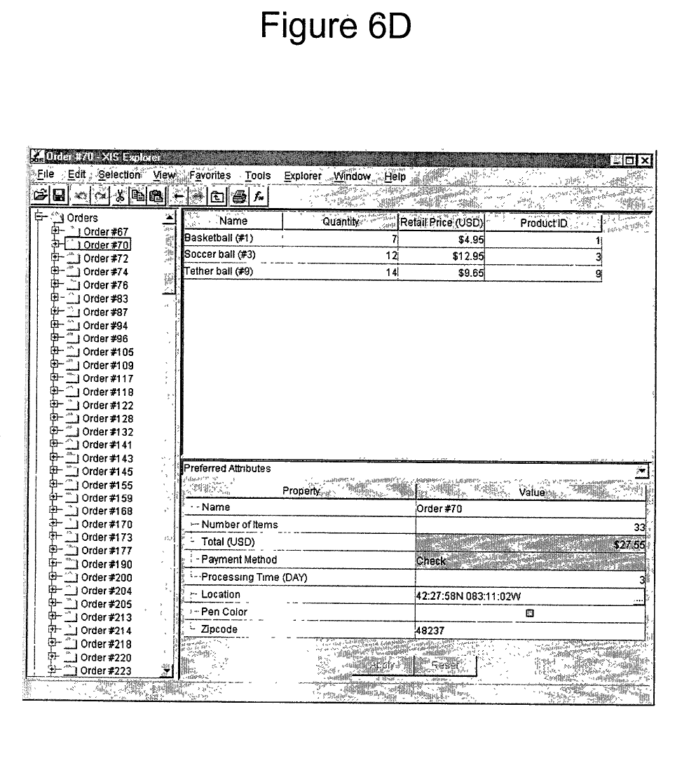

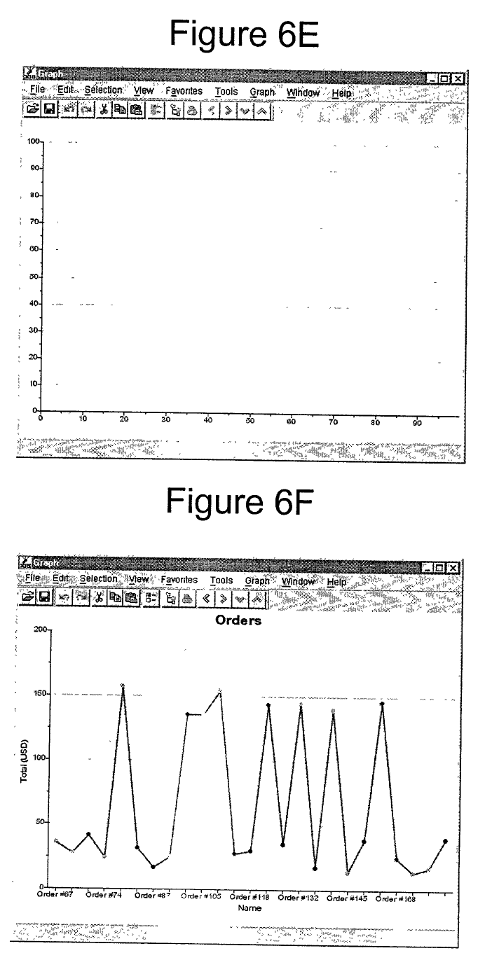

Using the framework 100, a data consumer 420, 422, 424 (for example, an INFOBEAN as shown in FIG. 6B) may be able to use heterogeneous data sources and, thus, eliminate the need to write a particular display software object for each particular data source. Within this framework, any data consumer object or application may use the data source object's information by getting attributes and relationships dynamically at run time. Instead of hard coding a visualization to a specific type of data source component, the visualization object or data consumer looks for the attributes it needs to perform its function. Thus, in this framework, developers for source and consumer objects may work independently of each other.

The DSI object may create any data structure containing members and references, and may expose any part of that data structure to the framework or system 100 if it is desired. Since there are no requirements involved to be a data source, a visualization bean can also be a data source. The data source can consume data from other data sources, and can create new data based on what it has learned. For example, DSI objects may be coded to use data source from an RDBMS, e.g., systems such as provided by Oracle Corporation of Redwood Shores, Calif., USA and as provided by Microsoft Corporation of Redmond, Wash., USA through their “ACCESS” application or SQL Server. DSI objects also may use data sources such as XML format data, tabular data (e.g., spreadsheet data such as spreadsheet files in the format of the “Excel” application from Microsoft Corporation), email, schedules (e.g. schedule data in the format of the “PROJECT” application from Microsoft Corporation), data following the SNMP (simple network management protocol), and the like.

Objects created by DSIs are considered to be raw objects in the XIS platform. These raw objects become normalized objects within the XIS framework when they conform to the mediation layer or the API 112. In one embodiment, when these raw objects are added to an XIS-enabled environment, the XIS framework wraps them with a normalized object called a LeifDataItem (see FIG. 3A) and holds the data item in one or more InfoModels. The raw data item could be a simple Java object (that does not know anything about XIS) or it can support XIS with direct references to AttributeDescriptors and other metadata that are recognized by XIS. The mediation layer is implemented in software and runs in-process. It is also exportable to serve as a distributed middleware if required by a given application.

An attribute is any property of an object. An attribute 474, 475 typically includes identity (ID number) 476, 477, name of the attribute 478, 479, value 480, 481, and the metadata type or Type Metadata 482, 484, and a description 484, 485. Attribute names 478, 479 may be the table column header or field name in an RDBMS. The description of the attribute 484, 485 may be plain text that explains the attribute. The value 480, 481 may be expressed as a number, string, or other basic data type, or may be expressed as a complex, structured object in itself.

Referring back to FIG. 2, the Attribute/Metadata interface 214 provides for fine-grained exposure of an information element or data item 440 442 (FIG. 4); by “fine-grained” is meant that the data item is broken down into a number of aspects or characteristics (the “attributes”) which are simpler data elements. These might be numerical values, strings, arrays, or anything else that can be represented by a software object (but is simpler than the original element). If a data consumer 412, 414 is not able to handle the entire data element, it may be able to handle some of its attributes and therefore may be able to do something useful with it, unlike most systems providing interfaces for data integration, which require the entire interface to be implemented to enable any data usage.

The Attribute/Metadata interface 214 also makes each attribute self-describing, to a limited extent. In accordance with the invention, a data consumer designed without regard to a particular type of attribute is still able to display and perform limited operations with those attributes by using the metadata types. For example, a data consumer object or INFOBEAN, which displays an X and Y chart of cost of living (expressed as a numerical value) versus geographical location (expressed as a territory or state character string, e.g., “California”), may be used to display a different set of data contained in another data source component or data item, so long as the metadata types of the different sets of data are compatible with the X and Y chart. In particular, a data consumer component that renders and edits information may still be executed, the default value substituted in cases of absence, and statistical summarization performed, even if the data consumer component is processing a different data source component. Other operations are possible and additional metadata may be provided by developers for any identified classes of information elements (such as number, array, geographic entity, etc.) desired. Because of this, data consumer developers may identify the type of auxiliary information or procedures provided by the consumer component and then define the interface according to which other developers creating data sources should provide or expose their metadata.

In one embodiment, any property or attribute of an object may be defined with an AttributeDescriptor programming code. When a data source object is enabled within the XIS framework, the computing system automatically creates AttributeDescriptors for JavaBean properties and for some public properties. A JSlider object, for example, is a JavaBean. JavaBeans have properties that are defined by the get<property> and set<property> methods. If the object is a JavaBean and provides a BeanInfo, then it will be honored and treated according to the JavaBean's specification for BeanInfo classes. Only properties listed in the BeanInfo appear as attributes. If metadata types, further discussed below, support the property's type, then they appear as attributes for that data item. Any properties that do not have TypeMetaData support become data items themselves (using the same reflection and introspection rules) and are listed in the data item's reference array, retrieved by the LeifDataItem getReferences( ) method (i.e., a method to obtain the references). Translators translate various data item classes, thereby enabling seamless integration of various data items without code modification. Translators may also be added to augment object reflection and introspection, i.e., by developers directly specifying the properties of an object.

Table III below lists exemplary programming code to define attributes. Table III shows how to define a SIZE attribute.

TABLE III
public static AttributeDescriptor SIZE;
static {

AttributeDescriptorFactory factory =

AttributeDescriptorFactory.getAttributeDescriptorFactory();

SIZE = factory.createAttributeDescriptor(

“size”, Your.class,
new NumericTypeMetaData(“Size”, long.class,
UnitsOfMeasure.BYTES, 6));

}

Metadata are data or information regarding data, for example, data type, field name, length, value restriction, color, and the like. In practice, metadata are used to define the structure and meaning of data objects in tools, databases, applications, and other information processes. The data type metadata 482, 483 encompasses both procedural and declarative information, including (as appropriate for the value) but not limited to the following:

unit of measure (from the provided unit of measure software object, converters to/from other units are accessible);

content length;

default or maximum character length or precision of numbers;

data quality (a rating given by the provider of the data);

default value (given by the provider of the data type);

constraints (e.g., numeric range or list of acceptable values);

formatting;

comparator function (a procedure which takes two items of the data type in question and returns whether one is to be ordered before, after, or the same as the other);

validation function (returns ‘true’ or ‘false’ depending on whether the value for the attribute passes a certain test or set of tests, tests are developer-definable based on an interface which takes a software object providing a value and returns a Boolean value, but several reference implementations are provided, such as one to determine whether a number is within a specified range;

list of applicable summary (statistical) functions, summary functions are developer-definable based on an interface which takes a collection or array of software objects providing values and returns a single value (usually, but not necessarily of the same type) based on those values, several reference implementations are provided, including mean, standard deviation, count, max, min, median; and

renderer and editor procedures for different output modalities (examples of modalities include local graphical window, HTML, plain text, and WML).

A renderer displays a value, while an editor allows the user to enter or edit one; renderers and editors are both developer definable for any modality desired. In the preferred embodiment, renderers and editors for graphical windows, HTML, and plain text are provided.

In a simple example, a data item may have an attribute called “Manager” (attribute name) 478, 479 that has a value of “John Doe,” 480, 481 with metadata type 482, 484 of content length (e.g. “30”), data type (“string”), and default value (“”). In another example, a data item may have an attribute called “Cost” 478, 479 that has a value of “5.00” 480, 481 with metadata type of data type (“float”), default value (“0.0”), summary statistics (“true”), validation function (“can never be less than zero”), and the like.

The Attribute/Metadata interface specifies generic type accessors for object comparing, editing, formatting, rendering, and validation. This displaces the burden from the consumer of the data (INFOBEANs) to the developer of the TypeMetaData. It enables developers to use existing TypeMetaData to create content that is viewable in many forms such as a Swing Component, HTML table, and WML text.

In one embodiment of the invention, the data consumer components are very generic, requiring little or no Domain-specific knowledge. For example, a data consumer object, for example, which resembles a spreadsheet, displays all available attributes of any data item, regardless of the Domain Policies represented. If useful to this consumer object, the metadata types may provide graphical control components for rendering attribute values. They also may supply editor components that give the end-user a standard way to modify an attribute, e.g., a color chooser GUI for selecting a new color value.

An input/out metadata class, TypeIO, defines the end content format. The TypeIO class offers flexibility in both the input (editing) and output (rendering) of attributes according to their type. In one embodiment, a TypeIO object is registered for a specific TypeMetaData using a registry, for example, the TypeIORegistry. The registration is performed on the following interface types: HTMLTypeIO, SwingTypeIO, TextTypeIO and WMLTypeIO. Examples of TypeIO are “Swing TypeIO” (for Java standard user interface library called “Swing”), HTML (hypertext markup language), WML (wireless markup language), XML (extensible markup language), and text. Swing is a graphical user interface (GUI) component kit, part of the Java Foundation Classes (JFC) that are integrated into the Java programming language. Swing simplifies deployment of applications by providing a complete set of user-interface elements written entirely in the Java programming language. Swing components permit a customizable look and feel without relying on any specific windowing system.

Table IV below is exemplary code to register two different TypeIOs for the BooleanTypeMetaData.

TABLE IV
static {

TypeIORegistry.registerTypeIO(BooleanTypeMetaData.class,

SwingTypeIO.class,
BooleanSwingTypeIO.class);

TypeIORegistry.registerTypeIO(BooleanTypeMetaData.class,

TextTypeIO.class,
BooleanTextTypeIO.class);

}

In one embodiment, the metadata type may be overridden. For example, it is possible to override the editing/rendering capabilities of a TypeMetaData. In one embodiment, a new TypeIO implementation is registered that provides the desired editing and rendering. If a developer only wants to affect the TypeMetaData instance that the developer is using, a subclass must be created and the TypeIO registered with that subclass. Thereafter, any instances of the new subclass will use the specified TypeIO.

Other features may also be added to the TypeMetaData, such as summary function, min function, max function, and the like. For example, BooleanTypeMetaData adds summary methods for obtaining the total of false and true counts. Exemplary code to perform this modification is listed in Table V below.

TABLE V
static {

TypeIORegistry.registerTypeIO(BooleanTypeMetaData.class,

SwingTypeIO.class,
BooleanSwingTypeIO.class);

TypeIORegistry.registerTypeIO(BooleanTypeMetaData.class,

TextTypeIO.class,
BooleanTextTypeIO.class);

}
. . .
/**
* Constructs a <b>BooleanTypeMetaData</b> with <i>name</I>
* @param name the type name, returned by getName( ).
*/
public BooleanTypeMetaData(String name) {
super(name);

addSummaryFunction(new FalseBooleanSummaryFunction(this));
addSummaryFunction(new TrueBooleanSummaryFunction(this));

}
. . .

Methods may also be added to the TypeMetaData interface to provide standard behavior. Constraints may also be specified. Table VI below lists exemplary code to define a StringTypeMetaData called “Threat” with only three valid values (“HOSTILE,” “FRIEND,” and “NEUTRAL”).

TABLE VI

new StringTypeMetaData(“Threat”, 3) {

{

set ValidTest(

new DiscreteRange( ) {

{

add(“HOS”);
add(“FRI”);
add(“NEU”);

}

}

);

}

}

In one embodiment, an INFOBEAN data consumer is given a data item. The consumer examines the data item and its attributes, and may also access certain Domain attributes or execute Domain methods. If the consumer finds something it can use, the data item is further processed according to that consumer's function. For example, a user might drag a group of data items to an INFOBEAN that displays time relationships. The INFOBEAN would ignore those data items that did not have any appropriate time-related attributes. For those data items that have time-related attributes, the values can be obtained and used to populate a user interface.

Referring back to FIG. 2, the Domain Definition/Policy interface 202 provides a means for the intended use of an attribute in a data item to be conveyed along with the attribute itself. A domain policy typically comprises a list of attribute types with metadata and a list of function calls applicable to data possessing some or all of the attributes with parameter specifications, annotated with English text expressing the intent (i.e., description of the attribute). It is a group of related attributes (or properties), along with their semantics to usefully deal with data processing those attributes, particularly to define the specific intent of the attribute or method. The semantics are specified in the attribute TypeMetaData and in natural language. Software developers of both sources 102 and consumers of data 122 may refer to a domain policy in making design decisions, thereby ensuring that an attribute is handled in a more sensible manner than the limited self describing capabilities provided by metadata alone would allow. Domain policies indicating intended use of a set of information that are well understood, for example, by experts now may be mapped and aligned so that common features of different sources of data may be combined along common lines.

A domain policy typically has no knowledge of the data items that use the attributes from those domains or the data consumer components that use them. Domains are just a related collection of Attributes and methods from which the various data item classes are free to choose.

In one embodiment of the invention, every data item in the framework provides a list of domain policies it “subscribes to” when requested by a standard method call. For example, a geographical domain policy is defined within the framework 100 to handle a set of three numerical values (longitude, latitude, and altitude) to define the position of, for example, an airplane. This domain policy or domain interface is defined in the mediation layer 112 so that the data source component 102 and the data consumer component 122 may interface with each properly. In this scenario, data source component 102 exposes the three numerical values properly (i.e., as latitude, longitude, and latitude). The data consumer component 122, on the other hand, understands this pre-defined domain policy and thus is able to properly handle these three attributes or values, such that, the location of this airplane may be plotted on a map (like the one shown in FIG. 1A), distances between positions calculated, and the like.

Two or more modules (consumer and source) may subscribe to the same Domain. This, however, does not preclude the modules to be developed independently. A Domain Policy in one embodiment is defined by Java classes that declare a set of attributes and methods that might be supported by a given data item. For example, a temporal domain defines start time and duration as attributes. A timeline may only be properly plotted if such software object understands which attribute represents the start time and which attribute represents the duration or the end time. For this to work in XIS, two classes would need to exist: TemporalDomain and TemporalDomainWrapper. The TemporalDomain class defines the AttributeDescriptors (i.e., attributes) for each domain attribute; and the TemporalDomainWrapper class provides accessor and mutator (get and set) methods for these attributes. The wrapper also may declare one or more domain methods, which can have any signature to be invoked with the data item as the target object. The wrapper is a convenience class for accessing domain attributes, providing optional default values, and invoking domain methods through Java reflection.

Analyzing any domain yields a list of attributes and methods. Though much like a class definition in form, Domain Policies are supposed to convey and define logically independent characteristics related only by their domain context. It is very important not to fall into the trap of accidentally creating a domain that reflects a particular class or interface, or to add implementation-specific details that have nothing to do with conceptual domains into a given Domain Policy. An application can obtain and manipulate attributes of an object via a domain wrapper instead of accessing the object directly. This eliminates the dependency on the class of the object. An application can now be written with only the knowledge of domains. No prior knowledge of a particular data source is required at development time, only domains.

In one embodiment, attribute aliases may be used. This enables one attribute to be substituted for another. This is typically used when two domains are defined that have similar attributes. This enables a consumer to ask for the Attribute from the domain that it knows about, and have the value translated from the Attribute of the DSI from the second domain. In one embodiment, the mediation layer implements this in a seamless operation, i.e., either the consumer or provider of the Attributes knows that it was an aliased Attribute, for example, “speed in knots” and “velocity in meters/sec”.

In another embodiment, methods of Domains may be registered with domain method descriptor factories similar to AttributeDescriptors. In this implementation, it enables developers to reference domain methods via these static singletons, determine if domain methods of interest are defined, and to determine all information about the argument types and interpretation of the domain method. Furthermore, like the attribute descriptor factory (AttributeDescriptorFactory), developers pass the necessary ingredients or information to this factory, and the factory handles the internal registration of the method parameter types, return type, exceptions, and interpretation. It ensures that one and only one object in the Java runtime exists for each distinct domain method definition (each unique method signature), similar to attributes and attributes factory.

FIG. 4 shows a schematic diagram of information that may be exposed by a data item 510 (440 and 452 in FIG. 4). In an embodiment of the present invention, a data item 510 is defined as any unit of information that can be represented by a single object (perhaps containing subobjects) in an object oriented programming (OOP) language and is a coherent unit in terms of the semantics of the content domain that it relates to. Thus, data items are defined within a common semantic representation. Each information element is defined in terms of entities (data source or data consumer component), identity, relationships, attributes (name/value), services (not just data), and change events (dynamic nature).

For example, a single row in a relational database containing information on a person's name and address constitutes an information element, but so would the table from which it comes, and even the entire database itself. Different levels or granularity of information is useful in the context of different applications, but any one of them can be considered an information element for purposes of our exposition. An example of a noncoherent unit would be a random collection of name/address rows from a database, unless there was some comprehensible unifying characteristic to them (e.g., all rows for addresses in the state of Utah).

Data items use Domain Policy attributes and methods to express the data item characteristics in a “normalized” manner. That is, a data item may expose Domain Policy methods 512, which are the functions or methods 516, 518, 520 of a particular Domain Policy to characterize the data item's behavior and attributes to characterize the data item's information content. A data item may also expose Domain attributes and metadata. A data item may also be part of more than one Domain Policy, thus a number of Domain methods 512 may be exposed with such data item 510. The Domain methods define the method name, possible input parameters, which may be mutable objects, i.e., input/output parameters, and optional return value. This shows the expected behavior of the method, expectations of the inputs, and return value constraints. The data item may also expose one or more attributes 530 and 538. Each attribute 530, 538 may have an attribute value 534, 542, an attribute descriptor 532, 540 (containing, among other information, an English text description of the attribute), and type metadata 536, 543. The type metadata may include the class type 544 (the class type of the attribute's value) and type input/output 546 (TypeIO, for IO facilities). Examples of class type are LatLonAlt (for latitude, longitude, altitude data), String (string data), Integer (integer data), Date (calendar date), Color, and the like. TypeIO, as discussed above, may indicate the input and output format.

The Relationships 522, e.g., containment, hierarchies, and ad-hoc relationships, of a particular data item 510 may also be exposed as shown by the data items 524, 526, 528. A data item may have zero (none at all) or may have many data relationships to the other data items via Domain methods and attributes.

Additional information exposed by a data element is a metadata override, which may be used to override a default behavior of a Domain Policy attribute. For example, default formatting of a date for some Domain Policy may be overridden, from MM-DD format (two digits for month and two digits for date) to “month text string” and DD format. In one embodiment, this may be implemented by assigning different metadata to an attribute using FieldMetaData within the XIS framework.

User Interface

FIGS. 6A to 6F are exemplary representations of computer display windows produced by data consumer components 122, which may be developed within the XIS framework 100. These data consumer components may use any data source component 102 for data and may also be run without an associated data source component.

FIG. 6A shows a computer display window called “Map View 1” produced by a mapping program for an INFOBEAN object that contains vector shoreline data from a data source component to produce the world shoreline depiction in the drawing figure. If an appropriate data source is loaded into this INFOBEAN, then appropriate additional pieces of information will be displayed, e.g., as geographic points on the depicted world map. Appropriate pieces of information for this INFOBEAN may include numeric data, which may, for example, be mapped to a set of latitude, longitude, and altitude coordinates on the map display of FIG. 6A.

FIGS. 6B to 6D show window displays of a file manager or information exploring component, much like a file system explorer, called “XIS Explorer” with a vertically oriented directory frame on the left side of the window display and two stacked information detail frames on the right side. The directory frame on the left may provide a tree diagram of available DSI components and their relationships to other components. FIG. 6B shows that the Explorer View display does not contain any data (the “Explorer Contents” menu is empty). FIG. 6C shows the XIS Explorer program after it is loaded with data called “Orders”, “Computer”, and “People Source” data sources, with “People Source” selected. Detail information about the People Source data is shown in the two stacked right frames. The upper right frame shows a listing of data objects or entries in the People Source data source, and the lower right frame shows attributes of a particular data object in People Source. A different set of data objects or records is shown in FIG. 6D, this time for the “Orders” data file. That is, FIG. 6D corresponds to the FIG. 6B display after XIS Explorer is loaded with the “Orders” data. Thus, detail information about the orders is shown in the two right frames. FIG. 6D shows that a listing of data object names can be provided in the left tree diagram frame. As indicated by the display windows shown in FIGS. 6B to 6D, the same data consumer component or INFOBEAN-generated display format (FIG. 6B) may be used to display different data source components (FIG. 6C and FIG. 6D, e.g., “People Source” and “Orders”).

FIGS. 6E and 6F show a graphing program INFOBEAN display. FIG. 6E shows the window display when it does not contain any data, while FIG. 6F shows “Orders” (the same class of data objects shown in FIG. 6D) loaded and displayed as a graph. This shows that the same data source component 102 may be utilized by more than one data consumer component to display different types of data characteristics and carry out different operations on the data, as shown in FIGS. 6B through 6F. Thus, different INFOBEAN data consumer components can be configured to produce the desired data operations and window displays from available data objects (sources).

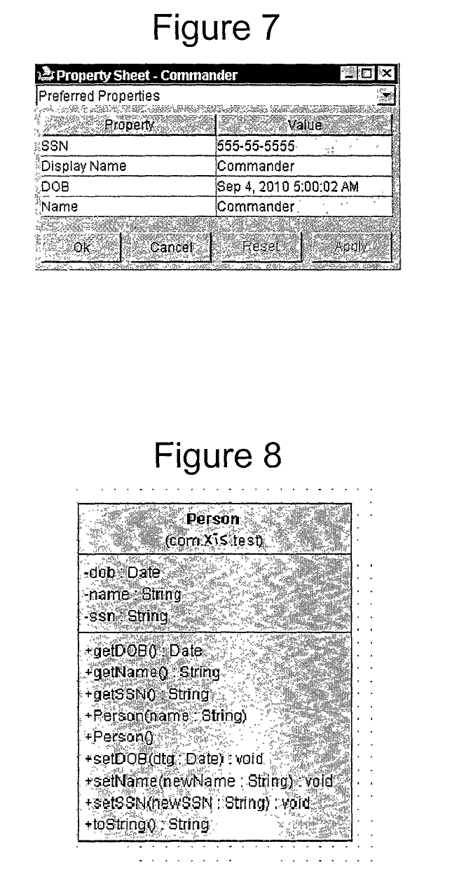

FIG. 7 shows a computer window display for an INFOBEAN data consumer component, showing the property sheet of a particular data source object called “Person.” This “Person” object may be a Java object. Those skilled in the art will understand that JavaBeans are a specification developed by Sun Microsystems that defines how Java objects can interact. An object that conforms to this specification is called a JavaBean. This object may be used by any application that understands the JavaBeans format. For example, the “INFOBEAN” objects available from Polexis, Inc. of San Diego, Calif., USA are objects that behave as JavaBeans that can process data in a generic fashion, looking for and manipulating data pertaining to particular domains as generated by DSIs or other INFOBEANs.

Data consumer objects may also be Java objects that present and/or process 2D and 3D maps, table/spreadsheet data, hierarchies (trees), plots (bar, scatter, pie, etc.), gantt/timeline, content (e.g., email), organization charts, calendars, properties or attributes, and the like.

FIG. 8 shows a unified modeling language (UML) class diagram for a Person class source data. Using the XIS framework of the present invention, the data consumer, an INFOBEAN, obtains information, particularly, the attributes listed in FIG. 7 (e.g., SSN, Display Name, DOB, and Name) of the Person object. This set of information is shown in blocks 460 and 461 in FIG. 4. This is performed, for example, by using a naming convention for methods, i.e., GET + “Attribute Name.” An API determines the available methods of an object and determines attributes based on method names. For example, an API from “getDOB,” “getName,” and “getSSN” methods determines the attributes DOB, Name, and SSN, respectively. Java introspection may also be used.

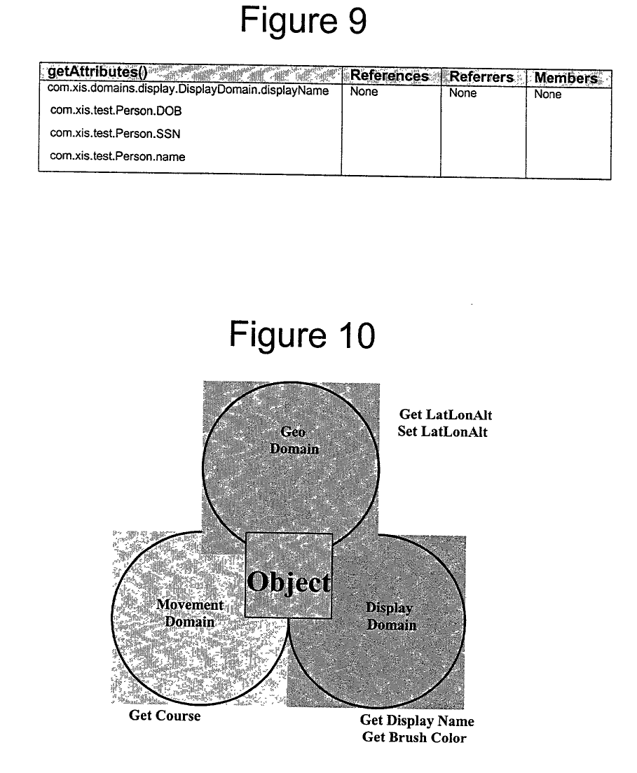

FIG. 9 shows the different attributes obtained or exposed for the Person object (i.e., DOB, SSN, and Name). In addition, using the toString( ) method, available for every object in Java, as shown in FIG. 6, the DisplayName attribute is also exposed.

In one embodiment, no Translator exists for the Person object. Also, there are no static get<PropertyName>Descriptor methods defined, so the only XIS Domain Attribute is the displayName that is obtained, by default, from the toString( ) method available in every object in Java. The remaining attributes (date of birth, Social Security number, and name), though not mapped to a Domain, are available through the mediation layer API.

If an XIS Translator were used or if the Person class specified XIS AttributeDescriptors, then the Java fields could be mapped to domains. In this case, for example, the birth date and Social Security number could be mapped to corresponding attributes in the “Personnel Domain”. Within this domain, the attributes would be specified with detailed TypeMetaData, which is made available so that the data from the attributes, such as the Social Security number, can be appropriately validated, displayed, edited, formatted, and otherwise processed wherever that attribute is used.

FIG. 10 shows how an object, particularly a data source component, may belong to multiple domain policies. In this case, for example, the domain policies include the Geo Domain (geographical domain), Movement Domain, and Display Domain. The Geo Domain has defined at least two methods called GetLatLonAlt and SetLatLonAlt. The GetLatLonAlt method obtains the latitude, longitude, and altitude, while the SetLatLonAlt method sets these parameters. The Movement Domain contains a GetCourse method, which obtains the course or direction of an airplane, for example. The Display Domain has two methods called GetDisplayName and GetBrushColor, which obtain the name of the object and display the color of the object, respectively.

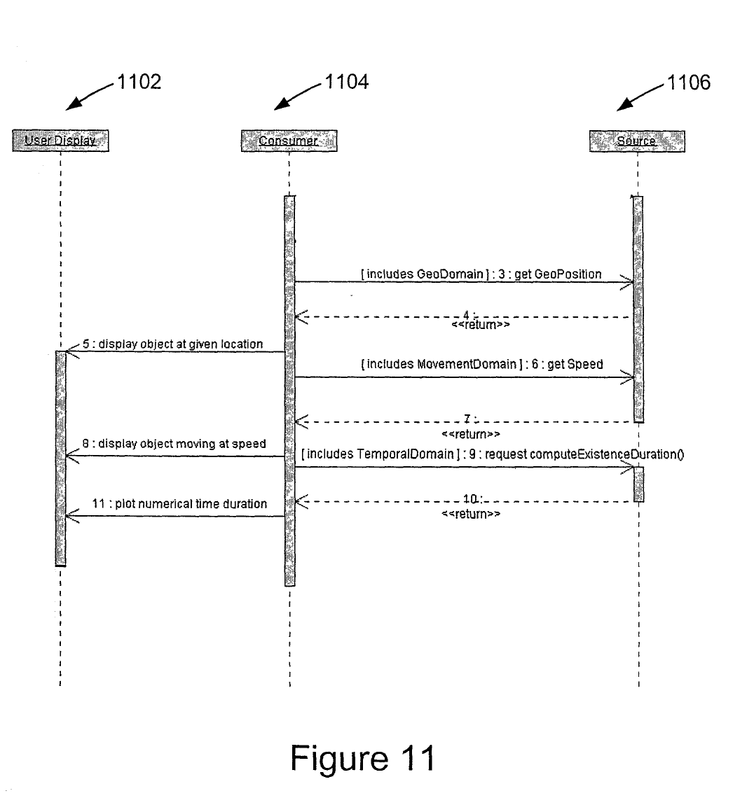

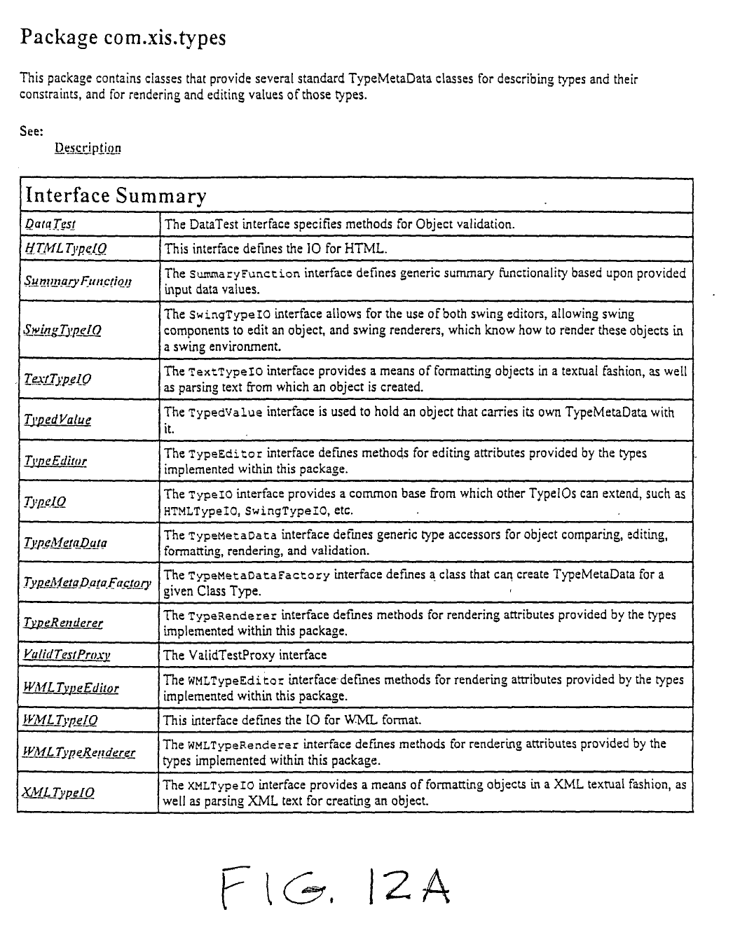

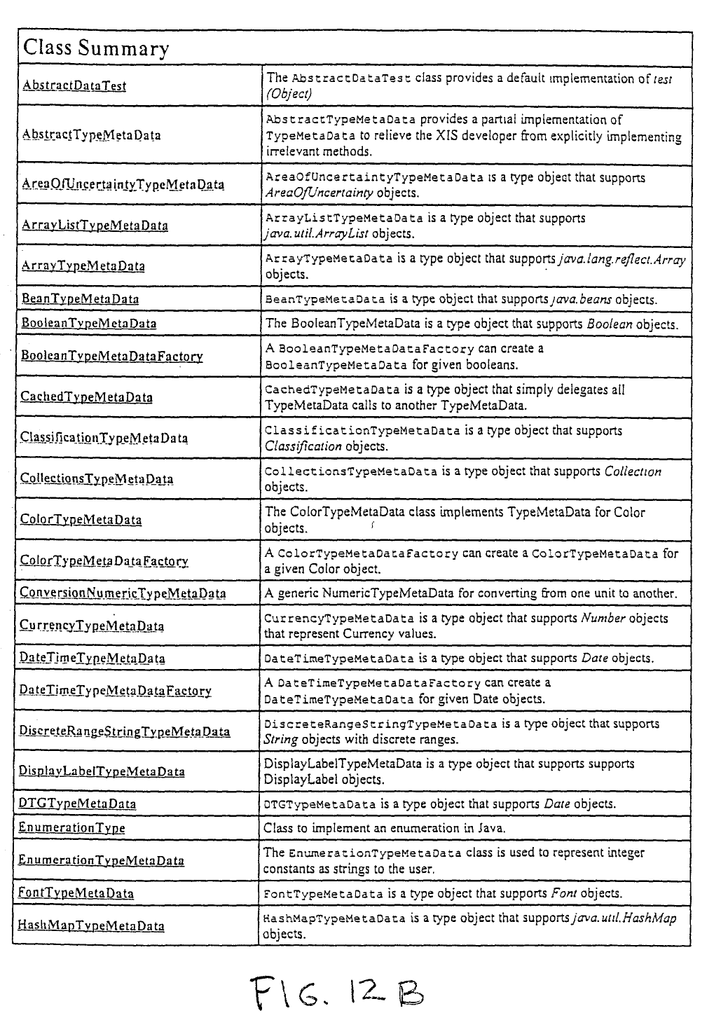

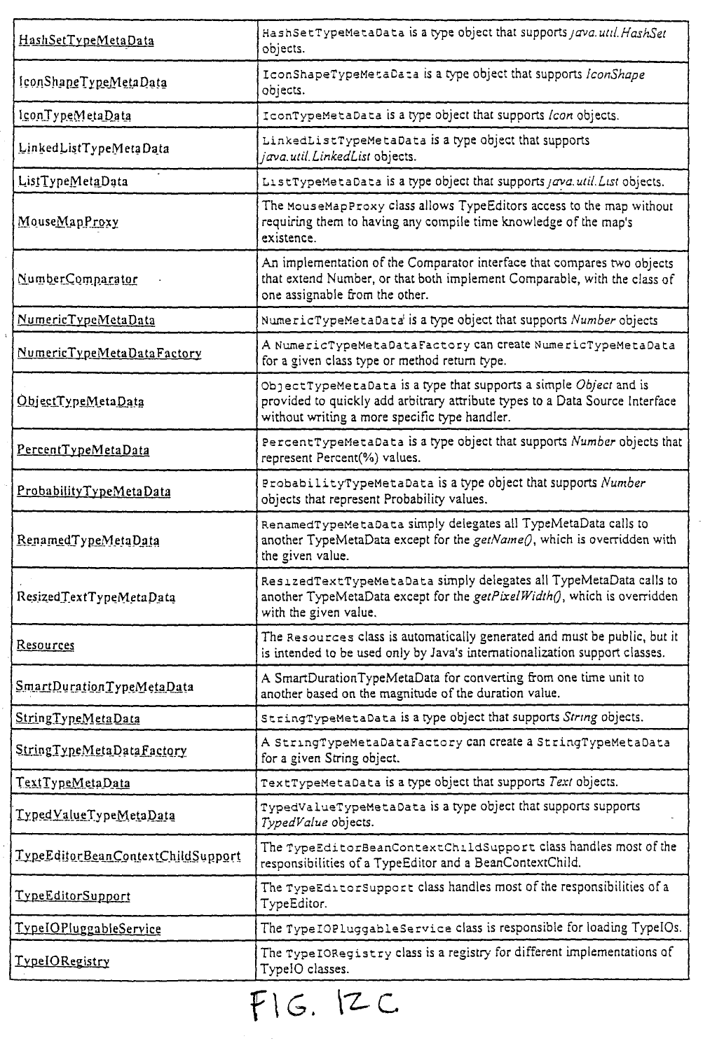

FIG. 11 shows a sequence diagram of a domain policy usage scenario. In this time sequence diagram, each column represents an entity (i.e., user display 1102, data consumer component 1104, and data source component 1106), and time or sequence flows from top to bottom. Here, a data consumer software component (middle) requests a data source to tell it the Domain Policies to which the data source subscribes. Upon receipt of the information, the data consumer checks to see whether these include the Geo, Movement, and Temporal Domains, which it recognizes. The developer of the data consumer need not have known about this particular source, nor the data source developer known about the particular consumer, for these two components to interoperate correctly: the data consumer plots three numbers given to it by the source as position, speed, and a time duration (computed by a call to a known function on the source), as they were intended by the source's developer. In the XIS framework, applications and components that comply with the Domain Policy API are able to share data in a simple yet powerful manner, ensuring automated integration and reuse. Thus, data sources and data consumers may be independently developed.

In one embodiment, attributes of a given domain are exposed through the static final AttributeDescriptors of that domain. The AttributeDescriptors that make up any given domain are built using the AttributeDescriptorFactory. If the developer of a data item class uses a custom AttributeDescriptor, then it should be built (typically in the Translator) using this factory.

Table VII below shows exemplary code that illustrates how a DisplayDomain builds its font attribute.

TABLE VII
public static final AttributeDescriptor font;
static {

AttributeDescriptor tmpFont = null;
try{

AttributeDescriptorFactory factory =

AttributeDescriptorFactory.getAttributeDescriptor
Factory();

tmpFont = factory.createAttributeDescriptor(

“font”,
DisplayDomain.class,
new com.xis.types.FontTypeMetaData(“Font”)

);

}catch (Throwable t) {

t.printStackTrace();

}

font = tmpFont;

}

Providing the font parameter to the factory means that the expected method names for accessing the attribute will be getFont( ) and setFont( ). The exception is thrown if the attribute has already been registered with that domain. The primary integral ingredient of an AttributeDescriptor is the appropriate TypeMetaData.

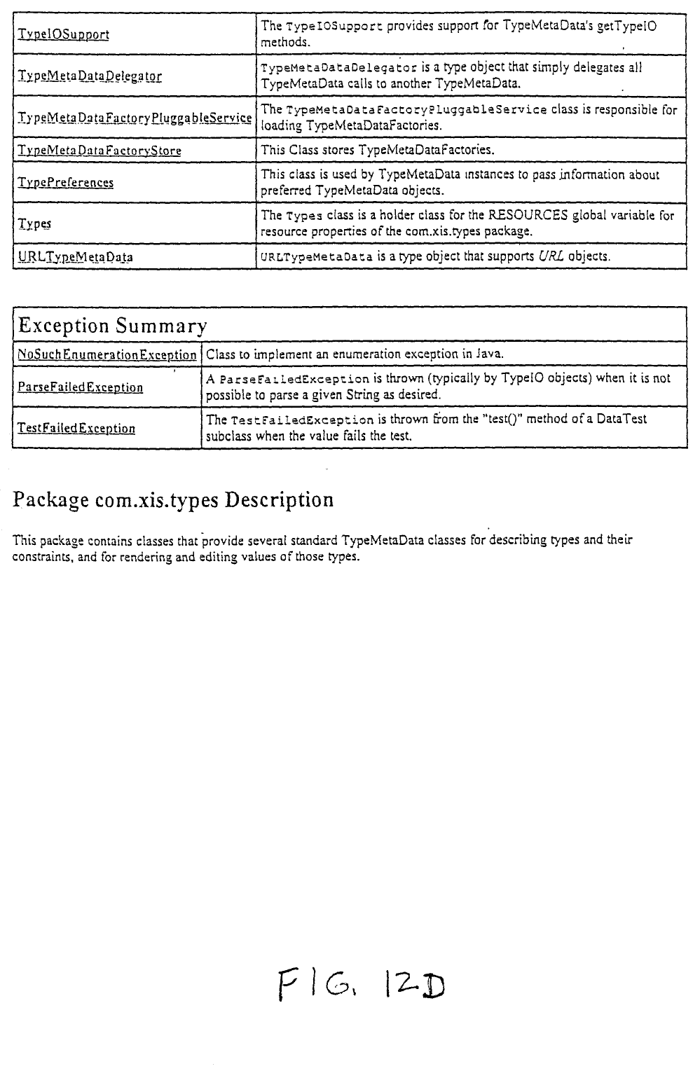

FIGS. 12A to 12D list an exemplary Java package called com.xis.types and its respective classes. In one embodiment of the invention, several packages containing various classes to implement the features of the present invention are contained in class libraries or APIs.

Referring again to FIGS. 2 and 4, the set of Relationships 210, 472, 473 that a given data item 440, 442 possesses with other data items is also exposed through standard method calls. One method retrieves the “member elements” belonging to a given element in a parent-child relationship. These members are directly referred to by means of conventional object “pointers”.

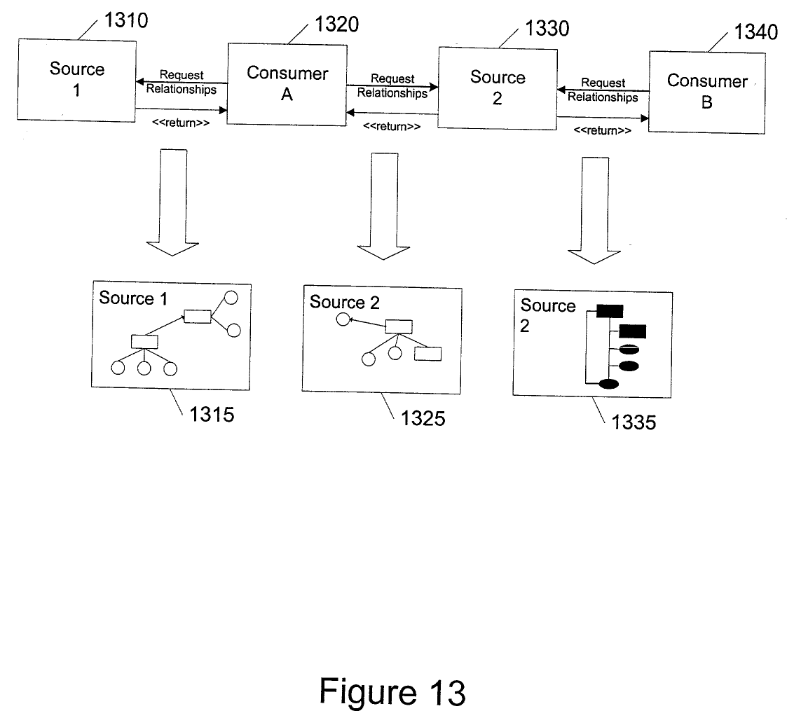

FIG. 13 is a block diagram representation of how relationships between data items within the XIS framework 100 are exposed in a generic fashion. Member-of (i.e., hierarchical) and reference relationships are supported.

Members enable the creation of a hierarchical data structure. A data source object may also have members themselves. When members are added or removed, it is the data source's responsibility to fire the appropriate events to inform any listeners that the data structure has changed. By nature, certain objects have members (like Collections or arrays). In one embodiment, the actual array is returned to the object requesting the relationship.

A reference represents a pointer or a reference to an object. In one embodiment, an object may be referred to without instantiating that object until necessary. References in the XIS framework may also provide persistable or persistent data to define a link and may also refer to software classes/objects on how to later resolve such link to an actual live data item. These references may also provide annotations (e.g., description of links and their roles with respect to data items).

FIG. 14 shows how references may be resolved. Information regarding relationships, as stated above, may be obtained using object pointers, e.g., there is an object pointer from one data item to another data item to indicate a parent-child relationship. In this way, data source components may be able to determine which data items are directly or indirectly children of which others and the general relationships between data items. This set of relationship information may be used in displaying and representing the data items with its own characteristic fashion. This relationship information, for example, may be helpful in an organization chart or an explorer-type consumer component. Relationships, for example, may be a “peer-to-peer” or “members of” type.

In FIG. 13, for example, a data consumer Component A 1320 requests the relationship of a data source component 1313 (Source 1), via the mediation layer 112 shown in FIG. 1. Via the same mediation layer 112, the data source component (Source 1) 1313 returns a data item, which indicates the relationship of the data source component or data item, as shown in Source 1 1315. Similarly, the same data consumer Component A 1320 may request the relationship of data source component 1330 (Source 2), and such relationship information is returned 1325. Another data consumer Component B 1340 may also obtain the relationship information of the data source (Source 2) 1330, i.e., the result 1335. As shown, the resulting relationship information 1325 and 1335, e.g., how the relationship is represented may depend on the data source component, for example, the relationship information shown in the box 1325 is different from the box 1335.

In one embodiment of the invention, a unique ID for a data item is available in the current runtime environment. Such unique ID for a particular item need not be recreated (or a new unique ID created) except when the data has been completely unloaded and then reloaded, e.g., loading of a row from a database, unloading it, and then reloading (will usually result in a new unique ID).

A second method retrieves links representing a more general and indirect form of relationship comprising a text annotation and a reference object which can be used to either obtain the referred data item (or information element) or retrieve or reconstruct it if it is not directly available. This retrieval or reconstruction need not take place until the moment the referred information or data element is actually needed. In particular, the reference refers directly to a “resolver” object on which—when retrieval is actually requested—a method is called with arguments also specified in the reference. This method then returns the desired information element or data element.

This mechanism is quite general; one possible implementation would be a resolver object able to make queries on a database and construct data source objects from the result. The reference could specify the particular query to be made, with the effect that a very small reference (comprised primarily of a query string, assuming the resolver class is loaded as part of the general mechanisms within the application) can be passed around between application components and only resolved into a large, memory intensive data object when some operation (such as display to a user) needs to be performed on it. Other types of reference retrieval mechanisms not involving databases are possible, such as query of network based services or collection of direct user input, i.e., anything that can be implemented within the implementation language can be used as a reconstruction procedure.

Additional methods on a data element may be implemented to provide Relationship information in the reverse direction,that is, to the elements that contain a given element and elements that refer to a given element may also be acquired through direct queries.

Finally, a more dynamic form of information is accessible through a standardized mechanism by which interested data consumers 122 or sources 102 can register—through calling a particular method on the data source object 102—to receive events whenever one or more chosen aspects of a data source change. In particular, a data source maintains lists of those software objects interested in hearing about changes in attribute values, the addition or removal of attributes, the addition or removal of members or containers, and the addition and removal of references or referrers, and whenever one of these aspects changes, it sends a message to each object on the appropriate list. This mechanism, founded on the event passing mechanisms found in many object oriented programming languages and libraries but centered around information structure as exposed generically within the XIS framework, enables different components of an application to “keep in sync” with information sources that change or grow during use. In other words, if a data source signals a change in an information element, all displays and computations can be updated immediately to reflect the change, much like a dynamically adjusting spreadsheet program.

FIG. 14 is an exemplary flow diagram that shows how a reference is resolved within an XIS framework. In the first block 1410, a data consumer component Consumer A produces or creates a reference to a data item Data X. In the next operation 1420, this reference is saved to disk, e.g., as a text file. In the next operation 1430, the data consumer component Consumer A is restarted and the reference is retrieved from the file saved in the previous operation. In the next operation 1440, such reference is also passed to data consumers Consumer B and Consumer C. Next, at 1450, Consumer B requests resolution of the reference. This resolution is done in the next operation 1460, wherein Data X is constructed through executing a database query. This database query is stored as part of the reference information stored in the disk (block 1420). The query returns the data item Data X, which is then used by Consumer B (block 1470). Consumer C may also request resolution of the reference (block 1480). Considering that data item X has been resolved by the data consumer component Consumer B, Data X is not reconstructed again from the database, rather a cached version is directly returned instead (block 1490). This operation 1490 assumes that no change in Data X occurred.

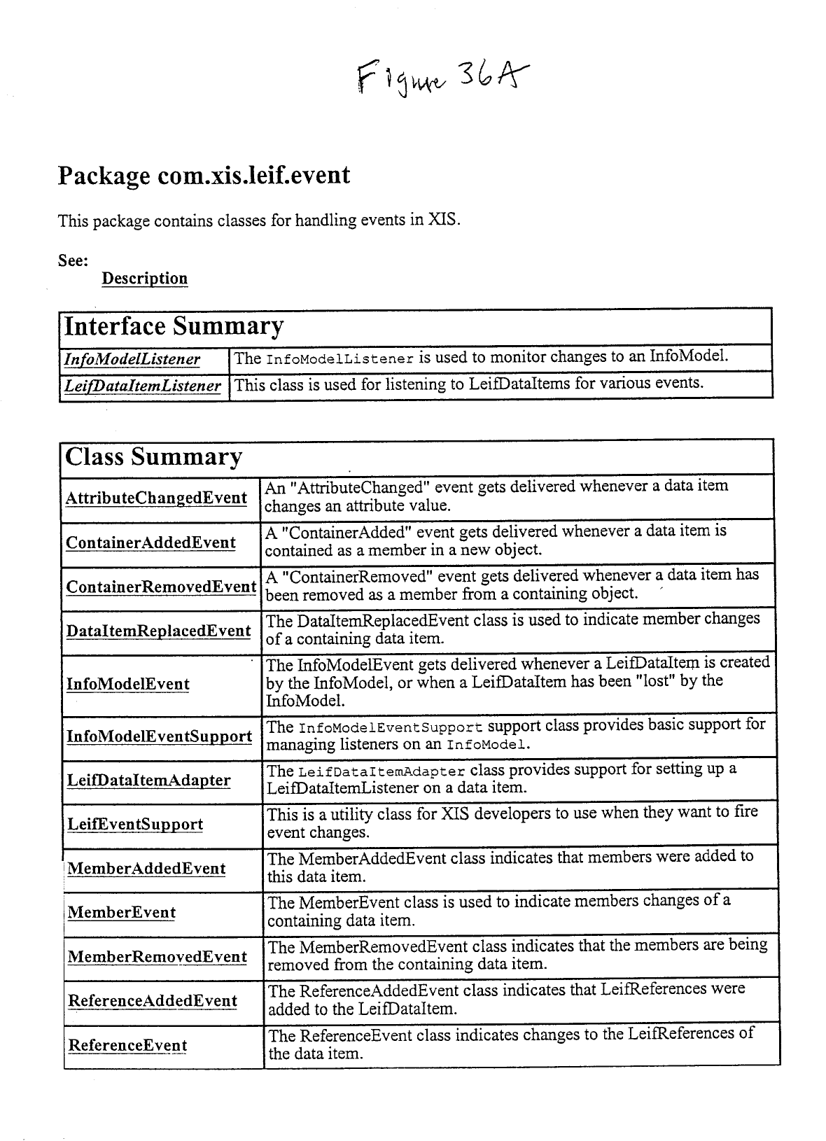

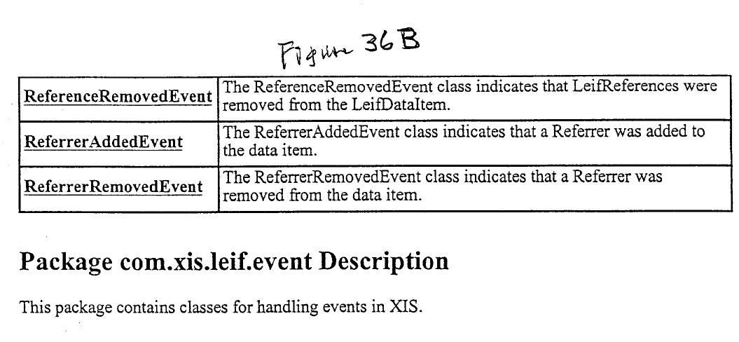

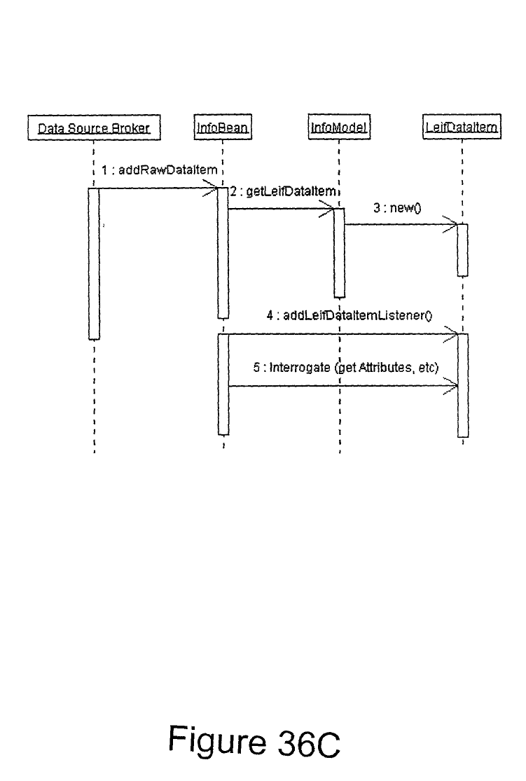

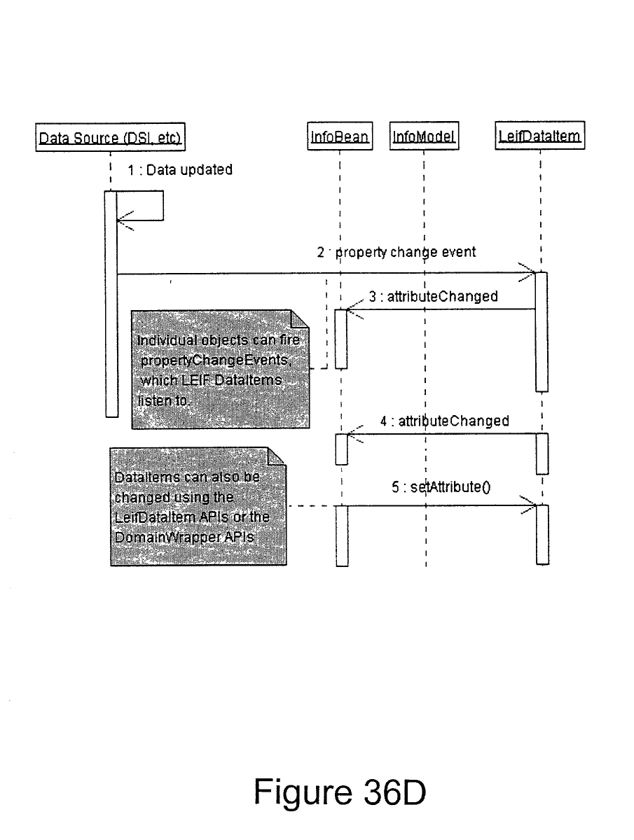

In one embodiment of the invention, the XIS framework models communication after the JavaBeans PropertyChange mechanism. FIGS. 36A to 36B show a listing of an exemplary package, com.xis.leif.event, which includes interfaces, event objects, and default implementation adapters for events in the XIS framework.

The UML sequence diagram shown in FIG. 36C shows how a data source interacts with an INFOBEAN. In particular, it shows how a data source and an INFOBEAN interact when data is added. The INFOBEAN gets a LeifDataItem for that object and adds a listener. When the data source updates the object, or if any other INFOBEAN updates the LeifDataItem, the LeifDataItem fires events to all listeners.

Each INFOBEAN may choose to listen for changes in the data it is using. If it would like to receive updates, it must attach a LeifDataItemListener to each data item to which it would like to listen. Thus, when something changes in the data, the listener receives the event. Upon receiving this event, the listener updates the corresponding data item if the change is one that concerns the INFOBEAN.

FIG. 36D shows a UML sequence illustrating how a data source and INFOBEAN interact particularly when data are updated.

In one embodiment, state attributes are defined to assist in determining change events as well as management of references. The state attribute describes what state the data is in at any time. This may be implemented to determine whether a data item should be kept and whether to display it, for example, without listening to the parent of the data, if there is one. Exemplary states are defined below:

(1) Deleted: When a raw data item is in this state, it is no longer being used and should be discarded.

(2) Exists: When a raw data item is in this state, the data exists and is still being referenced as either a member of another raw data item or it is a DSI itself.

(3) Live: This state includes everything in the Exists state. This state also means that the data item is also connected to a live data feed such as a database or server and that the connection is still alive.

(4) Dead: This state includes everything in the Exists state. This state also means that the data item was, at one point, connected to a live data feed, but the connection to the data feed no longer exists. An example of a Dead state is when the connection to a data server goes down and the data still exists in the DSI, but can no longer be updated.

To better help understand the features of the invention, sample information-handling applications, using Java programming, are exemplified and discussed below.

Example 1

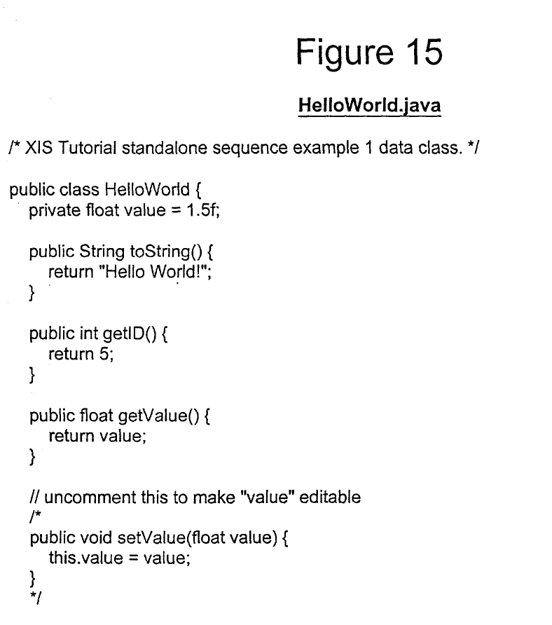

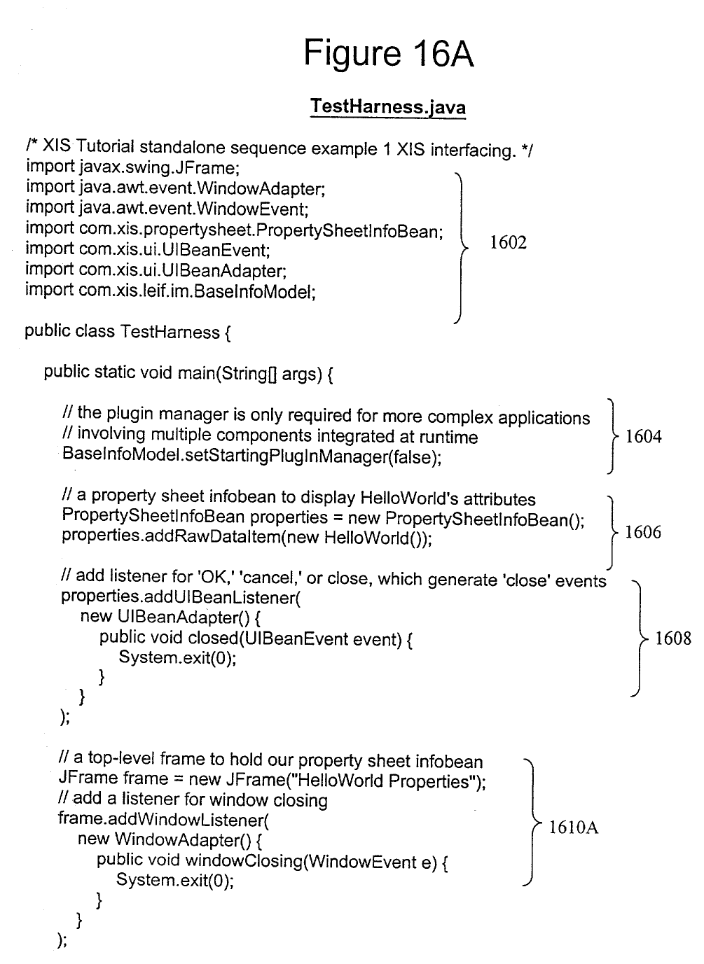

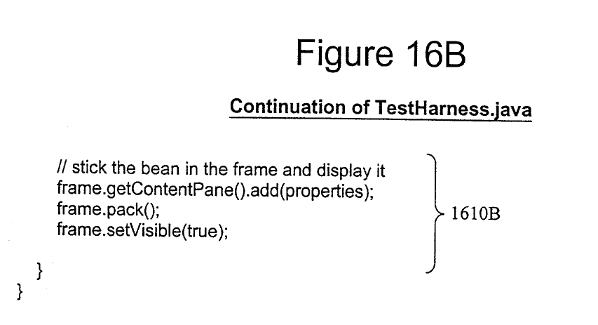

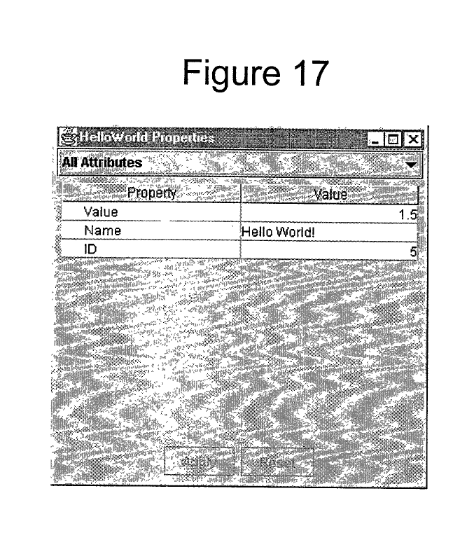

FIGS. 15 and 16 show two Java source files to implement an application within the XIS framework. The output is shown in FIG. 17.

FIG. 15 lists the HelloWorld.java source file that creates a Hello World object, which is a data source component. This source file is a minimal Java object that satisfies the method conventions for a JavaBean, in this case, it contains “get” and “set” methods (which often but need not necessarily correspond to private member variables), and a toString( ) method.

FIGS. 16A and 16B list the TestHarness.java source file that creates a TestHarness object, which is a data consumer component. TestHarness contains all the code to access all the information exposed within XIS and display its properties/attributes using a PropertySheetinfoBean. The PropertySheetInfoBean is a data consumer component, which displays the attributes of a data source component.

Referring back to FIG. 16A, as shown in the portion of code 1602, many standard classes of the Java language are used. In addition, a set of classes provided within the XIS framework, particularly within the mediation layer, is also used, e.g., com.xis.leif.im.BaseInfoModel. The code for the class library for the com.xis.leif class is not shown herein. Various alternatives relating to what classes are needed would depend on how the XIS framework of the present invention is implemented, designed, and the like, as will be known to those skilled in the art in view of this description.

The first line in main( ) of the HelloWorld.java code 1604 prevents the XIS PlugInManager from starting up. The PlugInManager is used for tying components of a large XIS application together based on resource files it finds associated with their classes. The PlugInManager is further discussed below. This feature is set to “off” to reduce the time to startup.

The lines of code shown 1606 in the first part of this source file sets up a predefined XIS InfoBean, in this case, PropertySheetInfoBean that is capable of displaying the available attributes of an object. The attributes are obtained through the Java language reflection method, which are used to make a wrapper object in the addRawDataItem( ) call. This means that the addRawDataItem method in the “properties” class is predefined within the XIS framework. This addRawDataItem method will ultimately result in the invocation of the reflection feature of Java so that the various attributes contained in the data source Hello World object are exposed to be used by the PropertySheetInfo.

The PropertySheetInfoBean uses the wrapper to access the attributes for display and, if necessary, enable the user to update the exposed attributes of the object. In this example, however, none of the attributes are editable. The PropertySheetInfoBean also fires a close event when a “Cancel,” “OK,” or close button is pressed. The next portion of code 1608 sets up a Java listener to exit the program when the appropriate button is pressed.

The last portion of code 1610A and 1610B creates a JFrame (Java frame) to display the INFOBEAN (it extends java.awt.Component). A listener is added to exit the program when the window is closed.

FIG. 17 shows the resulting display application on INFOBEAN called PropertySheetInfoBean. Example 1 is very simple, as it simply displays the attributes exposed for the Hello World object in a tabular format. Pressing a “close window” display button causes the application to exit.

Example 2

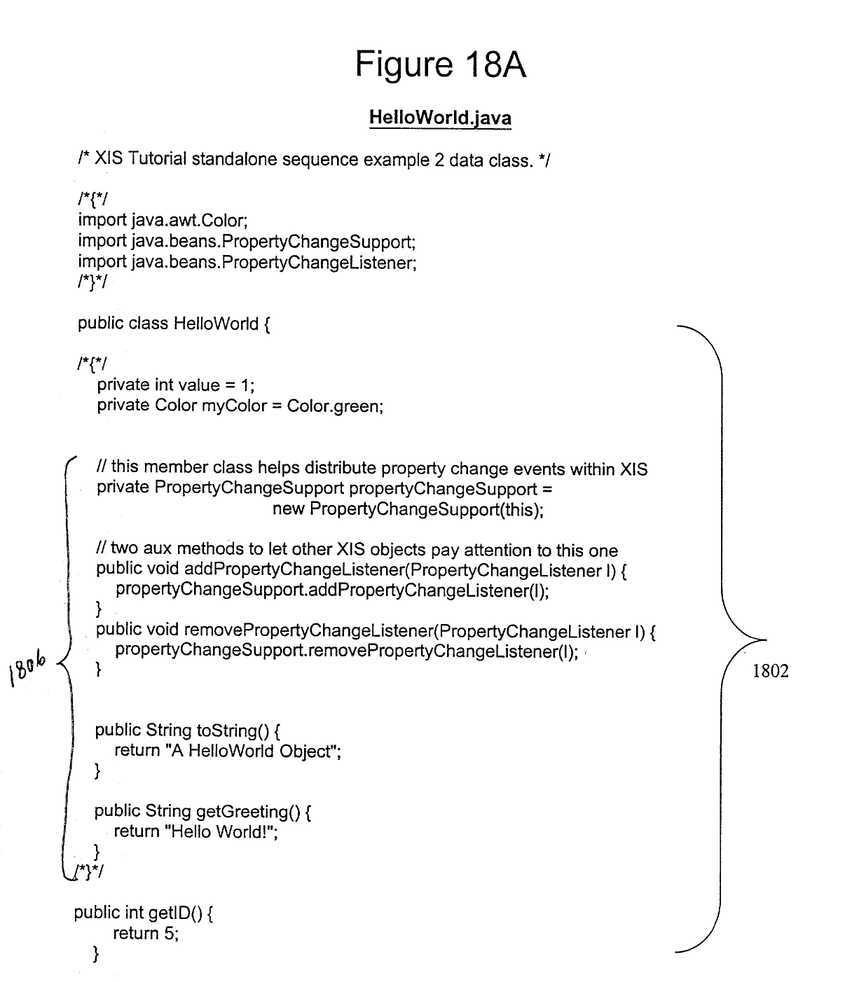

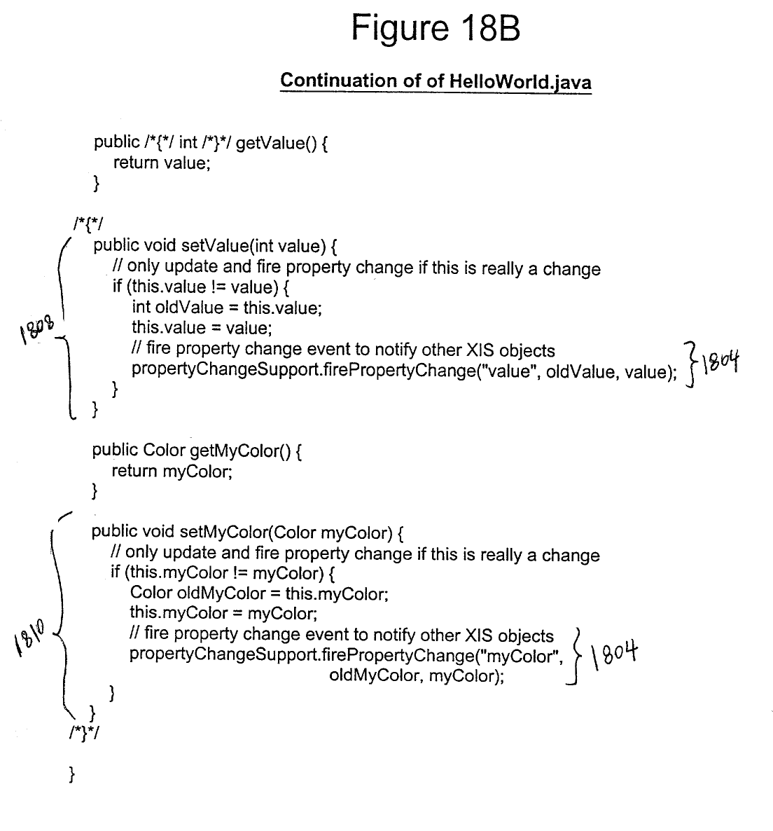

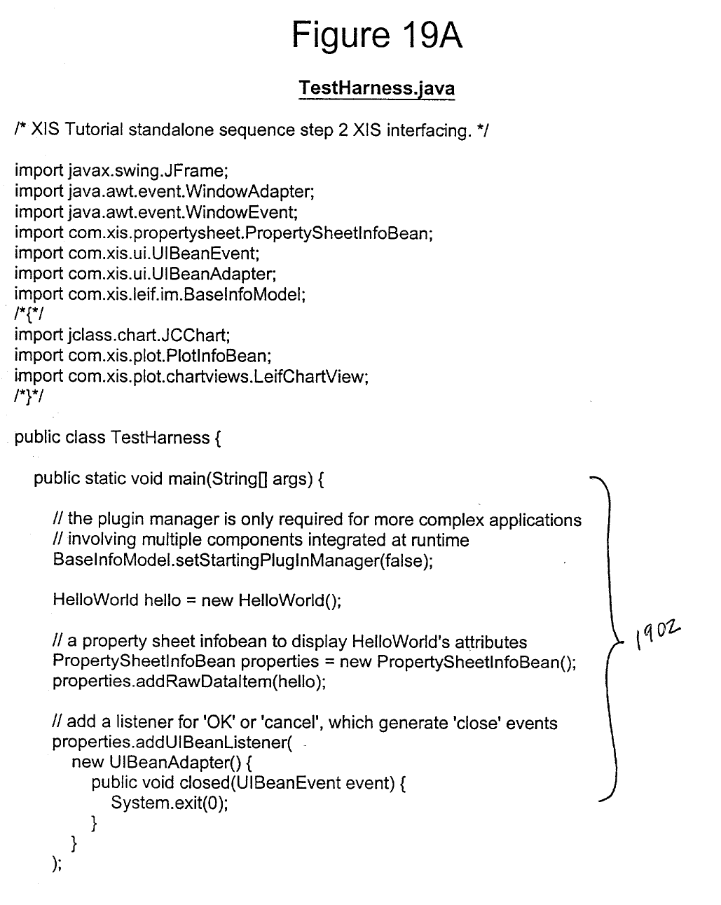

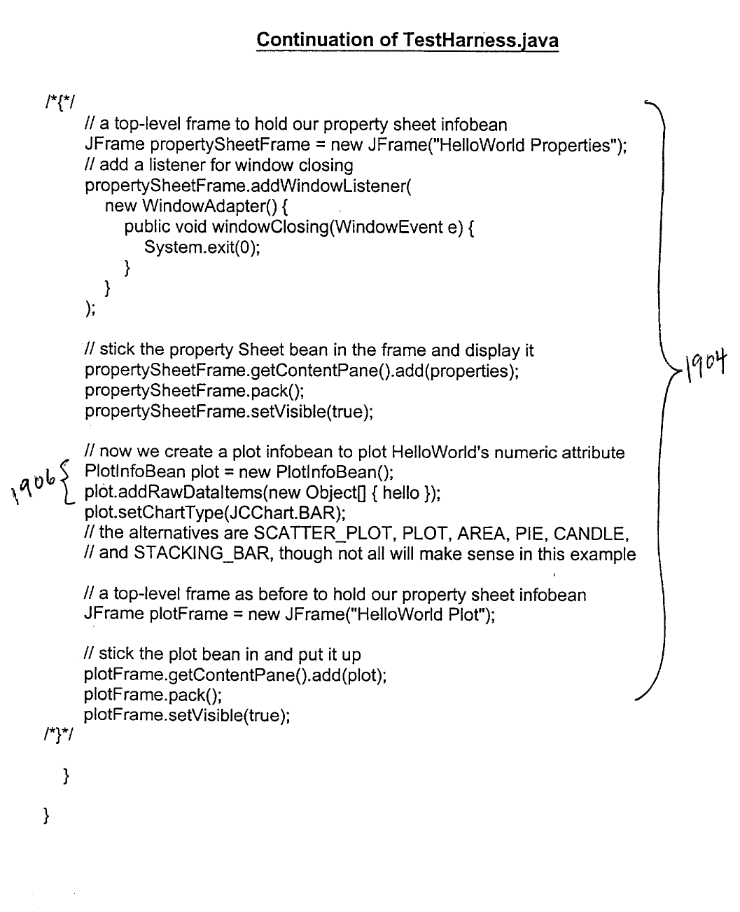

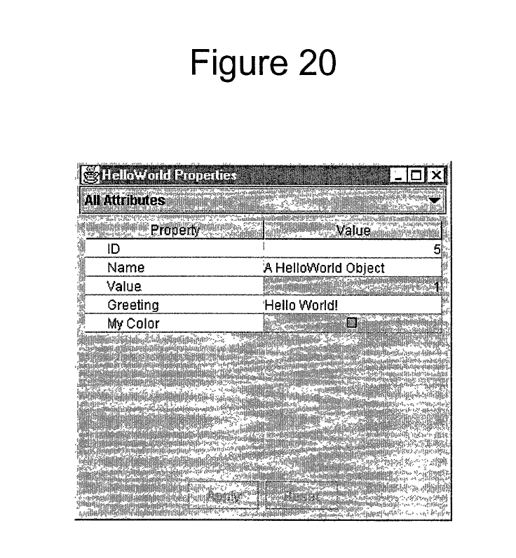

FIGS. 18A, 18B, 19A, and 19B list two Java source files. These two Java source files function similarly to those listed in FIGS. 15 and 16. Modifications or additions to the code listed in FIGS. 15 and 16 are marked with “/*{*/” <new code here> “/*}*/}.” The resulting output is shown in FIG. 20.

FIGS. 18A and 18B extend the previous Hello World class (FIG. 15) by using the JavaBean standard property change event distribution classes so that other XIS objects are automatically notified when its properties are changed (within the set methods). The java.beans.PropertyChangeSupport instance takes care of maintaining lists of listeners and sending events to them. It is only necessary to implement wrapper methods to pass listeners to this contained instance (the first block of new code after the imports 1802) and then to call the firePropertyChange method 1804 on it when anything is actually changed. This is performed in the setValue 1808 and setMyColor 1810 methods. Value and My Color are editable fields.

FIGS. 19A and 19B contain the TestHarness file. Similar to FIGS. 16A and 16B, the TestHarness file contains code to expose an instance of this object within XIS. In this case, not only are the properties or attributes displayed using a PropertySheetInfoBean, but a charting program, ChartInfoBean, i.e., another data consumer component uses the same data item to display a chart accordingly. The ChartInfoBean automatically searches for numeric attributes on the data item and plots them accordingly. The Numeric attributes are recognized as such through reflection when the raw data item, Hello World object, is wrapped within a LeifDataItem object.

Similar to FIGS. 16A and 16B, the TestHarness file contains code to expose an instance of this object within XIS. In this case, not only are the properties or attributes displayed using a PropertySheetInfoBean, but a charting program, ChartInfoBean, i.e., a data consumer component feeds the same data item to display a chart accordingly. The ChartInfoBean automatically searches for numeric attributes on the data item, and allow them to be plotted. The Numeric attributes are recognized as such through reflection when the Hello World object was registered within the XIS framework.

The first portion of code 1902 sets up a property sheet INFOBEAN similar to Example 1. The second new code portion 1904, marked in the drawing by comment braces, sets up a second frame and puts a ChartINFOBEAN into it. Since the chart can display multiple data items, the method to feed it data items (addRawDataItems) 1906 takes an array of objects. The method setChartType 1908 may be used to specify the type of chart, its axes, and so on.

FIG. 20 shows the PropertySheetInfoBean displaying the attributes of the data item, i.e., the Hello World object. The charting component is not shown in the figure.

Example 2 application puts up two windows—a property sheet displaying information on a Hello World object and a chart display (alternatively called a “plot” display) showing one or more of the numeric attributes of the same data item. On the property sheet, editable fields are surrounded by a darker gray background. In particular, one may change the “My Color” property by clicking on it. Clicking on this property brings up a default editor for color attributes defined within this framework. In this embodiment, numbers, strings, dates, and several other kinds of attributes all have appropriate editors automatically set up for them within XIS, via the TypeMetaData facilities.

The chart starts out displaying either the ID or the Value attribute. It may be changed by clicking on the Y axis label. This is also the way to set which kind of chart (bar, line, pie, etc.) is used. If the value being plotted (or the color) is changed in the property sheet (and the display button “Apply” is pressed), the chart automatically updates. Similarly, right clicking on the part of the chart corresponding to a data item enables a user to bring up its property sheet. In this embodiment, this kind of coordination is maintained automatically within the XIS framework through the use of the JavaBeans event mechanisms. It should be noted that when the application is run or executed, the color of the chart does not match the one set in the property sheet. This is because, although the PropertySheet recognizes that any field of type “java.awt.Color” is displayable and editable as a color, the chart has no way of knowing which color field (if there are more than one) should be used. This may be solved, however, within the framework by using standardized Domain Attributes.

In one embodiment of the invention, Translators are used within the XIS framework. As described earlier, a DSI exposes data information within the XIS framework for data consumers to use. Java reflection and introspection may be used to obtain attributes specified in simple objects and JavaBean, respectively. The XIS framework first searches for a Translator class for the data source object. Translators are therefore optional considering that the attribute values and attribute descriptors may directly be obtained from an object. Translators may also be used in order to keep the object's class simple so that it is capable of being used in non-XIS environments.

In an embodiment, Translators are somewhat similar to the BeanInfo class in JavaBeans. Like the BeanInfo class, the name of the class must begin with the name of the data class followed by “Translator”. For example, a DSI class named PlanObject.java would have a corresponding Translator class PlanObjectTranslator.java. Also, similar to BeanInfo classes, Translators must reside in the same class space in which the DSI is located. For special circumstance cases such as non-localized objects or custom Translator definitions, a Translator registry, e.g., TranslatorRegistry, may be used to register a Translator for a given data item class.

Table VIII below shows an exemplary code to register a Translator within the XIS framework.

TABLE VIII
//register the translator for File objects
TranslatorRegistry.getTranslatorRegistry()

.registerObjectSchema(PlanObject.class,
PlanObjectTranslator.class);

The above code, as well as all code discussed herein, is provided to illustrate the functional behavior described herein. One of ordinary skill in the art will be able to produce the code, for example, to create classes, objects, APIs to affect this Translator registry.

When the value of an attribute is requested from a data source component, using the mediation layer, the value from the attribute methods specified in the Translator, if any, is exposed. If the Translator does not exist, then the method in the object is invoked, i.e., the get+attribute method within the data source object. The Translator may directly invoke the object's methods as well. The Translator may also be used to wrap legacy code. For example, if the object class is a legacy code, which may not be modified, and has a color property, a Translator may be written to return the value of the color, for example, for the DisplayDomain.color attribute. In this way, the information may be accessed without modifying the original legacy code. The data in the data source object in effect has been normalized or tailored to the domain policy specified. The XIS framework in this embodiment provides the ability to integrate existing data item classes without modifying them.

To integrate a data item class into the XIS framework, an accompanying Translator class should be provided. In this Translator class, the data source developer provides code that reaches back into the data item's class to expose its properties. It also serves as a way of normalizing access to these properties by imposing a common interface for all Translators to implement.

Translators have two primary functions:

(1) Translators provide an intermediate method from the caller of an attribute “get” or “set” method to the data source object, enabling a developer to translate the value from its internal representation to a representation understood within the framework, particularly, by the data consumer components. For example, an object may store a default color as a string color name, but the Translator may convert that color to a java.awt.Color object.

(2) Translators also enable a developer to define attribute types more precisely (e.g., via AttributeDescriptor code, which provides detailed TypeMetaData and may map attributes to specific domains). This resolves any ambiguity in the attribute type. It should be noted that reflected properties that are converted into XIS attributes carry minimal semantics, which contributes to the usefulness of the XIS framework. For example, “float getDegrees( )” by itself does not imply whether it provides an angular measure or a temperature measure, nor does it imply that the valid range is from 0 to 360 or from 0.0 to 2.0 pi for angular measures, or distinguish between Fahrenheit, Celsius, or Kelvin for temperature measures.

Translators also enable developers to convert objects that do not follow the JavaBeans get/set API design pattern. For instance, a data item could be implemented as a mapping of attribute names to values (e.g., String, Integer, Double, and Boolean).

The Translator may map actual XIS attributes to these key/value combinations, making XIS data items appear as if they were generated from the more typical JavaBeans-style objects. Example 3 shows how a Translator may be implemented in the XIS framework.

Example 3

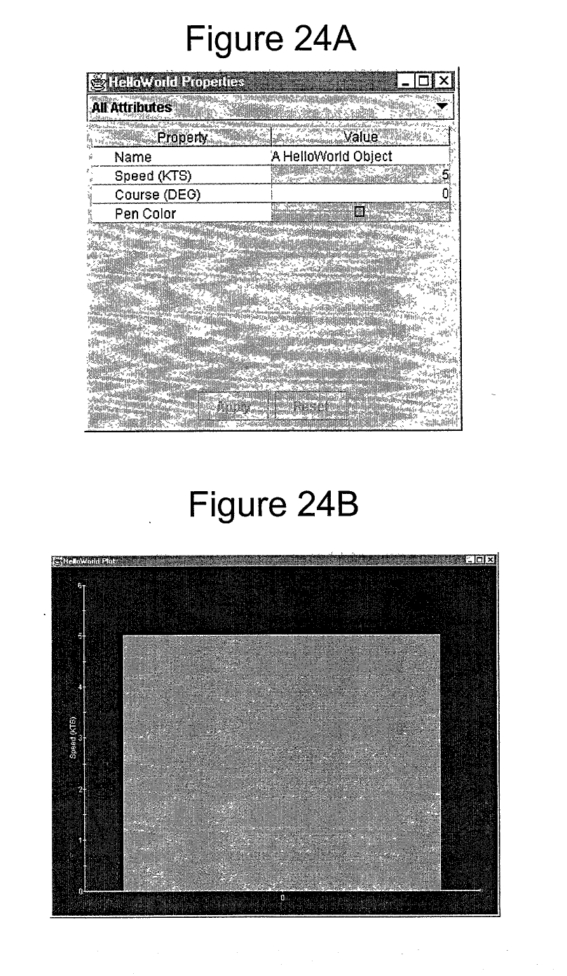

Example 3 application is contained in three source files listed in FIGS. 21, 22A, 22B, 22C, 23A, 23B, 23C, and 23D. The resulting outputs are shown in FIGS. 24A and 24B.

Example 3 functions similarly to Example 2 above, but enable finer control over the data item attributes exposed within XIS. In particular, the Hello World object is explicitly wrapped in a Translator rather than simply feeding it to XIS and letting it rely on reflection to display and manipulate the data. This allows some properties of the raw data item to be hidden, and allows other ones to be better “understood” within XIS. The Hello World Translator.java file contains the Translator.

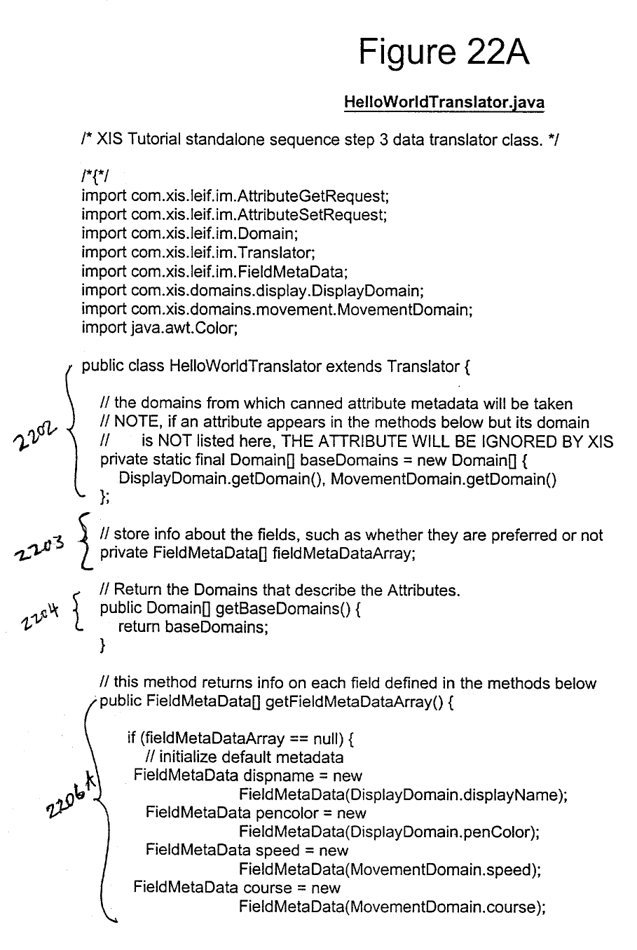

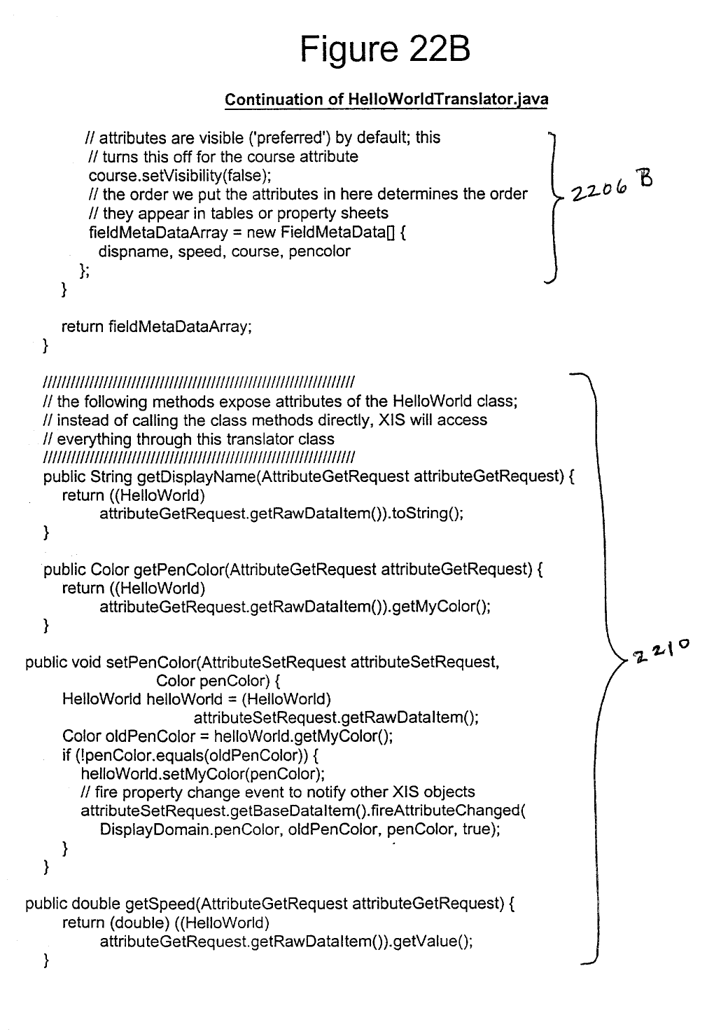

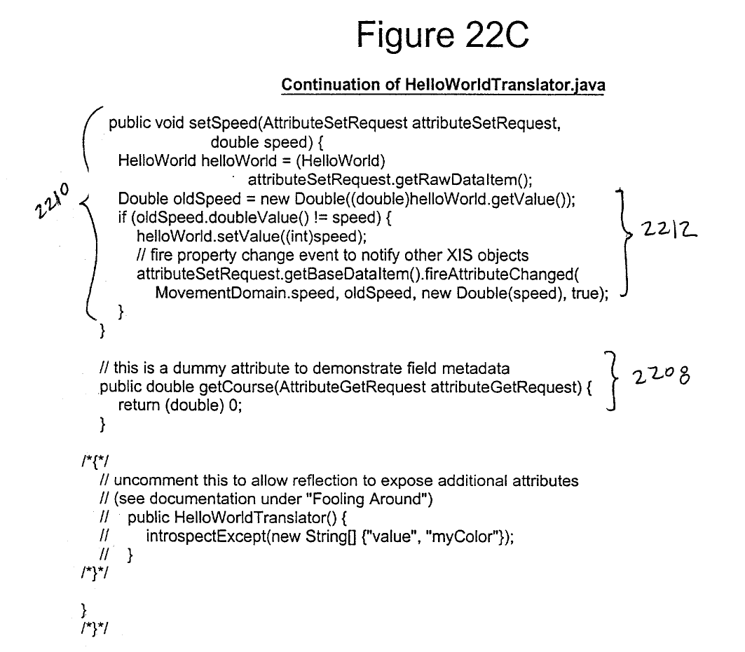

Referring to FIG. 21, the property change event-handling portion of code 1506 found in FIG. 18A has been removed from the set methods. These functions are now handled in the Hello World Translator class (FIGS. 22A-22C), which is registered with XIS by the TranslatorRegistry static call at the beginning of that class.

Referring to FIGS. 22A to 22C, this file contains the Hello World Translator class 2202 that wraps the Hello World object. When an INFOBEAN encounters a raw data item, it ultimately accesses the raw data item through a Translator's methods, if a Translator exists. In one embodiment, all Translators are subclasses of the com.xis.leif.im.Translator class, which provides an infrastructure that facilitates the use of attributes already defined or set-up in an XIS Domain. Such attributes have type metadata predefined for them, and many XIS INFOBEANs automatically access and utilize the metadata and the attributes themselves.

The first member variable 2204 of the Hello World Translator class lists the predefined XIS domains from which attributes are taken. In order to use an attribute not in one of these domains, it may be necessary to provide a separate metadata for it. The second member variable 2203 defines an array, which lists auxiliary information on the fields, in this case, whether they are displayed by default in the property sheet display. The getFieldMetaDataArray method 2206A and 2206B fills this array, if necessary, with the default metadata for the fields that are exposed by the get and set methods further listed below in the source file. The exception to the defaults is that the “course” attribute 2208 is not visible, i.e., it is not displayed under the “Preferred Attributes” on the property sheet. It is displayed, however, when the “All Attributes” option is selected. Other things that may be set (but are not in the source file) include the sorting order and rank when multiple data items of this class are listed together, as in a table.

The ensuing get and set methods 2210 define the attributes that the rest of the XIS objects can see. In general, this refers to the enclosing raw data object, but this need not always be the case. For example, here, the Hello World's integer ‘value ’ property is map to the ‘speed’ attribute, which takes its metadata and its type (double) from the Movement domain 2212. The Movement domain has previously been defined. By handling conversions within the Translator, the rest of XIS “never knows” that there is really an integer value underneath.

All change event propagation is handled through the request objects passed into the set methods 2214. Similar to Example 2, all XIS objects using the same data item are notified of the change.

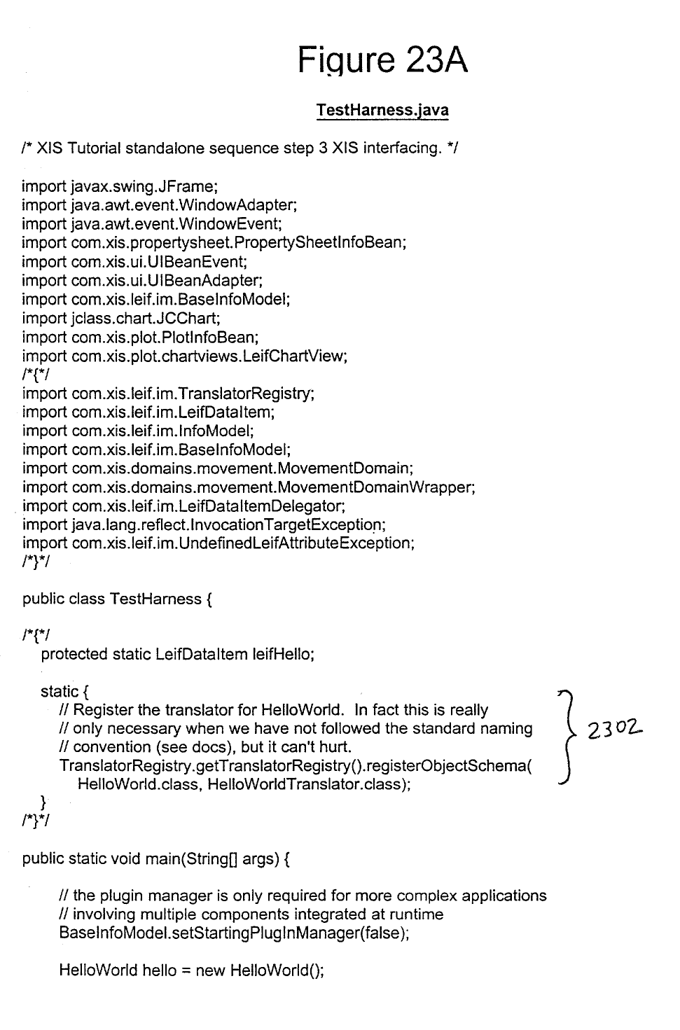

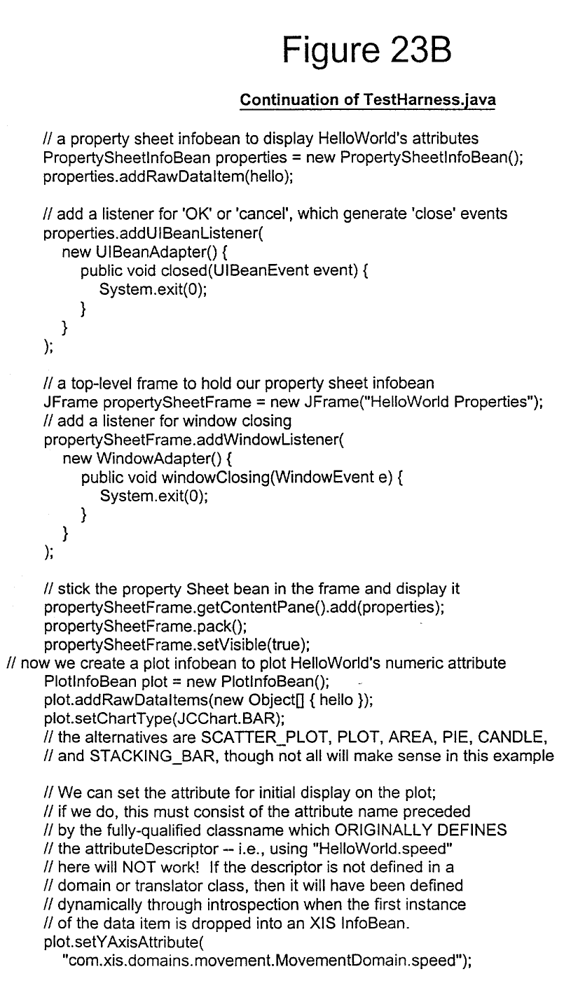

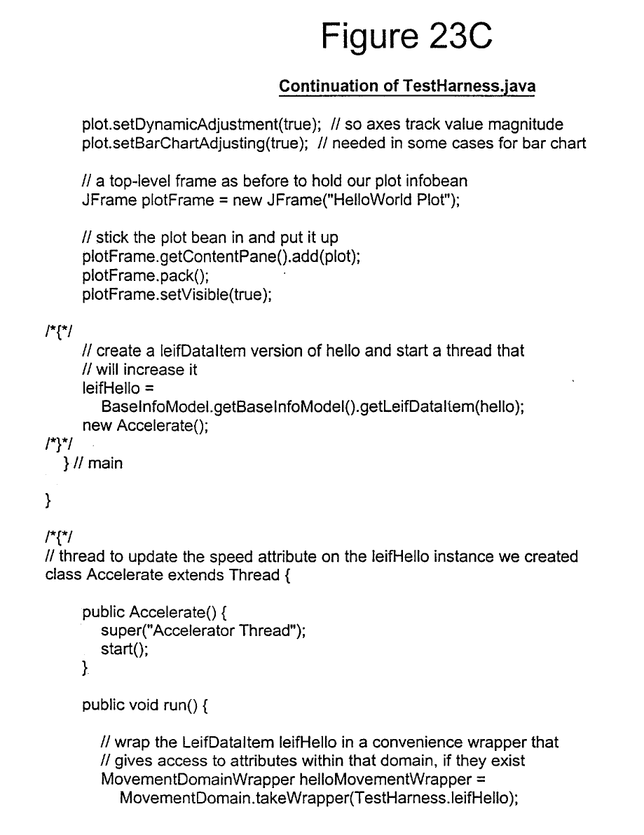

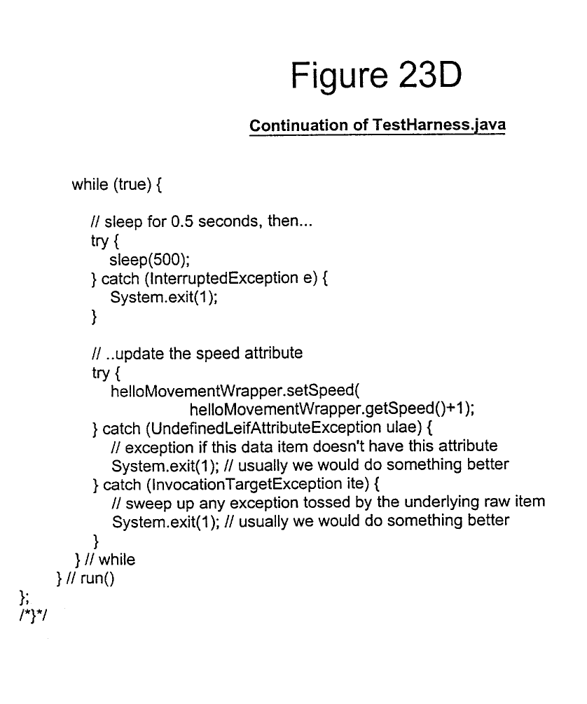

Referring to FIGS. 23A through 23D, the TestHarness code is largely unchanged from Example 2, but at the end it includes a separate class that demonstrates how attributes may be altered on a data item that includes a Translator. In general, the procedure is to obtain, first, the LeifDataItem corresponding to the raw data item, then a “domain wrapper” that wraps this and enables access to attributes that come under that domain. Internally, the domain wrapper calls methods on the Translator, but externally it presents an interface to the developer that depends only on the domain and not on the particular LeifDataItem being wrapped.

The code in the Accelerate class is a standard thread implementation that uses the wrapper to successively change the Hello World data item's speed attribute. In other embodiments, this attribute may be altered by any portion of the program that has access to the data item. Because the wrapper eventually calls the Translator, the change events are propagated appropriately.

The Example 3 application, similar to Example 2, displays two windows—a property sheet and a chart. Example 3 shows that the property sheet may be made to display more properties (in this case, the “course” attribute) by selecting “All Attributes” from the top menu, which ignores the “preferred” setting in the FieldMetaData. The attributes all have reasonable names, which come from the metadata stored in the domains. Finally, if the “Pen Color” attribute is edited, the plot changes color accordingly. This is because the Chart INFOBEAN recognizes and uses the “Pen Color” attribute from the Display Domain if it finds one on the data item. Because of the various wrappers employed, it does not matter what kind of object is eventually underneath or what other attributes it has; as long as the “Pen Color” attribute is found, it will be used.

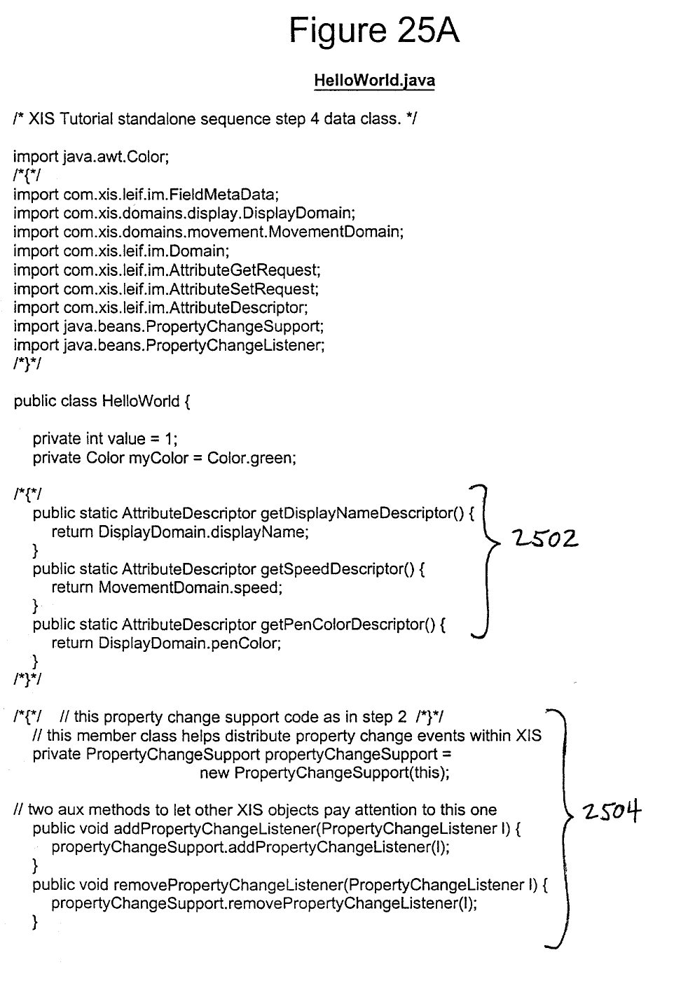

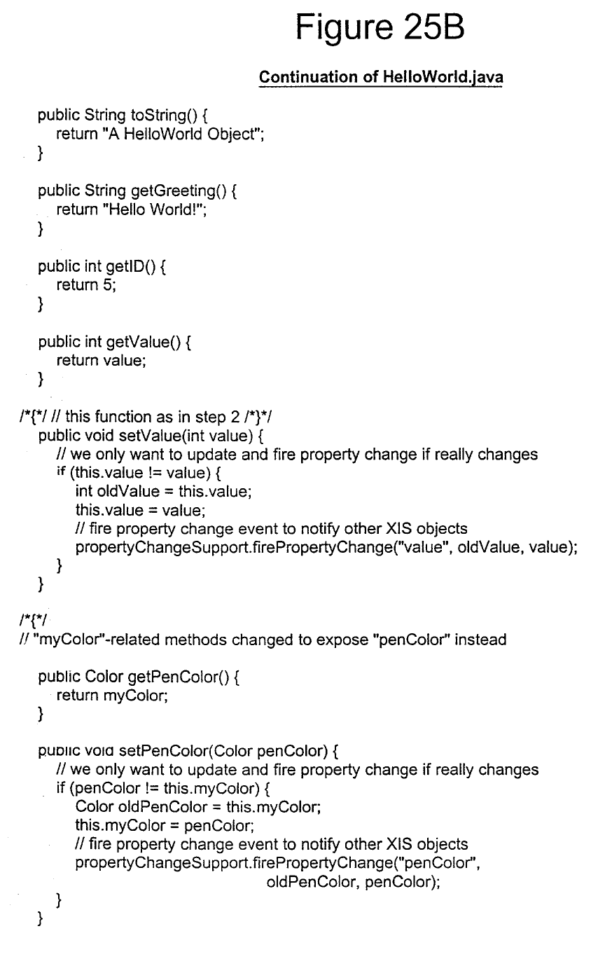

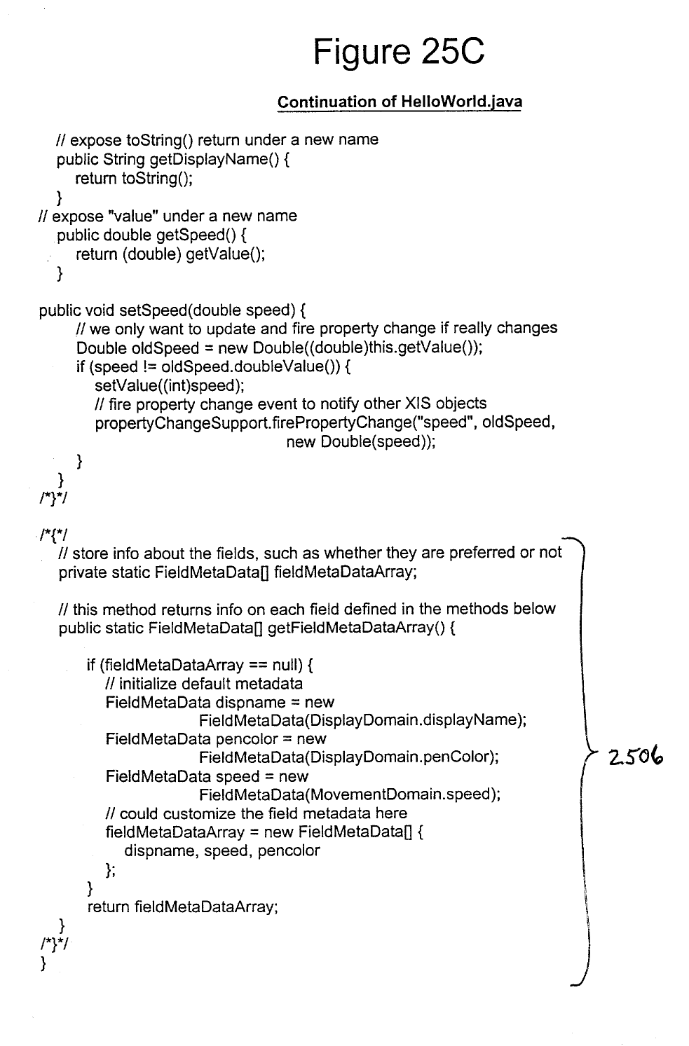

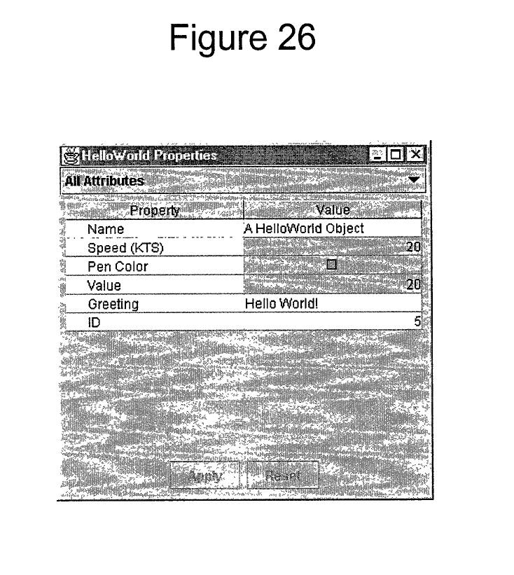

Example 4 Example 4 contains two source files namely Hello World and TestHarness. FIGS. 25A to 25C list the Hello World.java source file. This example shows translation without a Translator class. The resulting output is a property sheet INFOBEAN and a Chart INFOBEAN. FIG. 26 shows the property sheet InfoBean, but the ChartINFOBEAN is not shown. The Hello World Translator.java file from Example 3 is eliminated. Similar to above, the Hello World.java file has been marked such that changes from Example 3 are marked by open and close commented braces.

The Java source files enable some of the same fine control over the attributes exposed within XIS (see Example 3) without using a separate Translator class. If a developer has control over the Java code for the data source, the overhead of using a Translator may be eliminated by building some of its functions directly into the data source. It may, however, still be desirable to use a Translator because this avoids building any XIS-specific code into the JavaBean created and enables the code to be more streamlined for use in non-XIS contexts.

FIGS. 22A to 22C contain the Hello World code, which include some of the code from Example 3, with some additional code for exposing attributes and providing field metadata as the Hello World Translator class in Example 3. In fact, almost everything may be done from within this data item class that could be done with a Translator except for two things. First, attributes cannot be hidden from XIS—everything with a get( ) method is exposed. Second, Translators may be used in conjunction with security features, for example, embodied in the XIS framework to restrict access to visible properties in a generalized fashion across all data items.

The first portion of code 2502 provides methods for XIS to obtain information on which data item properties have attribute information provided for them. The XIS components first introspect on the data item to find its properties, then try to call the get(property name)Descriptor for each property. For those instances where this fails, the XIS component may provide its own attribute descriptors where it recognizes the type of the attribute. For example, the property sheet recognizes Color, Numeric (various subtypes), Date, and String attributes. The next portion of code 2504 initializes a PropertyChangeSupport instance, because property change events must be handled here, similar to Example 2.

Following this are several methods unchanged from Example 3, but the set( ) methods have been altered to resemble those from Example 2 in which property change events are fired. Next, there are several new get( ) and set( ) methods which expose the properties with the same names as the Translator did in Example 3. These names correspond with the getAttributeDescriptor methods listed above in the code, and the XIS components interpret them accordingly. These properties show up as preferred attributes in the property sheet, whereas those properties without corresponding attribute descriptors become nonpreferred attributes.

The portion of new code 2506 following this provides field metadata for this raw data item. This program code is almost identical with those in the Example 3 Hello WorldTranslator, except that both the variable and the method are now static, and the “Course” attribute removed to reduce clutter.

The TestHarness file for Example 4 is generally unchanged from Example 3, except the code to register a Translator is removed. The portion of program code 2302 in FIG. 23A is removed in this example.

This Example 4 application is largely similar to Example 3, except that if the “All Attributes” option is chosen under the property sheet, then the previously unexposed “value”, “myColor”, and other attributes appear. The chart is also able to display the “value” and “ID” properties.

FIG. 26 shows a window display of the property sheet output from the Example 4 application.

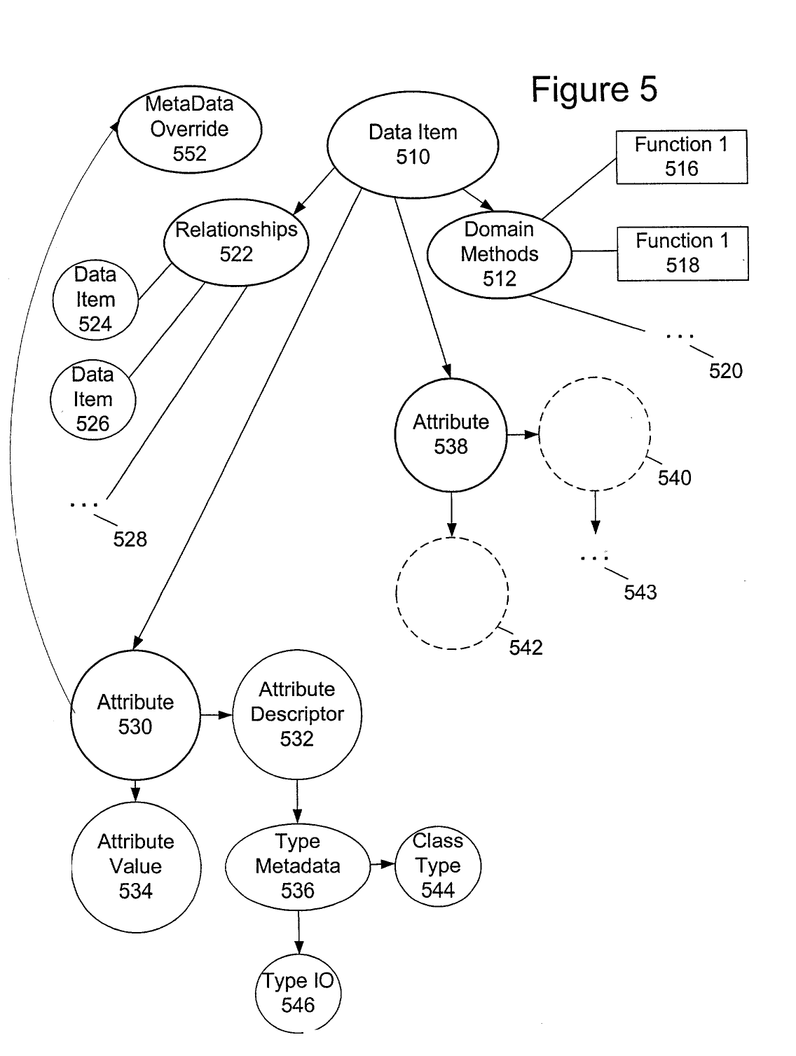

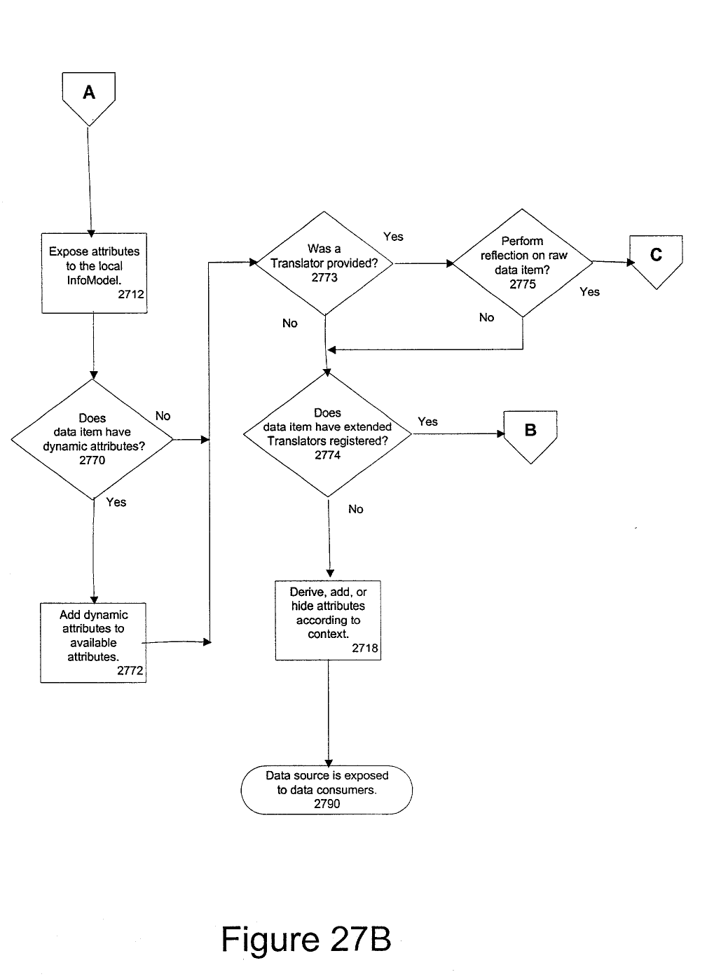

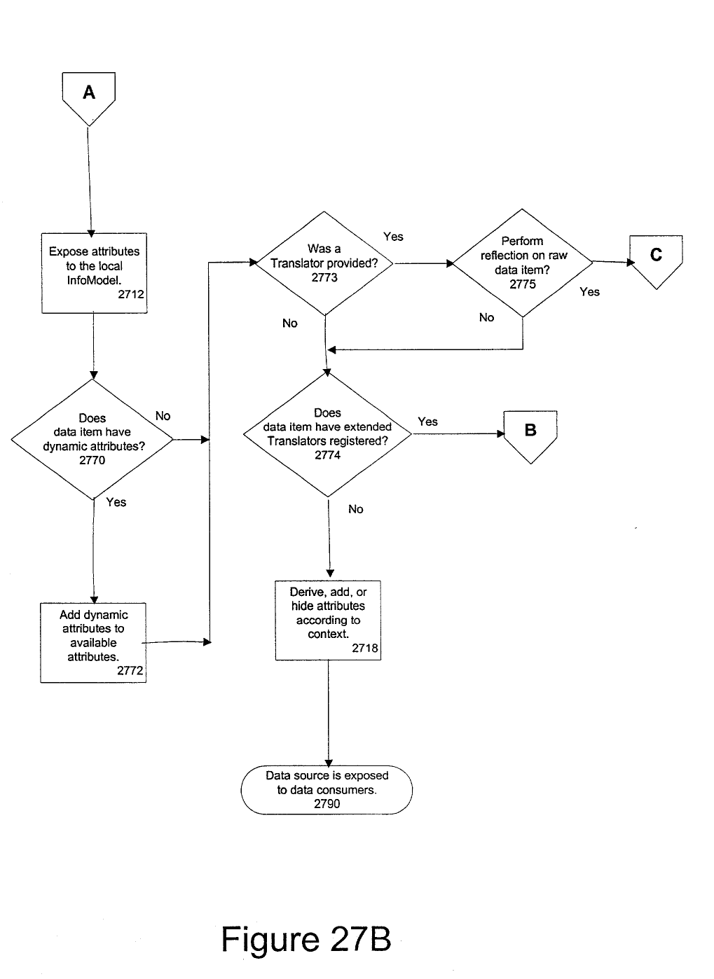

Processing Flow for Exposing Data FIG. 27A and FIG. 27B show a flow diagram of how information about a data item, e.g., a data item as shown in FIG. 5, is exposed to data consumer components. In the preferred embodiment, data exposure within the system may be accomplished by one of three methods, described further below. There are two primary functions to be performed: (1) interfacing with an internal or external data source such as a set of disk files, a database, or a web service; and (2) exposing the resulting data according to the standard interface outlined above, e.g., following the domain interface, relationships interface, and the like.

In the first method of exposure, one software component performs both functions; in the second method, separate software objects perform the two functions; in the third method, which is only implementable in an object oriented programming language that provides self-analysis facilities, such as Objective C or Java, the exposure function is performed automatically by the system. More particularly, in the first method, a data source interface (DSI) software object is written that connects to an external data source such as a local file system, an Internet site, or an RDBMS. The DSI object converts the information provided by the external data source into the information representation or data item that may be consumed by data consumer objects as described above. In a preferred embodiment of the invention, the data source DSI objects are from the LeifDataItem class.

In the second method, the API of an existing software data object is accessed by a Translator object, which then exposes the information to other data consumers in the representation format discussed above. This arrangement is referred to in the object oriented design literature as an Adapter or Wrapper pattern. See, for example, Gamma, E., Helm, R., Johnson, R., Vlissides, J. (1995); Design Patterns: Elements of Reusable Object Oriented Software; New York: Addison-Wesley. This is generally referred to as “wrapping”. More precisely, a data consumer component requests information from the Translator object, which then converts the request into something the original data source object can deal with. The consumer then converts that object's response into the appropriate format for a response to the original call.

The third method applies the facilities within a self-analysis-capable programming language such as Java or Objective C. This type of programming language enables an object to determine the available data fields and function calls afforded by another object while an application is running. In the preferred embodiment implemented in Java, the queried object must be a “JavaBean” according to Sun Microsystem's suggested convention, with “get( )” and “set( )” method calls. Each data field available through one of these calls, or by virtue of being a “public” variable, is examined, and the resulting type information is used to expose both the field's value and appropriate metadata to data consumers. If the field is a numeric type (double, Double, float, Float, Integer, int, long, or byte in Java), it is exposed as a decimal or integer with an “unknown” unit of measure. If the field is a string (String in Java), it is exposed as a text element. If the field is a complex object, it is exposed as a linked element via a reference (discussed above), unless a special class has registered to handle the complex object type within the application context or XIS framework.

In another embodiment, in addition to the facilities for exposing data, the XIS framework provides an apparatus for allowing application context to affect how information is exposed. This is illustrated in FIGS. 27A, 27B, and 28, described further below. The attributes, methods, and relationships available for a given data source are determined by a surrounding structure called an InfoModel. The InfoModel connects the pieces of the XIS framework together. It is an interface comprising an object that knows how to return data item information. See also FIG. 3A discussed above.

In another preferred embodiment, an application comprises one or more Views, each containing and providing an InfoModel to one or more data consumers, termed INFOBEANS as described above, which may provide display, computational, or interactive facilities. All of the Views are in turn managed under a single ViewHost, which provides the global application context. Conceptually, a view represents a single perspective of the current data. One single perspective (or view) could be quite different from another because of the ability to add/override attributes in a view. View creates a new InfoModel that in turn creates new LeifDataItems that are used within that view. This is done to separate context sensitive attributes between an InfoModel and another View, INFOBEAN, or InfoModel. Views are also used as a controller of one or more INFOBEANs by managing the data flow to each individual INFOBEAN. All Views are also by definition INFOBEANs since they manage information flow with generic means. The ViewHost is used to manage the complete set of Views and INFOBEANs, thus presenting each view to the user in a uniform fashion such as frames, windows or other display mechanisms.

FIG. 27A and FIG. 27B show a flow chart of a data exposure facility within the XIS framework constructed in accordance with the present invention. The diagrammed operations will occur when the XIS framework is loaded into program memory of a computer system that supports an object oriented programming (OOP) environment, as will be understood by those skilled in the art. In the first processing step, at block 2702, a data source object is registered within the XIS framework of the computer system. When a data item is brought into the framework, it is exposed to data consumer objects, e.g., via an InfoModel, typically via one of three methods. The first operation is to determine whether a Translator object is available and whether the Translator object is registered for the raw data object type. This processing is represented by the decision block 2704.

If the Translator is available, an affirmative outcome at the block 2704, then at block 2760 the data item attributes, methods, and Domains are obtained via the Translator. If the Translator is not available, a negative outcome at 2704, then at block 2706 the data item object is scanned to find the data object's methods. The scanning may be accomplished with facilities of the OOP environment of the host computer system, such as InfoBeans.

After the data item object has been scanned at block 2706, the system next checks to see if the data item includes an XIS-standard data exposure interface (that is, a predefined interface known to the XIS framework). If the standard interface is available, an affirmative outcome at block 2714, then at block 2762 the data item object attributes, methods, and Domains are obtained from the data source object itself. The system then checks for references to Domain Policies at block 2763. If there is no standard interface available at the decision block 2714, then processing moves to the block 2764, where the facilities of the programming language of the OOP environment are used to interrogate the data item object to determine the object's accessible data fields. Processing then moves to exposure attribute processing via the off-page connector B to FIG. 27B, described below.

Returning to block 2762, after the data item attributes, methods, and Domains are obtained, a check is made for Domain Policy references at the decision block 2763. If there are references to Domain Policies, an affirmative outcome at the decision block, then at block 2765 a check is made to determine if there is FieldMetaData override for a Domain. If there are no Domain overrides, then at block 2710 the definitions from the referenced Domain Policy are used for the attribute metadata. The processing then moves to exposure attribute processing via the off-page connector A. If there are Domain overrides, an affirmative outcome at block 2765, then at block 2716 the system uses the definitions included with the data item object Translator for the attribute metadata of the data item. The processing then moves to exposure attribute processing via the off-page connector A. Referring back to block 2763, if there were no references to Domain Policies, then processing proceeds straight to block 2716 to obtain the attribute metadata definitions and then to the exposure attribute processing via the off-page connector A to FIG. 27B.

Turning to the processing of FIG. 27B via the off-page connector A, the data item attributes are exposed to the local InfoModel class (i.e., a DSI object). Next, at the decision block 2770, a check is made to determine if the data item has any dynamic attributes. If the data item does, then at block 2772 the framework processing adds the dynamic attributes to the available data item attributes. If the data item has no dynamic attributes, or after any dynamic attributes have been added, processing moves to block 2773, where the system checks to determine if a Translator was provided (registered) for the Data Source object. If a Translator was provided, then at the decision box 2775 the system checks to determine if reflection has been requested. Those skilled in the art will understand that reflection is an operation that is provided by most OOP environments, such as by Java.

If reflection is to be performed, then processing returns to FIG. 27A via the off-page connector C, whereupon the Data Source is scanned. If reflection is not to be performed, or if no Translator was registered (a negative outcome at block 2773), then processing moves to the decision block 2774. At block 2774, the system checks to determine if the data item has registered any extended Translators. If there are no extended Translators, then at block 2718 the data item attributes are derived, added, or hidden, depending on the data context gleaned from the DSI. The data item is then fully exposed to data consumer components for use (block 2790). If there are extended Translators, an affirmative outcome at block 2774, then processing returns to FIG. 27A via the off-page connector B to obtain the information from such Translators (block 2760).

FIG. 28 is a diagram showing how InfoModels provide contextualization within the XIS framework. The initial “raw” object (e.g., Java object or data from RDBMS) provided by the data source is exposed through mediation by successive “wrapping layers” of other objects, which determine which fields are visible, and possibly performs conversions or consolidations. Each “View” within the XIS framework, which contains one or more “INFOBEAN” consumers, carries with it its own context. Feeding a data source component to a consumer component places it within that context.

When a data element provided by a data source is introduced to an InfoModel, the InfoModel actually provides a new element derived from this one to consumers. This derived element provides the actual data source interface discussed above. The attributes, type metadata, and methods provided for the element are first determined as described below under “data exposure facilities”. Then the InfoModel inspects the results and decides whether to add or derive any new attributes, or to hide existing attributes. Once the data is added to an InfoModel (discussed below), it may be asked for by other components for processing and visualization purposes.

In another embodiment, the ViewHost, a data consumer component, provides facilities allowing interactive cut and paste and drag and drop of information elements between different consumer components. When a cut-and-paste or drag-sand-drop occurs, each information element is decontextualized and then recontextualized inside the new InfoModel into which it is placed. This means that some attributes previously available may be removed, whereas others, more appropriate to the functions of the recipient consumer(s), may be added.

Referring back to FIG. 28, this figure shows how multiple InfoModels work to share references to raw objects. This figure also illustrates how an INFOBEAN and/or a DSI adds objects to the InfoModel to obtain data items. The DSI 2815 creates an instance of source raw data item (e.g., Java object) 2830. The original source objects are maintained by DSI and one or more InfoModels have references to these source objects. The raw data item 2830 is provided to or may be used by an INFOBEAN (data consumer) via the addRawDataItem( ) method. (Please refer to Table III above. The second line of code shows that the source object is added to the TableInfoClass.)

The INFOBEAN 2820 requests the data item for the raw object 2835 (which was the source object 2830) from its InfoModel or the BaseInfoModel. The BaseInfoModel as discussed above is responsible for creating and caching every data item (wrapping any object). Each InfoModel is considered to contain a subset of data items from the entire set of data. The InfoModel is a view of the BaseInfoModel, thus, there may be data items in the BaseInfoModel that are not present in the InfoModel used by the INFOBEAN. The circles 2828 shown in the InfoModel 2805 represent attributes, domains, relationships, etc. from the BaseInfoModel. For example, FIG. 6 contains a list of information that an INFOBEAN may obtain about the Person object, in this case 2830, 2835, through the LeifDataItem API. In addition information from nested InfoModels are inherited. An InfoModel 2805 also always adds new items to the BaseInfoModel, e.g., common attributes such as “selection” are delegated. These new items are also exposed to the INFOBEAN as shown by the number of circles in 2840.

The BaseInfoModel 2810 returns the raw data object 2845 to the InfoModel. The InfoModel 2805 returns a data item 2840, which exposes the information, for example, shown in FIGS. 4 and 5 to the INFOBEAN 2820. A data item 2845 (see FIG. 4) is returned, which may have been created or may have already existed in the InfoModel.

In the XIS framework, as shown in the InfoModel, attribute and method “requests” mechanisms are available. Standard mechanism to retrieve the current value of any Attribute, or set the current value, if the Attribute is mutable, may also be easily implemented. In one embodiment, this mechanism also enables a standard syntax and mechanism for the invocation of any domain method.

These attribute and method “request” objects contain all of the information necessary for the data source to fulfill the requested task. It contains the actual (“raw”) data item whose attribute value is being sought or set (along with the desired new value), or whose domain method is being invoked. They also contain contextual information, such as the current User, allowing data source developers to implement full user-based information access and security controls, and a context for obtaining services (implemented through the Java “BeanContext” APIs). This is significant because it enables the process of executing methods and/or getting or setting values to leverage services “in context” such as the current data view (or window) through which to interact with the user. These request objects also contain contextual “data item” (e.g., LeifDataItem), as opposed to the “raw” non-contextual data item, from which to get additional or overridden values or execute additional/overridden methods, if appropriate to the task. In another embodiment, these “Request” objects are not only passed when getting/setting values, or executing domain methods, but are also passed to all other “Translator” methods that take and may need to access or manipulate the data item. The “Request” object not only provides context, but also ensures that the DSI (via the Translator) always has what it needs (particularly, the User information) to manage its security constraints, if any.

A data item locking mechanism for obtaining, holding, and releasing a lock on an individual data item may be implemented in accordance with the present invention. This implementation is best defined by the data source provider, by implementing such locking mechanism in the data source, itself. Ad hoc implementations for data sources that do not provide native locking may also be done via the DSIs. This mechanism enables DSIs to implement multiple changes atomically (as one transaction) by effecting those changes at the time of the release. In addition, a “rollback” feature for atomic changes is possible through the “revert” capability, which generally releases the lock without affecting the previous changes. This locking mechanism may also be leveraged to lock multiple objects simultaneously, at the discretion of the DSI, by associating the lock with a DSI-defined “lock object” which can either be associated with a single data item or with a group of data items, as appropriate. Using the DSI API, this provides to data consumers a single API for dealing with locking implementations.

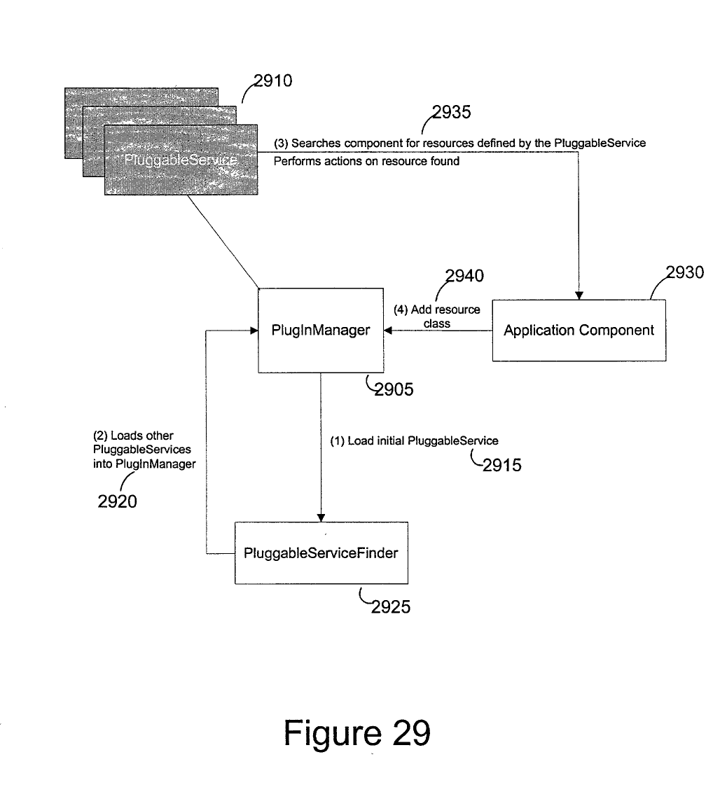

FIG. 29 shows an embodiment of a “plug-in manager” called PlugInManager of the present invention. The programming framework embodied in this invention includes a “plug-in manager” which provides extensible communication between services and components within an application. Plug-ins are software modules that add a specific feature or service to a larger system (i.e., plug into a larger application to provide functionality). For example, there are a number of plug-ins for the NETSCAPE NAVIGATOR browser that enables the browser to display different types of audio or video messages, e.g., SHOCKWAVE by MACROMEDIA.

A “service” is capable of obtaining information on a data consumer or data source component and capable of using that information to provide specific facilities to the application as a whole. Examples of such facilities include addition of entries to a top level application menu, loading MIME types into the global MIME type map, and running of scripts upon loading or unloading of data sources or consumers. The plug in manager loads new services at initialization and also at any time through an explicit request. The service in turn queries all modules present in the application as to whether they request any actions of the given service, executing them if so indicated.

In more detail, as each new module, object, or component is loaded into the XIS framework, the PlugInManager 2905 on startup loads a special service called PluggableServiceFinder 2925, which searches for other services 2915 and loads the services found into the PlugInManager 2920. The PlugInManager holds or keeps track of all services. These services are referred to as PluggableServices. As each pluggable service is loaded, the PlugInManager searches such service for defined resources and attaches these resources to the appropriate components or performs actions on resources found 2935. For example, a menu manager service might search for resources specifying menu entries and associated operations. A component that wants to add a menu entry to the global application menu bar would simply provide a resource of this type. In essence, as each new module is loaded, the PlugInManager tells the currently registered services (“PluggableServices”) to look for new plug-ins. Thus, in essence the PlugInManager acts as a plug-in for plug-in handlers.

The combination of the PluglnManager and the PluggableService interface allows communication between an XIS application and various XIS components. The components may contain a number of resources that affect certain areas of XIS. For example, they may have a resource file that contains an ECMA script. ECMA is an international industry association dedicated to the standardization of information and communication systems (see www.ecma.ch). If there is a PluggableService that knows about that resource file, then it may decide to run the ECMA script when it finds the resource. The PlugInManager is responsible for managing the resource list and all PluggableServices. When a new PluggableService is added, it is given all the resources to determine if it is interested in any of the resources on the list. If it is interested in a resource, then it may perform some action.

In one embodiment of the invention, an ASCII file is created to indicate that a JAR file contains a resource to be provided to all PluggableServices.

Table IX below shows an exemplary ASCII file that indicates that there are resources associated with the module containing the TableView class. It does not indicate what resources exist; it is up to the PluggableServices to determine if there is a resource in which they are interested. The PlugInManager, using Class.forName( ), creates the TableView.class and calls the loadPlugln method on each of the PluggableServices. Below is the content of the loadPlugln method in the MimeTypesPluggableService:

TABLE IX
public static final String RESOURCE_NAME =
“leifResources/mime.types”;
public void loadPlugln(Class relativeClass) {

if (loadedResources == null) {

synchronized (this) {

if (loadedResources == null) {

loadedResources = new HashSet();

}

}

}
try {

String resource = PlugInManager.convertResourceName(

relativeClass, RESOURCE_NAME);

ClassLoader loader = relativeClass.getClassLoader();
Enumeration enum = loader.getResources(resource)
while (enum.hasMoreElements()) {

URL resourceURL = (URL)enum.nextElement();
if (resourceURL ! = null) {

if (!loadedResources.contains(resourceURL)) {

loadedResources.add(resourceURL);

LeifJAFUtilities.addMimeTypes(
baseInfoModel.getOwnedBeanContextChild(),
resourceURL);
}

}

}
} catch (IOException e) {

e.printStackTrace();

}

}

The entire arrangement of data sources separated from consumers by a mediating structure, InfoModels providing context to Views, and a ViewHost and plug in manager playing set central organizing roles, allows a multi-purpose application to be rapidly assembled out of preexisting components. Each available data source and consumer component may be integrated into the application by the plug in manager, and compartmentalization.

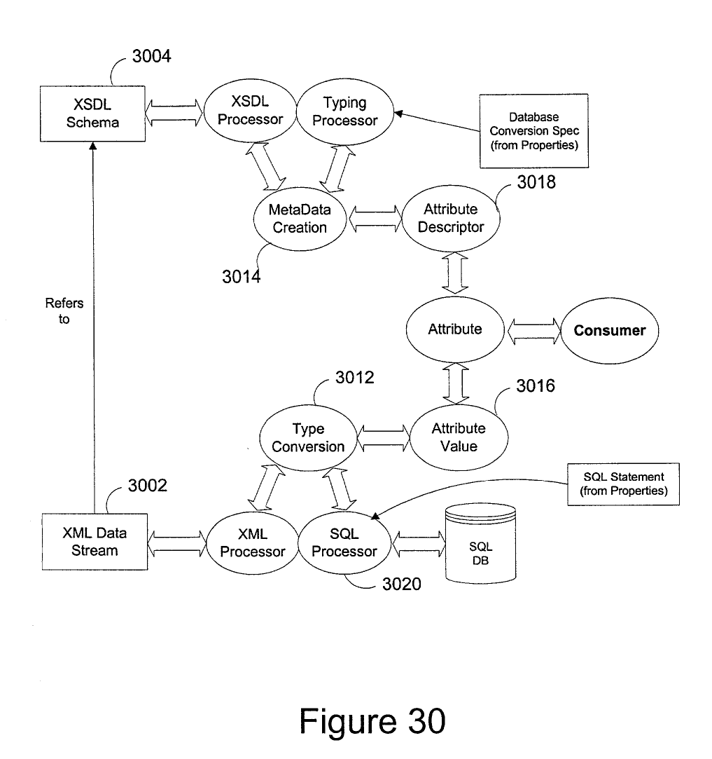

FIG. 30 shows a flow diagram of an embodiment of the invention that assists in creating XML (extensible markup language) DSIs and database DSIs. The XIS framework provides two sets of facilities for exposing electronically available information that comes from data sources that are partly structured and/or self-describing, and for writing back possibly modified information to the sources. For example, one of these works for XML formatted data, and the other works for data stored in relational databases. However, the mechanisms are inherently extensible to any other data source that is partly structured and/or self-describing.

The World Wide Web Consortium (W3C), which has standardized most of the XML formats to date, is in the process of defining a new XML format for declaring schemas, called XML Schema. The XML schema addresses the means for defining the structure, content, and semantics of XML documents. The present invention is configured to take into account future versions of the XML schema.

In one embodiment, the present invention includes aspects of the method outlined below that are in common between the XML and relational database interfaces and can be applied in this general capacity to be part of the invention as well. In particular (described further below), an embodiment includes the apparatus involving separate processing of “data” (3002 branch) and “schema” (3004 branch) information, with a type conversion stage 3012 during the former and a metadata creation stage 3014 during the latter, followed by the construction of semantically enriched attributes 3016, 3018 based on the results of both these processes.

In one embodiment, one method involves two apparatus or facilities designed to handle extensible markup language (XML) formatted data. An XML text stream comprises of a set of hierarchically structured “tags” interspersed with text “content”. The names, data types, and ordering of the tags may vary from stream to stream and is specified by a separate document called an “XML schema.” A description of the XML schema is provided in the document “XML Schema Part 1: Structures (Working Draft)”, which may be obtained from the W3C at the WWW address of http://www.w3.org/TR/xmlschema-1, and also in the document “XML Schema Part 2: Datatypes (Working Draft)”, which may be obtained at the WWW address of http://www.w3.org/TR/xmlschema-2. Given an XML data stream, the first apparatus parses the XML schema appropriate for it and constructs metadata specifications appropriate for the contents of each tag. In some cases, these specifications are in the form of computer program segments that can be compiled into executable procedures that can be accessed immediately by a running application; in other cases, they refer directly to already precompiled procedures. The second apparatus parses the data document, matching the tags up with the types and metadata derived from the schema, and exposes the content in the standardized information representation using this metadata. This information includes the generic relational links described above in addition to attributes and metadata.

In particular, the structures defined by an XML schema document determine the hierarchical and type structure allowed in XML instance documents, and this structure is paralleled again in the information elements (with attributes and member elements) constructed on parsing an instance. The following table (Table X) shows the correspondence:

TABLE X

| | Compliant XML | Resulting Information |
|---|---|---|
| XML Schema | Instance | Element |
| simple type outside attribute | element with no | (typed) attribute |
| declaration | subelements | |
| simple type inside attribute | attribute | (typed) attribute |
| declaration | | |
| complex type without | element with | information element |
| descendents | attributes but no | with attributes |
| | subelements | |
| complex type with | element with | information element |
| descendents | subelements | with member elements |

A complexType element, as defined in the W3C XML Schema standard, defines the structure of an information element. Elements contained within the complexType element which are defined as complexTypes themselves, are translated into the member elements of the information element defined by the containing complexType. All other elements and attributes contained within the complexType element, and defining single value types, are translated into attributes of the information element defined by the containing complexType.

The XML ingestion process supports an additional capability that allows for the translation of types defined by an XML Schema, into more semantically rich domain policy based attributes that consumers in the present framework can take advantage of. To do this an embodiment of the present invention includes a process that uses XSLT (XML Stylesheet Language Transformations) to scan an XSDL (XML Schema Definition Language) document, and embed domain specific instructions in a new version of the XSDL document. The embedded instructions direct the XML processing software to create information elements that contain the semantically richer domain attribute representations. In particular, the tags in the table below may be placed by the XSLT within <appinfo> subelements of elements in the XSDL schema document. When the schema parsing apparatus reads the resulting schema, it sets up the XML processor to perform the mappings as shown when reading an instance document. Because of the nature of the handling specified for <appinfo> elements in the XSDL specification (see the W3C Web site at http://www.w3.org/XML/Schema), these will simply be ignored by other XML schema processors that have not been designed to read them. Table XI lists properties that may be used:

TABLE XI

| Property | Description |
|---|---|
| domainfield | A Domain Policy attribute to map instances of this |
| | XML element or attribute to |
| typemetadata | A metadata type to map instances of this XML element or |
| | attribute |
| converter | A type converter for transformation of XML data |
| | values (strings) into typed values such as floating point |
| | numbers or date objects |
| visible | The initial visibility state with which instances of this XML |
| | element or attribute should be exposed within an |
| | information element |
| mutable | Whether or not instances of this XML element or |
| | attribute can be edited after being exposed within an |
| | information element |

Conversely, the system has the ability to construct an XML document and associated XML Schema from a hierarchy of information elements. The process for outputting an XML document and associated XML Schema from a hierarchy of information elements is essentially the reverse of the ingestion process. The resulting schema documents are generated with the special <appinfo> instructions that carry the additional semantic meaning for the attributes, but (see above) these additional instructions are embedded in a way that makes them transparent to other XML document readers that do not recognize them. In this way, an application-to-application information communication session can be set up using HTTP or a similar protocol for synchronous communications, and SMTP or similar for asynchronous communications. The sending application encodes information elements into an XML schema/instance pair using the just described apparatus and sends both to the receiver application. The receiver reconstructs the information elements also using the above apparatus. Thus, any form of structured, annotated information that can be expressed within our framework can be transmitted between applications using a simple document transfer protocol. Another embodiment of the present invention involves an apparatus 3020, which will connect to a relational database system and extract or write information from it using the structured query language (SQL). The user of such an information source needs only to specify the tables and columns to access within the database, as well as any selection criteria to narrow the range of data returned. The apparatus performing this function will automatically convert the data in the database into the appropriate representational format and add metadata and parent-child links as required. In general, the process is similar to that described for the XML data input/output capability, except that SQL statements and conversion mappings specified by the user take the place of the XML schema and document type and hierarchy information.

The process translates the result of a database query into an XIS data item, and each row in the result set is translated into a member data item of the result data item. Each row data item can also have a database query associated with it which can be executed to provide its own member data item. Access to the member items is on-demand (e.g., as called for by a consumer), an operation we refer to as “drill-down”.

The row data items are created with attributes that are derived from the columns returned by the result set. The attribute specifications can be generated automatically from the result set column SQL type specifications (integer, date, text, etc.), or can be customized to suit the needs of the user. The customization process allows the user to map database result column type definitions into more semantically rich domain policy and/or metadata-enhanced attributes that consumers can take advantage of. In other words, the DSI can associate column data types with metadata types and domain policy attribute types. To do this the framework supports a number of attribute customization properties that the user can specify (described further below).

Modifications to row data items are handled by allowing the user to associate parameterized update, insert and delete queries with a given result set. When the value of a record member attribute is changed, the user specified parameterized query is executed, and the parameters are filled in from the attribute values identified in the query specification. Insertion and deletion of record members are handled in a likewise manner.

The following table, Table XII, describes the list of customizable properties supported by the SQL database interface process. These properties are used to describe a single interface to a database for producing one or more hierarchically organized information elements from its contents.

TABLE XII

| Property | Description |
|---|---|
| jdbc.driver | JDBC vendor driver class name |
| jdbc.url | JDBC database connection URL |
| display.name | Default display name for result data item |
| select.query | SQL select statement for result data item |
| update.query | Parameterized SQL update statement |
| update.columns | Result column names that fill update query |
| | parameters |
| insert.query | Parameterized SQL insert statement |
| insert.columns | Result column names that fill insert query |
| | parameters |
| delete.query | Parameterized SQL delete statement |
| delete.columns | Result colunm names that fill delete query |
| | parameters |
| drilldown.query | Parameterized SQL select statement for record drill- |
| | down |
| drilldown.columns | Result column names that fill drill-down query |
| | parameters |
| result.attributes | Result data item attribute names |
| record.attributes | Record data item attribute names |

The names of attributes listed for both result and record data items are used to uniquely identify the attributes. The customization of each attribute is done according to its unique name. The following table (Table XIII) describes the list of customizable properties that can be applied to each attribute, where <name> is the unique attribute name. Note the parallel between these properties and those given for the ‘<appinfo>’ tag insertion in the case above of XML data parsing.

TABLE XIII

| Property | Description |
|---|---|
| <name>.label | The attribute display label |
| <name>.domainfield | A XIS Domain Policy class field to |
| | map this attribute to |
| <name>.typemetadata | A XIS metadata class name to map |
| | this attribute to |
| <name>.converter | A XIS type converter for transformation of result |
| | values |
| <name>.columns | The result columns names that will be converted |
| <name>.visible | The attribute initial visibility state |
| <name>.mutable | The editability of the attribute |

Given the metadata from known industry standard APIs (e.g., JDBC and ODBC) that provide metadata for results (typically handled as tabular columns) including string, length, numeric precision, date formatting, etc, relational databases may have dynamic DSI toolkit built and implemented as shown in FIG. 27. Tabular data may also be interpreted as a default string typed. Java objects, remote Java objects (via RMI or CORBA-derived interfaces), and Enterprise JavaBeans (a variant of RMI objects) may have DSIs automatically created for them, using, for example, reflection and known types (primitives and other typical types like String, Data, etc., and registered types). A developer may also place XIS-specific annotations (e.g., static AttributeDescriptor and FieldData methods) on reflected Java objects. Collection subclassed objects may also indicate containment.

Dynamic data supplemental metadata may also be used in the XIS framework of the present invention. Schemas with little or no expressive information may also be used to specify additional metadata within the XIS framework, which include mapping attributes to type metadata, mapping attributes or methods to domains, defining new attributes/methods based on existing data from the source, defining functions/user commands for easily implemented capabilities (e.g., deleting a data item, adding/inserting a new data item, initializing a template data item that a user can fill in before adding, etc.), and defining relationships to other data items to perform “drill-down” queries. Such type of schemas may be obtained, for example for Java Metadata API, CORBA API (on which the Java API was based), Oracle “common warehouse metamodel,” and the like. Other formats for mapping metadata to schemas from other sources, or as might be defined in the future, may easily be incorporated within the framework.

Distributed Application Capabilities

In an embodiment, the application development framework being discussed offers three sets of facilities to aid in the development of distributed applications in which users, software application components, or both are distributed across multiple computers connected by a network.

CORBA Exposure

The first set of facilities allows the automatic exposure of a data source over a network to any remote consumer software object via the Common Object Request Broker Architecture (CORBA) protocol. This protocol allows the remote consumer to utilize information elements just as if they existed locally, but usually with lower bandwidth than it would take to send the entire elements over the network connection.

To better understand the invention, examples are shown below in Table XIV, which shows an exemplary XML document.

TABLE XIV

<tracks>

<track name=”FIRST”>
<country>US</country>
<category>SUB</category>
<threat>HOS</threat>
<position>

<lat>10.0</lat>
<lon>10.0</lon>
<alt>10.0</alt>

</position>

</track>
<track name=”SECOND”>

<country>US</country>
<category>AIR</category>
<threat>FRI</threat>
<position>

<lat>20.0</lat>
<lon>20.0</lon>
<alt>20.0</alt>

</position>

</track>

</tracks>

The following table (Table XV) shows the result if the above XML document were run through an XML DSI.

TABLE XV

LEIF Data Item - tracks
LEIF Data Item - track
Attribute - name : String value=’FIRST’
Attribute - country : String value=’US’
Attribute - category : String value=’SUB’
Attribute - threat : String value=’HOS’
LEIF Data Item - position: LEIF Data Item
Attribute - lat : String value=’10.0’
Attribute - lon : String value=’10.0’
Attribute - alt : String value=’10.0’
LEIF Data Item - track
Attribute - name : String value=’SECOND’
Attribute - country : String value=’US’
Attribute - category : String value=’AIR’
Attribute - threat : String value=’FRI’
LEIF Data Item - position
Attribute - lat : String value=’20.0’
Attribute - lon : String value=’20.0’
Attribute - alt : String value=’20.0’

Table XVI below shows an exemplary XSDL document.

TABLE XVI
<?xml version=“1.0” encoding=“UTF-8”?>
<schema xmlns=“http://www.w3.org/1999/XMLSchema”>

<element name=“tracks”>

<complexType>

<element name=“track” type=“Track” maxOccurs=“unbounded”/>

</complexType>

</element>
<complexType name=“Track”>

<attribute name=“name” type=“string”/>
<element name=“country” type=“string”/>
<element name=“category” type=“string”/>
<element name “threat” type=“string”/>
<element name=“position” type=“LatLonAlt”/>

</complexType>
<complexType name=“LatLonAlt”>

<element name=“lat” type=“decimal”/>
<element name=“lon” type=“decimal”/>
<element name=“alt” type=“decimal”/>

</complexType>

</schema>

XML Schema Definition Language (.xsd) documents are used to express the semantic descriptions of Attributes and the Domains in which they live. Code generation utilities as described above create the actual Domain Objects with their groups of related Attributes. Thus, developers may create new Domains, and add Attributes to their existing Domains, by modifying these XML Schema files and generating the appropriate Java code. XML Schema files include basic attribute constraints (e.g., value ranges, list of valid values, attribute naming, formatting, etc.) that are turned into TypeMetaData objects, as well as textual comments that are converted into Java documentation to define the intent of the attribute (or method, in the case of Domain methods). In some cases, Java code is embedded in the document and used inline in the generated Java classes for the Domain.

Table XVII below shows the result when the above XSDL document is used to type the elements in the XML document source. Note that the type for lat, lon, and alt are now Double instead of String.

TABLE XVII

LEIF Data Item - tracks
LEIF Data Item - track
Attribute - name : String value=’FIRST’
Attribute - country : String value=’US’
Attribute - category : String value=’SUB’
Attribute - threat: String value=’HOS’
LEIF Data Item - position
Attribute - lat : Double value=’10.0’
Attribute - lon : Double value=’10.0’
Attribute - alt : Double value=’10.0’
LEIF Data Item - track
Attribute - name : String value=’SECOND’
Attribute - country : String value=’US’
Attribute - category : String value=’AIR’
Attribute - threat : String value=’FM’
LEIF Data Item - position
Attribute - lat : Double value=’20.0’
Attribute - lon : Double value=’20.0’
Attribute - alt : Double value=’20.0’

The following table (Table XVIII) shows an exemplary XSLT document.

TABLE XVIII
<xsl:for-each select=”xsd:element”>

<xsl:choose>

<xsl:when test=”@name=′position″′>

<xsl:copy>

<xsl:apply-templates select=”@*”/>
<annotation>

<appinfo>

<domainmap

domainfield=”com.xis.domains.geo.GeoDomain.latLonAlt”
converter=”DegreesToLatLonAltConverter”
parameters=”lat,lon,alt”
label=”Position”

/>

</appinfo>

/annotation>

</xsl:copy>

</xsl:when>
<xsl:otherwise>

<xsl:copy>

<xsl:apply-templates select=”@*”/>

</xsl:copy>

</xsl:otherwise>

</xsl:choose>

</xsl:for-each>

When such a transformation is used with the previous XSDL source shown above, used to type the XML document source, the result is shown in Table XIX below.

TABLE XIX

LEIF Data Item - tracks
LEIF Data Item - track
Attribute - name : String value=’FIRST’
Attribute - country : String value=’US’
Attribute - category : String value=’SUB’
Attribute - threat : String value=’HOS’
Attribute - position : LatLonAlt <− now mapped to
GeoDomain.latLonAlt
LEIF Data Item - track
Attribute - name : attribute value=’SECOND’
Attribute - country : String value=’US’
Attribute - category : String value=’AIR’
Attribute - threat : String value=’FRI’
Attribute - position : LatLonAlt <− now mapped to
GeoDomain.latLonAlt

Note that position has been mapped to GeoDomain.latLonAlt, meaning, it is now a LatLonAlt type. The lat, lon, and alt attributes are still the same, but the position itself may now be dealt as a single LatLonAlt object rather than a generic data item with three Double fields. The use of XSLT also enables the mapping of XML elements into TypeMetaData, such as the LatLonAltTypeMetaData in order have better manipulation of the data.

In one embodiment of the invention, the XIS framework has a “remote” capability enabling referral to an XIS session, or the data within it, from a remote virtual machine. Primarily, this means that data retrieval and sharing is the basis for export and collaboration. Secondarily, it supports operating on data within XIS from a remote virtual machine, perhaps on information existing only at that remote virtual machine.

In another embodiment, SOAP (Simple Object Access Protocol) may be utilized. SOAP is a messaging framework that defines a protocol for the exchange of information in a decentralized, distributed environment. See, for example, the W3C Web site at http://www.w3.org/TR/SOAP. SOAP provides an instantiation of the remote capability, and is used to enable a general-purpose means of mating together or communicating among distributed sessions. These sessions may be two full XIS sessions on separate servers, or may comprise one XIS server and one XIS client, or may be used to interface XIS to otherwise very different software, even including software applications written in different programming languages and running on incompatible operating systems. All data and remote procedure calls are made through XML. Those skilled in the art will be understand that SOAP is an XML-based protocol. The working draft of this specification is currently being developed by the W3C.

In another embodiment, remote references are used. These references are persistable or persistent references to XIS data. In a distributed context XIS uses XML representations of the references to share, persist, or identify particular data. Embedded in the XML are custom information enabling determination of data location in files or databases, on web servers, or based on unique Ids or names within the XIS session, or based on data which are passed to a constructor, or on an ECMA script that can re-generate the data object.

In another embodiment, the data representation in the remote distributed sessions is all based on the XIS mediation layer. All data, regardless of the initial type, is passed and manipulated as sets of attributes and relationships. This greatly enhances portability and interoperability of the data. At the same time the data contains a global unique identifier, so the individual and specific source and identity of that data is maintained in spite of having been translated to a mediated format.

In another embodiment, a metadata type, e.g., “Constructor Scripts,” is used. This metadata type supports the generation of ECMA Script scripts to restore a TypeMetaData (metadata type) object at a later time. By executing the script, the TypeMetaData is restored to its exact state. The advantage over standard Java object serialization is control over the save/restore process, and the ability to represent the state in fairly readable text format.

Distributed Multi-user Collaboration

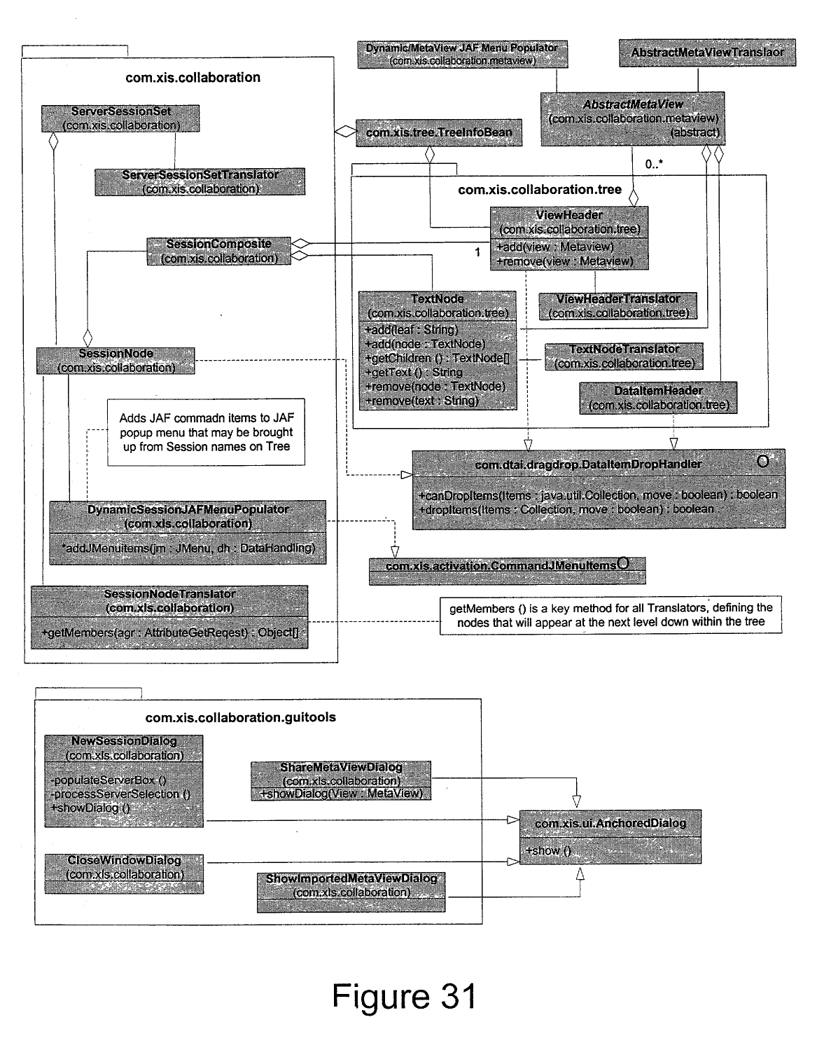

FIG. 31 is a schematic diagram of the second set of facilities that allows users at remote computers to collaborate through shared views of the same data. It also shows objects and methods that may be involved in distributed collaboration facilities. Visual consumer components (e.g., INFOBEANs) are condensed and compressed so that they may be efficiently accessed by a remote computer and then locally displayed. This is done using a Meta View object, which encapsulates the essential elements of a visual component to allow reconstruction on another screen with minimum requirement for data transmission. Meta Views are manipulated using the relationship handling machinery of the framework as discussed above; in particular, an indirect reference to the Meta View is produced and passed around to remote consumers, who need only resolve the reference and retrieve the Meta View object if the user requests the display.

An event-handling schema is introduced for transmission of changes in the view from one computer to all others that are joined to the session. View management is accomplished via a “tree” display showing hierarchies of local views, sessions, and shared views (including properties and subsidiary data items). Views may be shared through the intuitive action of dragging and dropping them from one branch on the tree to another. Multicast protocols may be used so that Meta Views, LeifReferences (references), and Event objects may be transmitted directly from one computer to another without the need to go through a server. Alternatively, HTTP protocols may be employed if security and firewall considerations make multicasting impractical.

Metadata Server Facilities

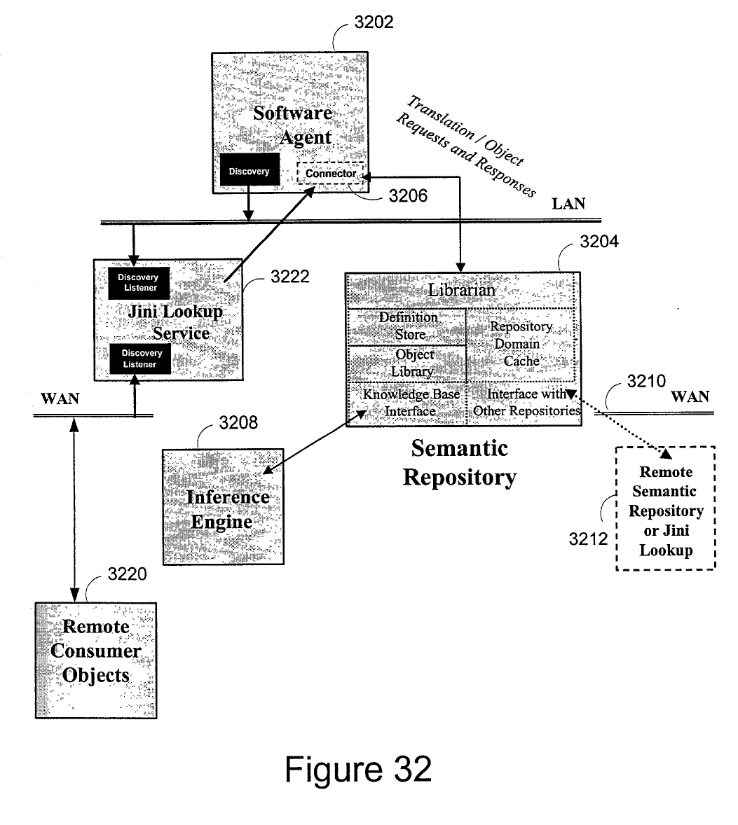

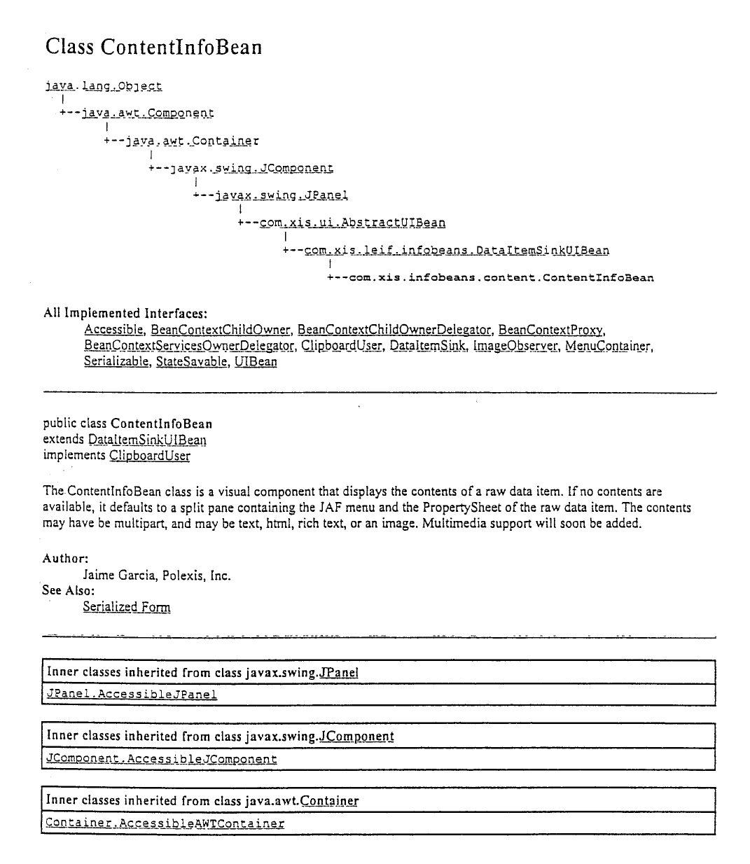

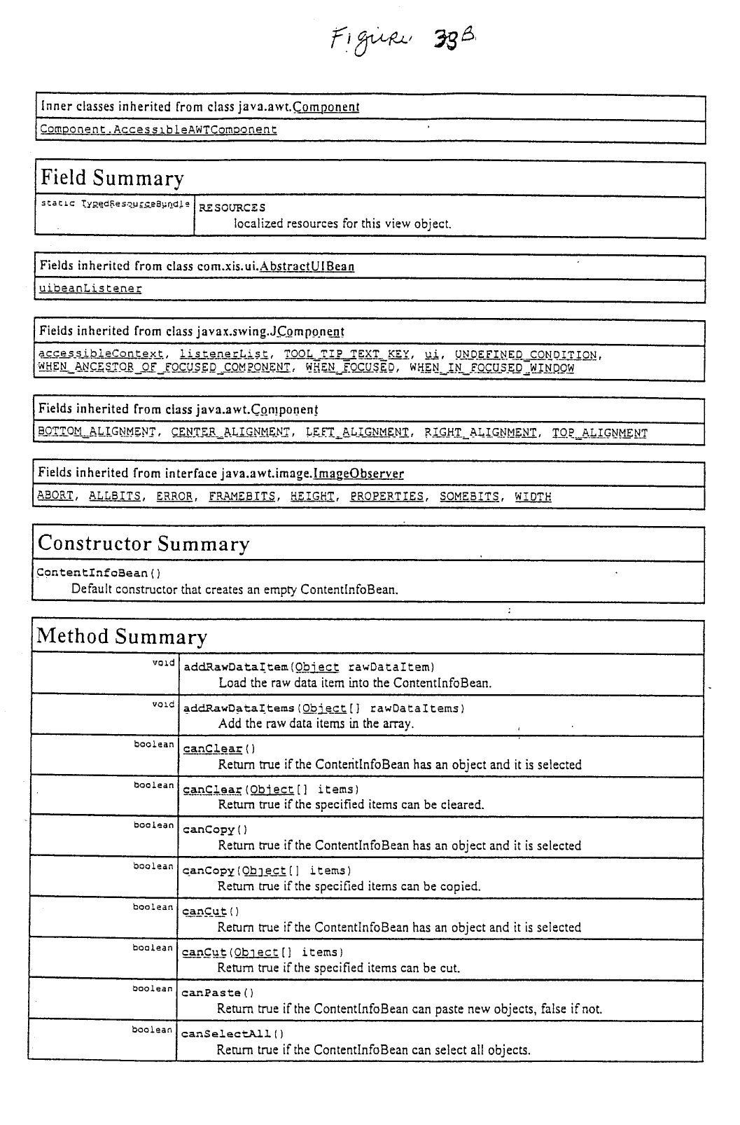

FIG. 32 shows a third set of facilities that allows remote consumer software objects 3220 to obtain additional annotations on information that is encountered along with at least a minimal self-description component, as may be found, e.g., in an XML tag name. These facilities are targeted to be useful to software agents 3202 in particular. (See Wooldridge, M., Jennings, N. (1995); “Intelligent Agents: Theory and Practice” in Knowledge Engineering Review 10:2.) For example, a Java software agent may occasionally encounter data objects or request terms, which were not anticipated when the agent was programmed. The tag name or other descriptive annotation (connector) 3206 is used as a key to request metadata and possibly domain policy methods defined within XIS from a known server, called a semantic repository 3204. The server 3204 checks its index for a match; if a match is not found, it can optionally ask a predicate logic inference engine 3208 to provide alternate names to search under (e.g., “cat, large, ferocious” is returned from the inference engine in response to a request for “lion”), which are then also compared to the index. If a match is found, the server returns the appropriate metadata and possibly domain policy method(s) to the requesting agent 3202, making use of either Sun's Jini framework or Java's built-in provisions 3222 for network transfer and subsequent dynamic loading of classes (including, e.g., procedural components of the metadata and methods) to transfer the actual code procedures into the running agent. These transferred information can then be used by the agent 3202 to aid in handling the object. For example, an agent can display an unanticipated data type to a user by calling the renderer method thus returned from the semantic repository. The semantic repository may also interface with other repositories 3212 via a data network 3210, such as a wide area network (WAN) 3210.

In the above embodiment, information metadata and even information access software may be dynamically downloaded from remote sources (“semantic repositories” or “Metadata Server Facilities”), e.g., from the data source itself or from an intermediary server. This is a unique feature particularly as applied to XIS metadata, domain policies, and DSIs.

One skilled in the art will further understand that the common representation of and access to information from internal APIs (mediation layer) may be exported to distributed application in support of middleware architectures for scalability or other advantages, and in support of collaboration by sharing data and data changes (permanent or transient) with other distributed collaborators.

The present invention also supports user “transfer” of objects from one context (e.g., between two INFOBEANs) via drag/drop, cut/paste, and other mechanisms. Transfers of objects apply only to non-contextual information. Thus, each view has its own InfoModel that provides the contextual information for that view alone. Example 5 below further explains this idea.

Example 5

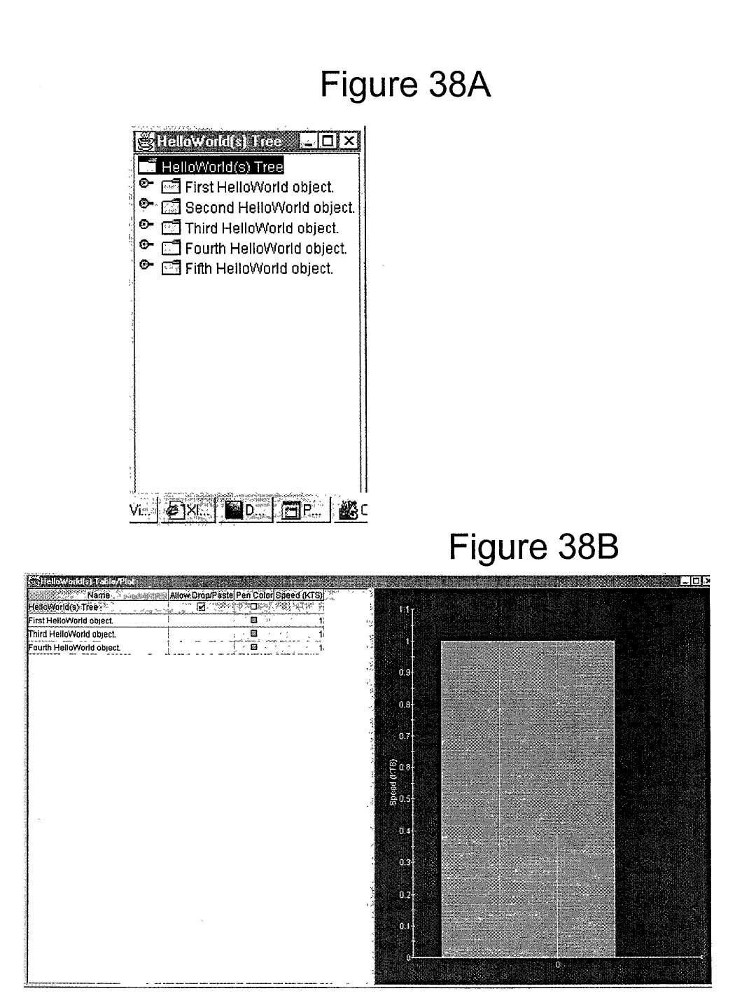

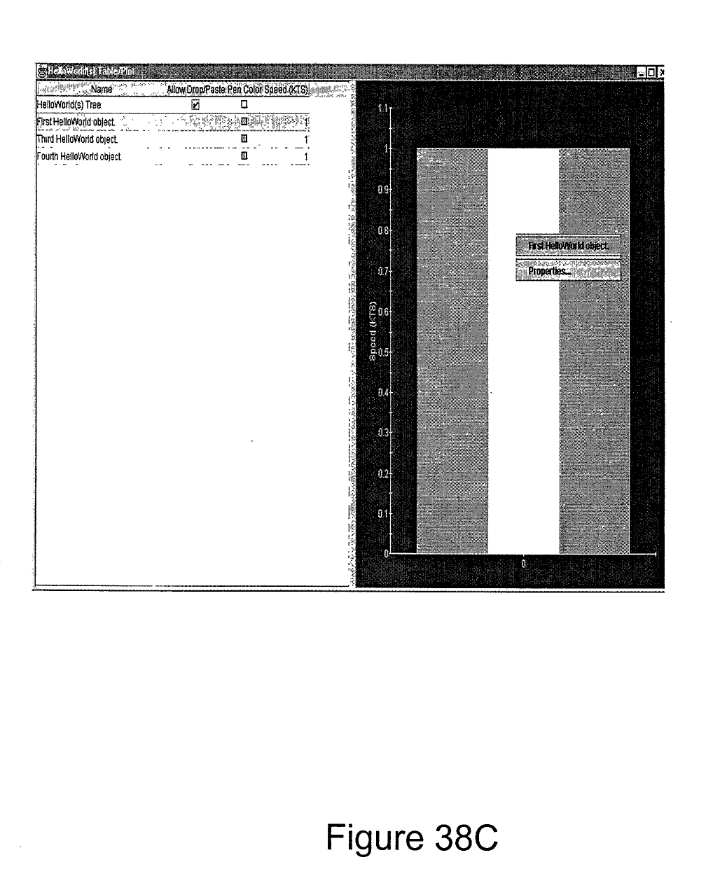

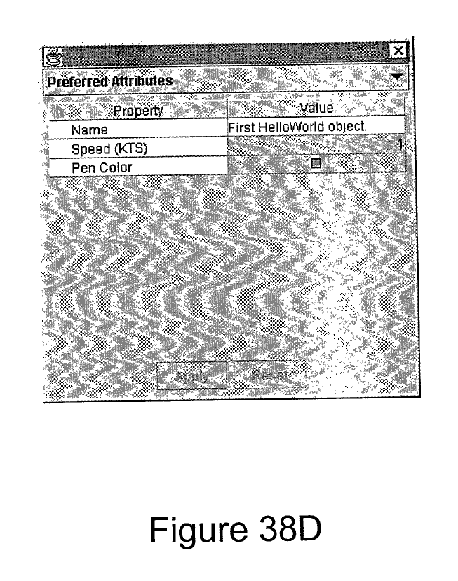

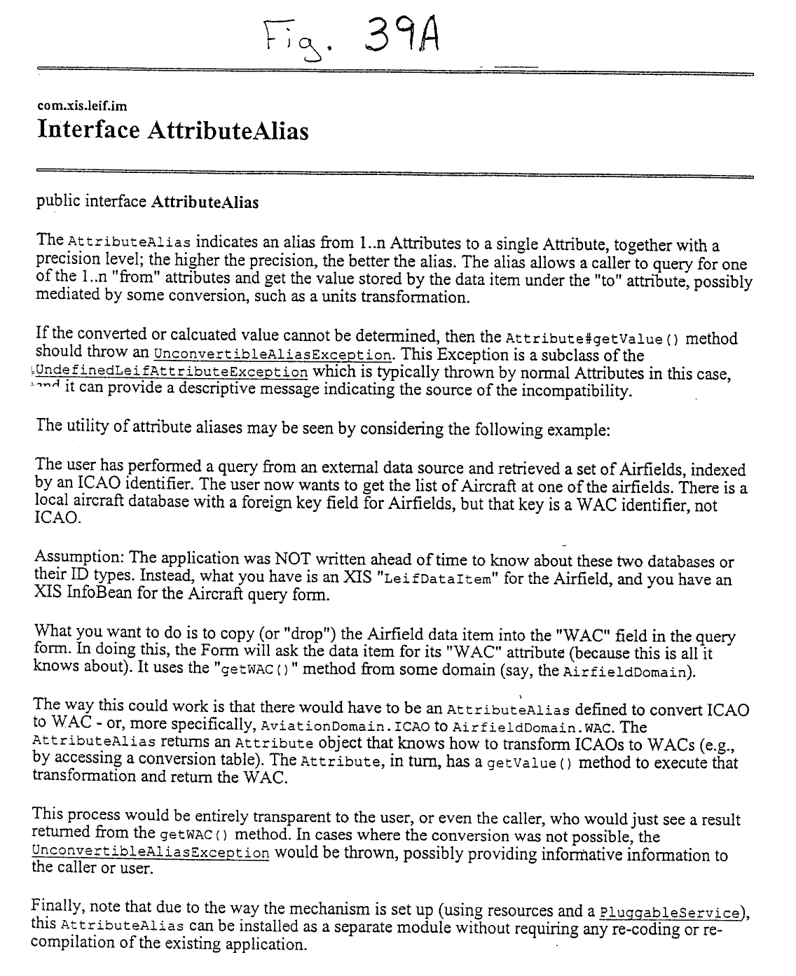

The Example 5 application is contained in three Java source files, HelloWorld.java, HelloWorldTranslator.java, and TestHarness.java. The source files for this Example are explained below. The resulting outputs are shown in FIGS. 38A and 38B. Non-contextual information is transferred in this Example.

The Java source files in Example 5 modify those from Example 3 or 4 to demonstrate the use of drag and drop facilities within XIS, along with a more complex view. As before, changes from the previous step are marked by open and close commented braces.

The table below (Table XX) shows a code snippet that replaces a portion of code in the Hello World.java file shown in Example 3. The code portion below replaces the portion of code 2102 found in FIG. 21 to implement Example 5.

TABLE XX

```
/*{*/
    private String myName;
    public HelloWorld(String myName) {
        this.myName = myName;
    }
    public String toString() {
        return myName;
    }
/*}*/
```

With the above modification, the Hello World.java file for this Example has been enhanced so that instances can be given names upon creation, and this name is returned by the toString( ) method. Also, the getID( ) method has been removed.

The Hello WorldTranslator.java file for this Example is similar to the HelloWorldTranslator.java file shown in FIGS. 22A to 22C, except that this source file has been simplified from the previous version by removing the “course” attribute.

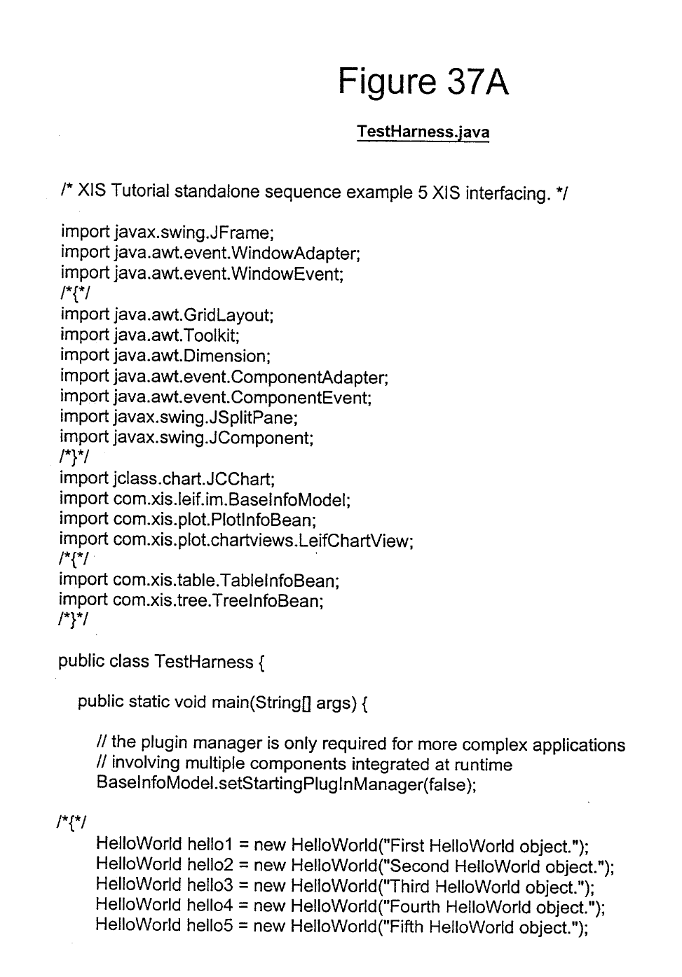

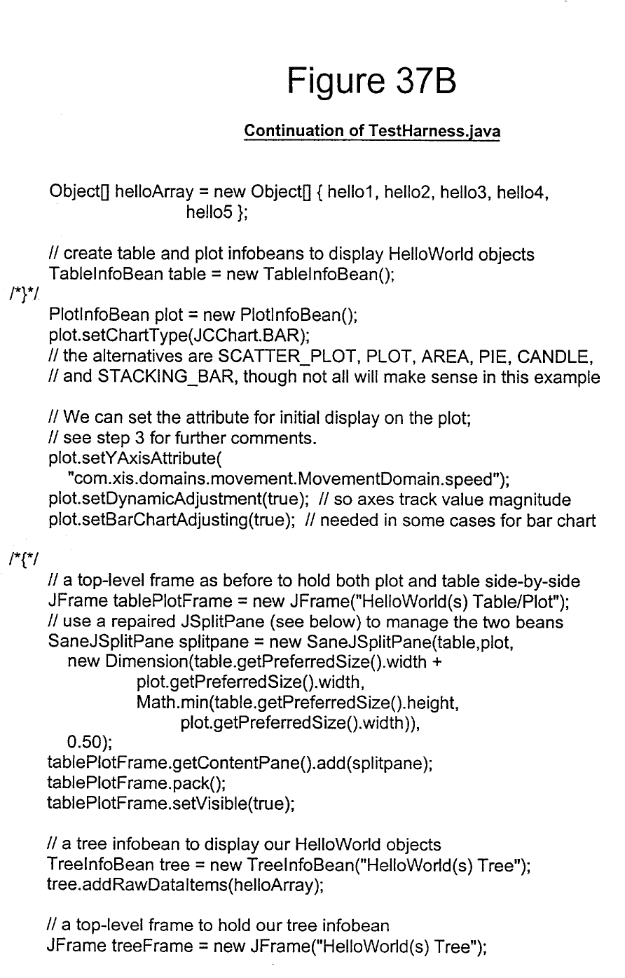

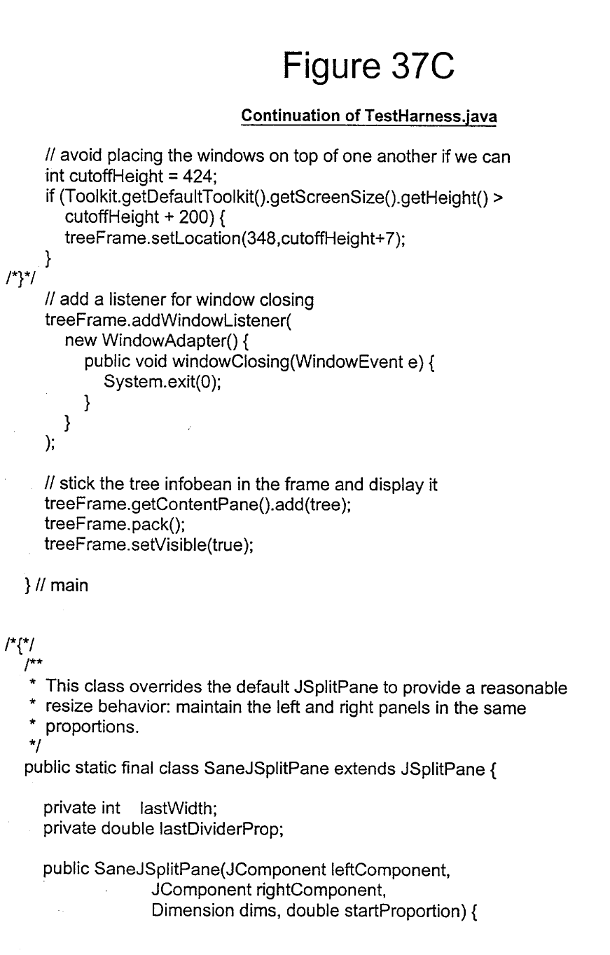

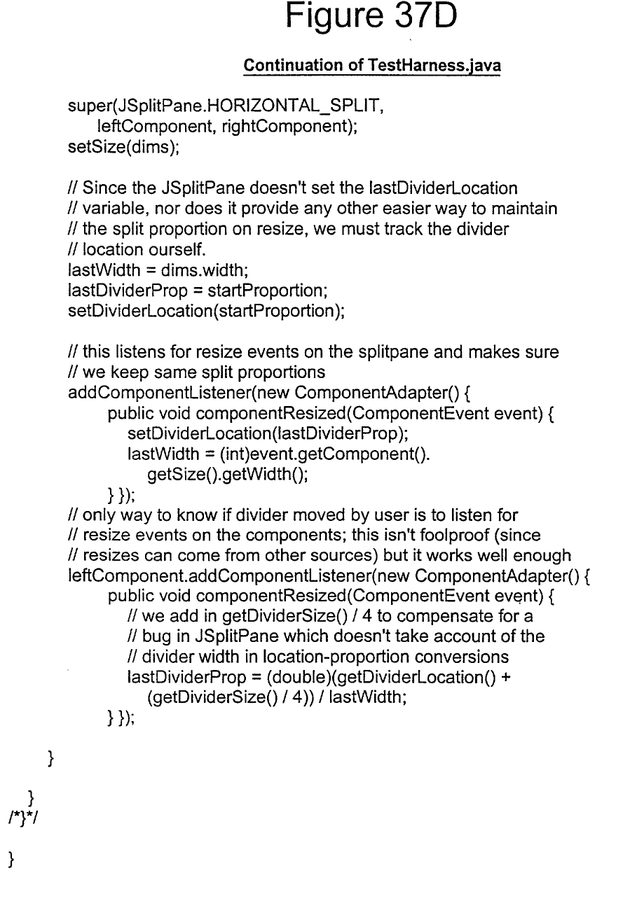

FIGS. 37A to 37D list the TestHarness java source file, where the bulk of the changes are coded. First of all, it contains an import to help lay out multiple components within a Jframe 3702, and also imports for two new XIS INFOBEANs: a Table bean and a Tree bean 3704. The tree bean displays data items and any member data items they contain, and enables users to select and perform various functions on them such as editing their properties. The table bean displays the attributes of multiple data items in a user-configurable way.

The first portion of new code 3706A and 3706B initializes several Hello World objects and inserts them into an array. The table and plot INFOBEANs are initialized and placed side-by-side in a JFrame. They are not loaded with any data items, but items can be dragged onto them when the application is running. The next thing is that a tree INFOBEAN is initialized and loaded with the array, and it is put up in its own JFrame.

This Example 5 application puts up two windows—the first is a Tree INFOBEAN containing several Hello World data items. The second has two frames, on the left a Table INFOBEAN, on the right a Chart INFOBEAN, both of which are initially empty. The table is initially completely blank because it has no information on what headings are appropriate, while the plot displays a default grid.

In the tree display, a user may select data items or open and close them, similar to the directory tree view provided by the “Windows Explorer” application. In this case, the only item that contains anything is the root, which is a special data item. Double-clicking on it opens or closes it, but it cannot itself be selected. Right clicking on an item (but not the root) brings up a menu of operations that may be performed on it. In particular, selecting ‘Properties’ brings up a property sheet window (as in the previous examples) for that particular instance. A user may left-click-and-drag on data items from the property sheet window over to the table or the plot.

The table automatically sets up columns for the preferred attributes of the data items dragged onto it. The layout may be changed interactively by either dragging on the headings or their boundaries, or by right clicking on the headings. Double clicking on the attributes enables a user to edit them. Items may also be dragged from the table onto the plot as well, or in the other direction. The selection and pen color attributes are kept aligned automatically between all views of the same data item. A user exits the application by closing the tree window.

Data item commands, also known as JAF Commands (based on “JavaBeans Activation Framework”) may also be implemented within XIS. The JAF API is a part of Java and provides a way to associate commands with object. By using JAF, developers may take advantage of standard Java interfaces to determine the type of an artitrary piece of data, encapsulate access to it, discover the operations available for it, and to instantiate the appropriate bean to perform said operation(s). For example, if a browser obtained a JPEG image, JAF would enable the browser to identify that the stream of data is a JPEG image, and from that type, the browser could locate and instantiate an object that could manipulate, or view that image. JAF commands are typically used in pop-up menus or menu bars to control objects.

XIS uses JAF commands to control DSIs and perform operation on data items. Right clicking on a data item in an InfoBean pops up a menu with commands that are specific to that data item. JAF commands with XIS may implement the following:

“Context Menus” or pop-up menus initiated by right clicking on a display that represents one (or more) data items;

Command “menus” may be combined into a menu for multiple objects (e.g., one single command (menu item) to delete all selected objects;

Addition of data item commands per object type by adding them to the “JAF” registry;

Addition of file/content MIME types in the display;

Addition to the “JAF” registry of entries that represent objects that can add any number of menu items dynamically;

JAF commands may be added by “Menu Populators” that can add menu items for single and multiple data items;

JAF commands may be added by the environment for other typical functions that might be performed on any object (possibly depending on capabilities/content of that data item), e.g., Copy/Paste/Cut/Delete, Hide/Show, Refers To (if the object exposed relationships to other objects which may or may not be loaded yet), Contains, Referred by, Contained by, URLs (attributes), Properties, etc.; and

Default behavior of “Properties” command may be overridden using a “JAF entry.”

FIGS. 38A, 38B, 38C, and 38D show how JAF is used within the framework. FIG. 38A shows a menu of Hello World objects for selection, displayed on a screen of the computer system implementing the framework. FIG. 38B shows that the Hello World objects are displayed through a graphing (data plot) viewer. FIG. 38C shows the display of FIG. 38B after the display cursor has been positioned over the bar graph, followed by a right-click. A context menu, enabling the user to select the “Properties” option, is displayed in FIG. 38D. In this example, the Hello World object can be manipulated by a PropertySheetInfoBean object. Thus, selecting the “Properties” option results in a PropertySheetInfoBean being instantiated showing the properties of the First Hello World object, as shown in FIG. 38D.

Another feature provided by the XIS framework is the use of attribute aliases. This enables one attribute from one domain to be substituted for an attribute in another domain. For illustration purposes, let us assume that we have two domains called Movement Domain and Physics Domain. The attribute speed in knots is defined in the Movement Domain, while the attribute velocity in meters/sec is defined in the Physics Domain. The XIS framework enables a developer to register or define that the speed attribute in the Movement Domain is similar or compatible with the velocity attribute in the Physics Domain. Thus, enabling a data consumer object to ask for the Attribute from the domain that it knows about, and have the value translated from the Attribute of the DSI from the second domain.

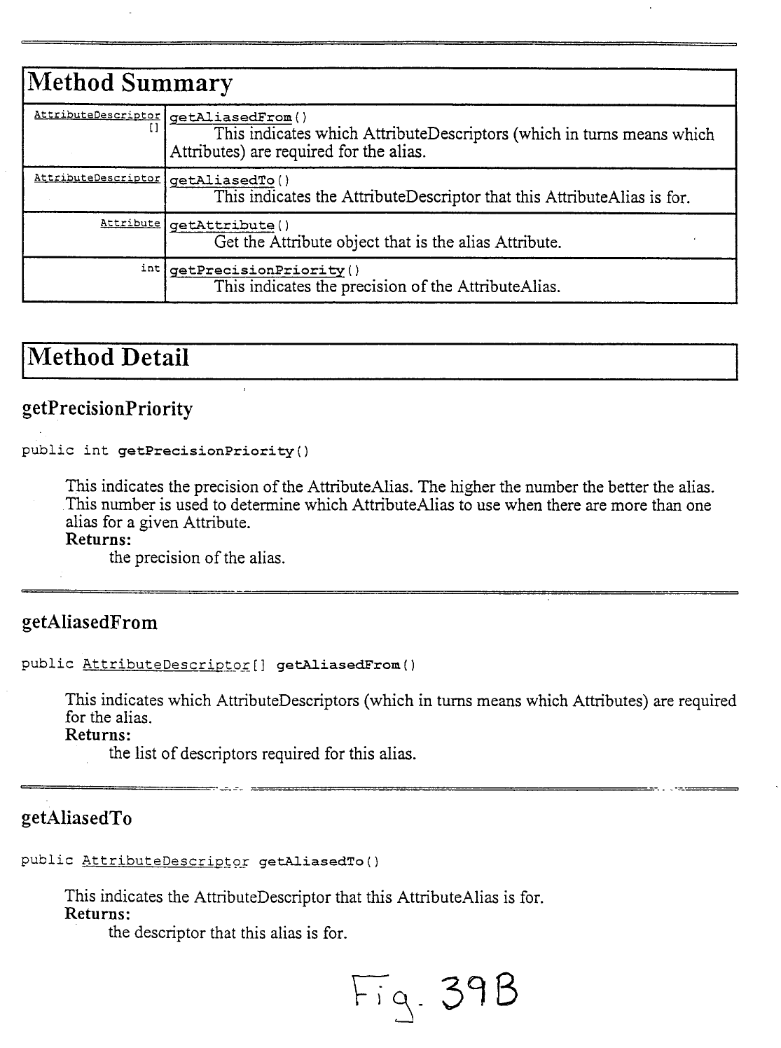

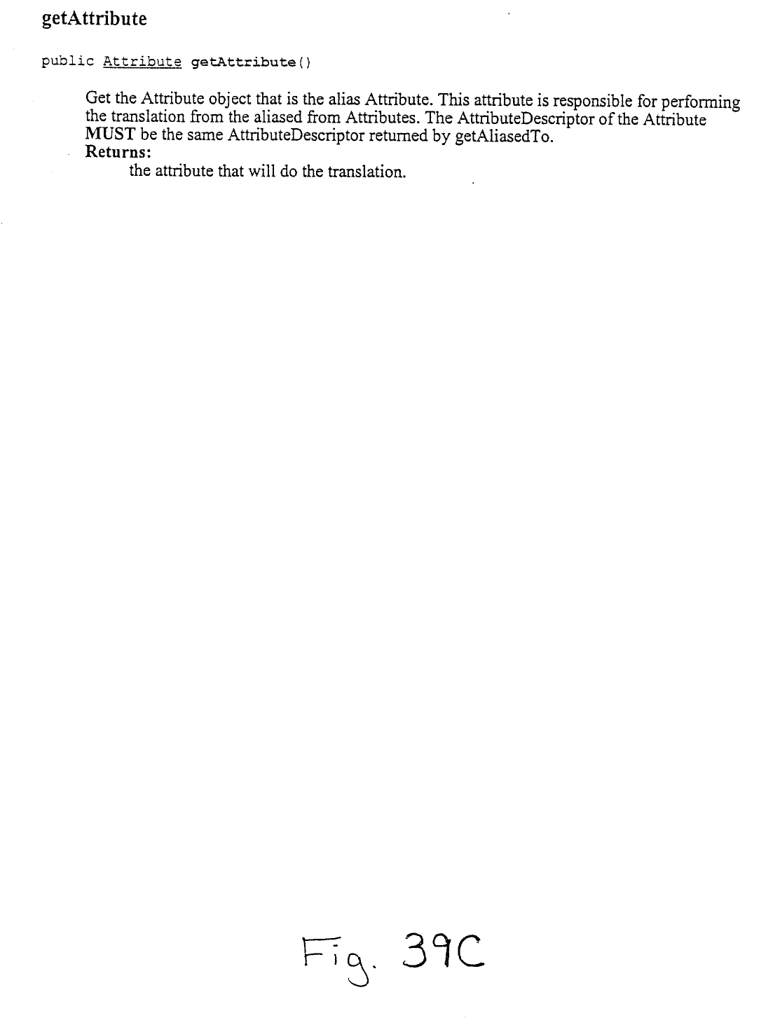

FIG. 39A, 39B, and 39C show details of an exemplary embodiment explaining how an interface for the attribute alias feature described above may be defined or implemented within the XIS framework. The illustration includes class listing for objects that are used in the preferred embodiment of the framework.

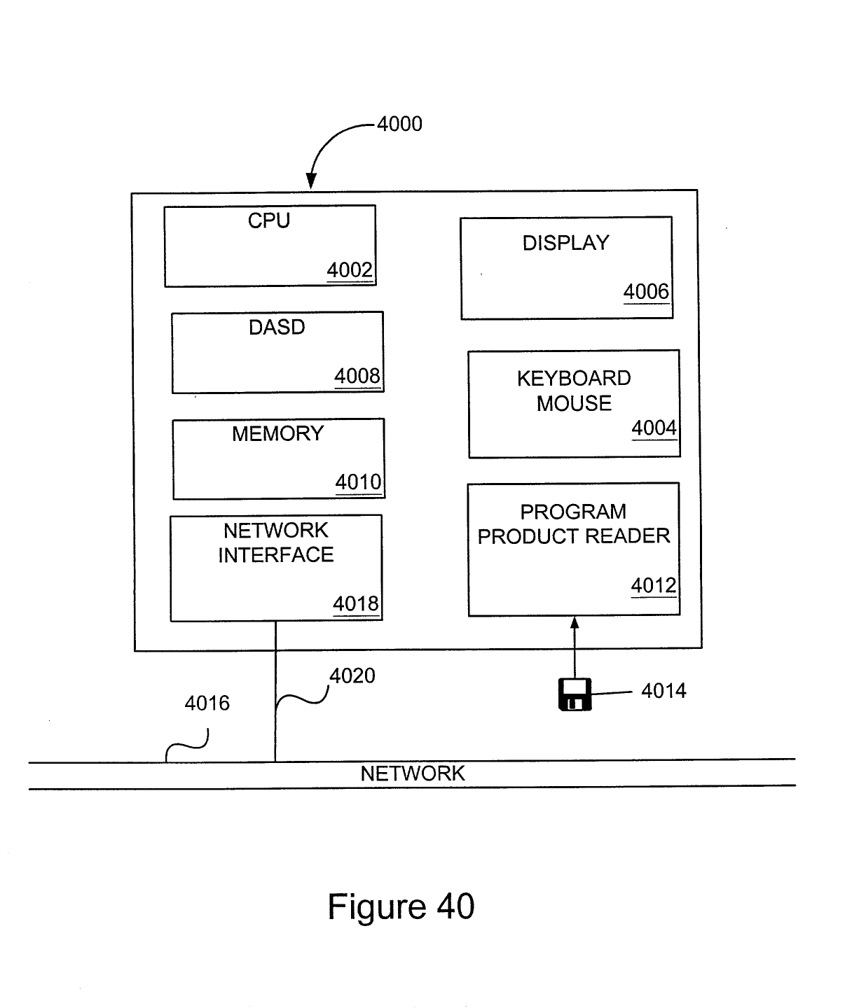

FIG. 40 is a block diagram of a computer that may be used to implement the framework described herein. The framework may be used in a single computer, or may be used in conjunction with one or more computers that may communicate with each other over a network to share data. Those skilled in the art will appreciate that the various data objects, framework extensions, and other processes described above may be implemented with one or more computers, all of which may have a similar computer construction to that illstrated in FIG. 40, or may have alternative constructions consistent with the capabilities described herein.

FIG. 40 shows an exemplary computer 4000 such as might comprise a computer in which an object oriented programming environment is supported to permit the framework operations described above, and to permit the various display operations and computer processing events. Each computer 4000 operates under control of a central processor unit (CPU) 4002, such as a “Pentium” microprocessor and associated integrated circuit chips, available from Intel Corporation of Santa Clara, Calif., USA. A computer user can input commands and data from a keyboard and computer mouse 4004, and can view inputs and computer output at a display 4006. The display is typically a video monitor or flat panel display. The computer 4000 also includes a direct access storage device (DASD) 4008, such as a hard disk drive. The memory 4010 typically comprises volatile semiconductor random access memory (RAM). Each computer preferably includes a program product reader 4012 that accepts a program product storage device 4014, from which the program product reader can read data (and to which it can optionally write data). The program product reader can comprise, for example, a disk drive, and the program product storage device can comprise removable storage media such as a magnetic floppy disk, a CD-R disc, a CD-RW disc, or DVD disc.

The computer 4000 can communicate with other computers over a computer network 4016 (such as the Internet or an intranet) through a network interface 4018 that enables communication over a connection 4020 between the network 4016 and the computer 4000. The network interface 4018 typically comprises, for example, a Network Interface Card (NIC) or a modem that permits communications over a variety of networks.

The CPU 4002 operates under control of programming steps that are temporarily stored in the memory 4010 of the computer 4000. When the programming steps are executed, the computer performs its functions. Thus, the programming steps implement the functionality of the event tracking process described above. The programming steps can be received from the DASD 4008, through the program product storage device 4014, or through the network connection 4020. The program product storage drive 4012 can receive a program product 4014, read programming steps recorded thereon, and transfer the programming steps into the memory 4010 for execution by the CPU 4002. As noted above, the program product storage device can comprise any one of multiple removable media having recorded computer-readable instructions, including magnetic floppy disks and CD-ROM storage discs. Other suitable program product storage devices can include magnetic tape and semiconductor memory chips. In this way, the processing steps necessary for operation in accordance with the invention can be embodied on a program product.

Alternatively, the program steps can be received into the operating memory 4010 over the network 4016. In the network method, the computer receives data including program steps into the memory 4010 through the network interface 4018 after network communication has been established over the network connection 4020 by well-known methods that will be understood by those skilled in the art without further explanation. The program steps are then executed by the CPU 4002 thereby comprising a computer process.

It should be understood that the any device that supports the framework envirnonment described above, acting as a host computer, will typically have a construction similar to that shown in FIG. 40, so that details described with respect to the FIG. 40 computer 4000 will be understood to apply to all computers of any network system in which the framework or framework-developed applications are utilized. Alternatively, the devices can have an alternative construction, so long as the computer can communicate with the other computers and can support the functionality described herein.

All patents, patent applications, publications and references mentioned in the specification are indicative of the practice level of those skilled in the art to which the invention pertains. All patents, patent applications, publications and references are herein incorporated by reference to the same extent as if each individual patent, patent application, publication or reference was specifically and individually indicated to be incorporated by reference.

One skilled in the art should readily appreciate that the present invention is well adapted to carry out the objects and obtain the ends and advantages mentioned, as well as those inherent therein. The specific embodiments described herein as presently representative of preferred embodiments are exemplary and are not intended as limitations on the scope of the invention. Changes therein and other uses will occur to those skilled in the art which are encompassed within the spirit of the invention are defined by the scope of the claims. It will be readily apparent to one skilled in the art that modifications may be made to the invention disclosed herein without departing from the scope and spirit of the invention.

The present invention has been described above in terms of presently preferred embodiments so that an understanding of the present invention can be conveyed. There are, however, many configurations for information system frameworks not specifically described herein but with which the present invention is applicable. The present invention should therefore not be seen as limited to the particular embodiments described herein, but rather, it should be understood that the present invention has wide applicability with respect to information systems generally. All modifications, variations, or equivalent arrangements and implementations that are within the scope of the attached claims should therefore be considered within the scope of the invention.

We claim:

1. An extensible framework for use in a computer system that supports an object oriented programming environment and includes a memory in which data objects can be stored, the framework comprising a set of object classes that can be extended using object oriented principles to define an information handling application with data objects comprising a class of data source objects and a class of data consumer objects, and a mediation layer that defines an interface between the data source objects and the data consumer objects to permit data communications between the two data object classes, such that the class configuration of the data source objects can be specified independently of the class configuration of the data consumer objects.

2. A computer system that supports an object oriented programming environment and includes access to data storage containing specifications for a set of object classes that can be extended using object oriented principles to define an information handling application with data objects comprising a class of data source objects and a class of data consumer objects, and a mediation layer that defines an interface between the data source objects and the data consumer objects to permit data information exchange between the two data object classes, such that the class configuration of the data source objects can be specified independently of the class configuration of the data consumer objects.

3. A computer system as defined in claim 2, wherein the mediation layer defines a data interface that provides an information exchange standard between the data source objects and the data consumer objects.

4. A computer system as defined in claim 3, wherein the data interface includes at least one attribute/metadata object class that specifies attributes, including metadata, and that provide declarative and procedural information relating to attributes in said data object.

5. A computer system as defined in claim 3, wherein the data interface includes at least one Relationship object class that specifies relationships between data source class objects.

6. A computer system as defined in claim 3, wherein the data interface includes at least one Domain Policy object class that specifies a group of related attributes, methods, and semantic information that indicates data processing to be available for the specified attributes, including the specific intent of said attributes.

7. A computer system as defined in claim 3, wherein the data interface includes at least one Event Change object class that specifies change event registration for detecting changes in the data objects.

8. A computer system as defined in claim 4, further including a TypeMetaData class of objects that specify semantic information indicating data processing to be available for specified attributes and intended use of the attributes of a data object.

9. A computer system as defined in claim 8, further including a TypeIO class of objects that define a desired format of a data object attribute specified by a TypeMetaData class.

10. A computer system as defined in claim 6, wherein an attribute alias may be specified by a user to indicate any data source attributes of an attribute domain that may be substituted with attributes of a different attribute domain.

11. A computer system as defined in claim 4, wherein said attribute/metadata interface provides input/output functions for display and editing of the attribute during runtime.

12. A computer system as defined in claim 4, further including a FieldMetaData attribute that specifies processing criteria for an attribute of a data object.

13. A computer system as defined in claim 4, wherein the processing criteria relates to a selected attribute of the data object for display processing.

14. A computer system as defined in claim 5, wherein the indicated relationship may be resolved using a version of the Relationship object in cache of the computer system.

15. A computer system as defined in claim 2, further including a collaboration facility that permits a user at a network computer remote from the computer system to share a view of a data object at the remote network computer.

16. A computer system as defined in claim 15, wherein the collaboration facility comprises a Meta View class of data objects that lightweight encapsulate elements of a data object for visual reconstruction on a display screen of the remote network computer.

17. A computer system as defined in claim 4, wherein the data interface provides an override function that can override default metadata of the data object attributes.

18. A computer system as defined in claim 6, wherein the data interface provides an override function that can override default metadata of the data object attributes.

19. A computer system as defined in claim 3, wherein data objects provided through the data interface comprise information that specifies data attributes, relationships, event broadcasting of changes in all registered data consumer objects, metadata for attributes that provide declarative and procedural information and/or input/output functions for display and editing, and related data items, and wherein the data objects can store references without direct access to a related data item.

20. A computer system as defined in claim 19, wherein the attributes and relationships include contextual metadata, and the events and methods are defined with respect to the contextual metadata.

21. A computer system as defined in claim 3, wherein the mediation layer further includes object classes that include one or more methods that provide data exposure, and further including a Data Source Interface object class of data objects with methods that automatically determine which data exposure method will be used for data communications between the data source objects and data consumer objects.

22. A computer system as defined in claim 21, wherein the determined data exposure method comprises data object reflection and introspection.

23. A computer system as defined in claim 21, wherein the data exposure methods include a data source object method that provides a standard interface, a data source object and a Translator object that maps an alternate data interface to the standard interface, and a data source object that is inspected by the computer system to determine available data fields which are thereby exposed to data consumer objects by the standard interface.

24. A computer system as defined in claim 3, wherein the data interface of the mediation layer provides a wrapper for the data objects.

25. A computer system as defined in claim 24, wherein data exchange occurs without providing contextual data characteristics to a receiving data object.

26. A computer system as defined in claim 25, wherein the contextual data characteristics are supplied by the data object wrapper.

27. A computer system as defined in claim 3, wherein data exchange occurs without providing contextual data characteristics to a receiving data object.

28. A computer system as defined in claim 2, further including a plug-in manager object class that integrates service components into the application.

29. A computer system as defined in claim 28, wherein data service components interact with other components of the application to determine if a service is required and to determine parameters that are to be interchanged.

30. A computer system as defined in claim 29, wherein the service determination occurs upon introduction of newly loaded components.

31. A computer system as defined in claim 3, further including a translator facility that translates information concerning a data object into (1) attributes and metadata that define groups of data source and data consumer class attributes and (2) an object class that specifies at least one domain method for defining groups of data object attributes.

32. A computer system as defined in claim 24, further including an InfoModel data object class.

33. A computer system as defined in claim 27, wherein said contextual data characteristics are supplied by an InfoModel object.

34. A computer system as defined in claim 33, wherein the InfoModel object receives a data source object for exposure to the data consumer objects, selects available attributes and methods of the received data source object for data characterization, and determines if the addition of attributes or methods to the data source object are appropriate.

35. A computer system as defined in claim 6, wherein the domain is defined using XML schema.

36. A method of communicating data in a computer system that supports an object oriented programming environment and includes data storage or access to data storage containing data objects and specifications for a set of object classes that can be extended using object oriented principles to define an information handling application, the method comprising:
receiving one or more data objects comprising a class of data source objects;
representing the data source objects in accordance with an Information Model class of objects of a mediation layer that defines a data interface between the data source objects and a class of data consumer objects;
wherein the Information Model objects include methods that permit data communications or information exchange between the two data object classes, such that the class configuration of the data source objects can be specified independently of the class configuration of the data consumer objects.

37. A method as defined in claim 36, further including specifying at least one attribute/metadata object class that specifies attributes, including metadata, and that provides declarative and procedural information relating to attributes in said data object.

38. A method as defined in claim 36, further including specifying a Relationship object class or classes that specify relationships between data source objects.

39. A method as defined in claim 36, further including specifying a Domain Policy or Domain object class or classes that specify a group of related attributes, methods, and semantic information that indicates data processing to be available for the specified attributes, including the specific intent of said attributes.

40. A method as defined in claim 36, further including specifying an Event Change object class or classes that specify change event registration for detecting changes in the data objects.

41. A method as defined in claim 37, further including specifying a TypeMetaData class of objects that specify semantic information indicating data processing to be available for specified attributes and intended use of the attributes of a data object.

42. A method as defined in claim 41, further including specifying a TypeIO class of objects that define a desired format of a data object attribute specified by a TypeMetaData class.

43. A method as defined in claim 39, further including specifying an attribute alias by a user to indicate any data source attributes of an attribute domain that may be subtitued with attributes of a different attribute domain.

44. A method as defined in claim 37, wherein the attribute/metadata interface provides input/output functions for display and editing of the attribute during runtime.

45. A method as defined in claim 37, wherein the attribute/metadata object class is a FieldMetaData attribute that specifies processing criteria for an attribute of a data object.

46. A method as defined in claim 37, wherein the processing criteria relates to a selected attribute of the data object for display processing.

47. A method as defined in claim 38, wherein the indicated relationship may be resolved using a version of the Relationship object in cache of the computer system.

48. A method as defined in claim 36, further including providing a collaboration facility that permits a user at a nework computer remote from the computer system to share a view of a data object at the remote network computer.

49. A method as defined in claim 48, wherein the collaboration facility comprises a Meta View class of data objects that lightweight encapsulate elements of a data object for visual reconstruction on a display screen of the remote network computer.

50. A method as defined in claim 37, wherein the data interface provides an override function that can override default metadata of the data object attributes.

51. A method as defined in claim 39, wherein the data interface provides an override function that can override default metadata of the data object attributes.

52. A method as defined in claim 36, wherein data objects provided through the data interface comprise information that specifies data attributes, relationships, event broadcasting of changes in all registered data consumer objects, metadata for attributes that provide declarative and procedural information and/or input/output functions for display and editing, and related data items, and wherein the data objects can store references without direct access to a related data item.

53. A method as defined in claim 52, wherein the attributes and relationships include contextual metadata, and the events and methods are defined with respect to the contextual metadata.

54. A method as defined in claim 36, wherein the mediation layer further includes object classes that include one or more methods that provide data exposure, and further including a Data Source Interface object class of data objects with methods that automatically determine which data exposure method will be used for data communications between the data source objects and data consumer objects.

55. A method as defined in claim 54, wherein the determined data exposure method comprises data object reflection and introspection.

56. A method as defined in claim 54, wherein the data exposure methods include a data source object method that provides a standard interface, a data source object and a Translator object that maps an alternate data interface to the standard interface, and a data source object that is inspected by the computer system to determine available data fields which are thereby exposed to data consumer objects by the standard interface.

57. A method as defined in claim 36, wherein the data interface of the mediation layer provides a wrapper for the data objects.

58. A method as defined in claim 57, wherein data exchange occurs without providing contextual data characteristics to a receiving data object.

59. A method as defined in claim 58, wherein the contextual data characteristics are supplied by the data object wrapper.

60. A method as defined in claim 36, wherein data exchange occurs without providing contextual data characteristics to a receiving data object.

61. A method as defined in claim 36, further including a plug-in manager object class that integrates service components into the application.

62. A method as defined in claim 61, wherein data service components interact with other components of the application to determine if a service is required and to determine parameters that are to be interchanged.

63. A method as defined in claim 62, wherein the service determination occurs upon introduction of newly loaded components.

64. A method as defined in claim 36, further including a translator facility that translates information concerning a data object into (1) attributes and metadata that define groups of data source and data consumer class attributes and (2) an object class that specifies at least one domain method for defining groups of data object attributes.

65. A method as defined in claim 57, further including an InfoModel data object class.

66. A method as defined in claim 60, wherein said contextual data characteristics are supplied by an InfoModel object.

67. A method as defined in claim 66, wherein the InfoModel object receives a data source object for exposure to the data consumer objects, selects available attributes and methods of the received data source object for data characterization, and determines if the addition of attributes or methods to the data source object are appropriate.

68. A method as defined in claim 39, wherein the domain is defined using XML schema.

69. A computer system that supports an object oriented programming environment, the system comprising:
a processor that executes program instructions to provide the object oriented programming environment; and
data store means for providing program instructions containing specifications for a set of object classes that can be extended using object oriented principles to define an information handling application with data objects comprising a class of data source objects and a class of data consumer objects, and a mediation layer that defines an interface between the data source objects and the data consumer objects to permit data information exchange between the two data object classes, such that the class configuration of the data source objects can be specified independently of the class configuration of the data consumer objects.

70. A computer system as defined in claim 69, wherein the mediation layer defines a data interface that provides an information exchange standard between the data source objects and the data consumer objects.

71. A computer system as defined in claim 70, wherein the data interface includes at least one attribute/metadata object class that specifies attributes, including metadata, and that provide declarative and procedural information relating to attributes in said data object.

72. A computer system as defined in claim 70, wherein the data interface includes at least one Relationship object class that specifies relationships between data source class objects.

73. A computer system as defined in claim 70, wherein the data interface includes at least one Domain Policy object class that specifies a group of related attributes, methods, and semantic information that indicates data processing to be available for the specified attributes, including the specific intent of said attributes.

74. A computer system as defined in claim 70, wherein the data interface includes at least one Event Change object class that specifies change event registration for detecting changes in the data objects.

75. A program product for use in a computer system that executes program instructions recorded in a computer-readable media to perform a method for information exchange in a computer system that supports an object oriented programming environment and includes access to data storage containing data objects, the program product comprising:
a recordable media; and
a program product of computer-readable instructions executable by the computer system to perform a method comprising:
receiving data specifications for a set of object classes that can be extended using object oriented principles to define an information handling application, wherein the extended objects provide an information handling application that can receive one or more data objects comprising a class of data source objects, and represent the data source objects in accordance with an Information Model class of objects of a mediation layer that defines a data interface between the data source objects and a class of data consumer objects;
wherein the Information Model objects include methods that permit data communications or information exchange between the two data object classes, such that the class configuration of the data source objects can be specified independently of the class configuration of the data consumer objects.

76. A program product as defined in claim 75, wherein the method further includes specifying at least one attribute/metadata object class that specifies attributes, including metadata, and that provides declarative and procedural information relating to attributes in said data object.

77. A program product as defined in claim 75, wherein the method further includes specifying a Relationship object class or classes that specify relationships between data source objects.

78. A program product as defined in claim 75, wherein the method further includes specifying a Domain Policy or Domain object class or classes that specify a group of related attributes, methods, and semantic information that indicates data processing to be available for the specified attributes, including the specific intent of said attributes.

79. A program product as defined in claim 75, further including specifying an Event Change object class or classes that specify change event registration for detecting changes in the data objects.

80. A method of operating a computer system to execute an information handling application in an object oriented programming environment and to receive data from a class of data source objects and provide a class of data consumer objects with data, the method comprising:
selecting available attributes and methods of a data source object for characterization;
determining attributes or methods to be added to the data source object during application execution; and
receiving the data source object and determining whether to expose or hide available attributes and methods of the object from data consumer objects, wherein data communications between the two data object classes is supported, such that the class configuration of the data source objects can be specified independently of the class configuration of the data consumer objects.
